(19) United States
(12) Patent Application Publication
(10) Pub. No.: US 2013/0154397 A1
(43) Pub. Date: Jun. 20, 2013

(54) HIGH EFFICIENCY MAGNETIC CORE ELECTRICAL MACHINES

(71) Applicant: John T. SULLIVAN, Marriottsville, MD (US)

(72) Inventor: John T. SULLIVAN, Marriottsville, MD (US)

(73) Assignee: John T. Sullivan, Marriottsville, MD (US)

(21) Appl. No.: 13/330,075

(22) Filed: Dec. 19, 2011

(51) Int. Cl. H02K 23/40; H02K 1/06; H02K 23/36; H02K 11/00; H02K 1/18; H02K 9/00; H02K 23/60; H02K 41/03

(52) U.S. Cl. 310/12.18; 310/198; 310/115; 310/156.66; 310/68 B; 310/216.113; 310/52

(57) ABSTRACT

A high efficiency magnetic core electrical machine includes magnet and coil assemblies that may be axially stacked to form modules. The magnet sub-assemblies include magnet locators on which multiple permanent magnets are arranged, and the coil sub-assembly includes a pair of bobbin holders supporting multiple bobbins and magnetic cores that extend through the bobbins and through openings in the bobbin holders to form magnetic poles that face the permanent magnets. The permanent magnets and magnetic poles may be arranged in various zero-cogging configurations, including one in which the permanent magnets on opposite sides of the coil assembly are skewed relative to each other to cause cogging force cancellation. In addition, a power matching circuit may be used to optimize the output power of the electrical machine to rotor speed when the electrical machine is used as a generator.

### BACKGROUND OF THE INVENTION

1. Field of the Invention

This invention relates to electrical machines that utilize permanent magnets/electrical coil interactions to generate torque (in the case of a motor) or electricity (in the case of a generator), and in particular to pole structures and flux return paths having a high flux density and/or switching rate so as to improve the efficiency by which the magnetic fluxes interact with the windings to generate currents or torque.

While a wide variety of magnetic core configurations are disclosed, they can be grouped into three general embodiments, each having a number of variations. The first embodiment utilizes three-dimensionally converging axial, radial, and circumferential flux paths to increase the flux density through individual windings. The second embodiment utilizes rotating auxiliary permanent magnet cylinders to respond to, in effect, enhance or amplify flux reversals. The third set of high efficiency flux return configurations involves variations of the flux-switching mono coil arrangements disclosed in Guo et al., “Comparative Study of 3D Flux Electrical Machines with Soft Magnetic Composite Cores,” Conference Record of the 2002 IEEE Industry Applications Conference (2002), and U.S. Pat. No. 7,646,126, in which pole structures are alternately exposed to permanent magnets of opposite polarity, and the resulting flux reversals or magnetic field changes are used to induced changes in a single coil or a set of discrete coils.

The invention also provides improved methods/structures for assembling magnetic core electrical machines, including modular core structures, magnet/coil structures, and so forth, as well as improved cooling and anti-cogging arrangements for the resulting electrical machines. For example, in both the first and third preferred embodiments, pole structures may be arranged as modular units held together by interlocking connections, such as mortise and tenon, dovetail, or wedge-like connection arrangements. In addition, the pole structures may be configured to obtain a self-cooling effect. The assembly/alignment, cooling, and anti-cogging techniques disclosed herein may be applicable to electrical machines other than the three-dimensional, rotating-magnet, and mono coil electrical machines of the three preferred embodiments, or the variations illustrated herein.

The invention also relates to improved methods of electrical machine construction, and in particular to methods of modularized electrical machine construction.

2. Description of Related Art

The need for high efficiency electrical machines has become increasingly critical as fossil fuel supplies become depleted and/or more expensive to extract. Despite the increasing cost of fossil fuels, however, motors and generators that utilize electro-magnetic induction continue to be less cost effective in many applications than fossil fuel based motors and generators, particularly for transportation and alternative power generation. At present, improvements are urgently needed in the areas of wind turbines, solar-heated steam turbines, wave-powered generators, and other generators responsive to intermittent motion or vibrations, as well as in the field of electric motors used for transportation and other applications where the weight and efficiency of the motor is critical.

One way to increase the efficiency of electrical machines is to use high-strength permanent magnets to provide the magnetic field with which the coils of the electrical machine interact to generate torque (in the case of a motor) or electricity (in the case of a generator). At present, the highest strength permanent magnets are rare-earth magnets. However, rare-earth materials such as samarium and neodymium, which are respectively combined with cobalt and iron/boron to form high strength permanent magnets, are currently available from only a few sources, resulting in limited supply and high prices. As a result, it would be desirable to provide motor and generator structures that can operate relatively efficiency with conventional magnets, or at least non rare-earth magnets. In addition, it would be also increase the efficiency of electrical machines that utilize rare-earth permanent magnets.

A first set of electrical machines constructed in accordance with a first preferred embodiment of the present invention seeks to increase efficiency by increasing the flux density of flux return paths for fluxes induced by the permanent magnets. Electrical machines with flux return paths are of course well-known, and are known as a magnetic core machines, with the core being made iron or an iron alloy having high magnetic permeability that conducts magnetic flux between the poles. Examples of flux return type permanent magnet electrical machines, also known as magnetic core electrical machines, are disclosed in U.S. Pat. Nos. 5,780,950 and 7,898,135. Efficiency is increased because the flux return paths concentrate magnetic fields and prevent energy losses resulting from the normal magnetic field distribution in air. As a result, magnetic core electrical machines are relatively low in cost and less bulky relative to coreless machines, which require an increased magnet size and number of coils to compensate for lower efficiency. However, the flux paths between the permanent magnets and through the poles of the conventional magnetic core electrical machines are two dimensional, which limits the amount of flux in the return paths. The addition of a third-dimension increases the flux capacity of the return paths, and thereby the flux concentration through the coils that surround or interact with the poles of the electrical machine.

In contrast, a second set of electrical machines constructed in accordance with the principles of a second preferred embodiment of the invention seeks to increase flux density and efficiency by adding movable permanent magnets to a magnet core in which the flux reverses, such as the magnetic core of a DC motor. While electrical machines with movable permanent magnets are known, the movable permanent magnets are geared to rotate in synchronism with the rotor, rather than being arranged to “follow” the flux reversals, and thereby increase the flux density in synchronism with the applied flux.

A third set of electrical machines constructed in accordance with the principles of a third preferred embodiment of the invention utilizes variations and novel applications of the principles of flux switching taught in the above-cited Guo et al. publication and in U.S. Pat. No. 7,646,126. As taught in the Guo et al. publications and in U.S. Pat. No. 7,646,126, relative movement between permanent magnets and poles whose number if twice that of the permanent magnets causes flux reversals in central core, which may be picked up by a single mono coil surrounding the core, in the case of a one-phase generator, or multiple mono coil units in the case of a multiple phase electrical machine (which may be a generator or motor). In the present invention, the flux reversal principle is generalized to a variety of mono coil configurations, including spherical and disc-shaped rather than cylindrical electrical machines, electrical machines having one or more mono coils surrounding individual poles, electrical machines with permanent magnets on both the stator and rotor (and that utilize changes in the fields of the magnets to induce currents in the winding(s)), and linear electrical machines.

In addition to providing for improved flux density, the present invention provides a scalable pole or flux return structure made up of modules molded from a soft magnetic compound (SMC) or plastic bonded iron powder (PBIP) material that fit together using mortise-and-tenon or similar interfitting or interlocking joining structures. British Patent Publication Nos. GB 2468018 and GB 2468019 disclose a magnetic core stator structure in which the upper and lower stator rings are provided with transverse projections that extend through the coils to form magnetic cores, and that include pin and hole jointing structures similar to those used in LEGO™ construction toys. The modular nature of the stator constructions disclosed in these publication is similar to that of the present invention, but only provide conventional two-dimensional flux paths consisting of closed circuits through adjacent coils, and lack the larger mating area provided by the mortise-and-tenon or similar joining structures of the present invention. By way of additional background, stator or pole arrangements made up of multiple parts, including parts made up of a moldable soft magnetic compound, are disclosed in U.S. Pat. Nos. 7,847,443 and 7,832,046 and U.S. Patent Publication Nos. 2006/0208602 and 2008/0018194. Suitable soft magnetic compound materials are disclosed, by way of example, in U.S. Pat. No. 6,338,900 and Horrdin et al., “Technology Shifts in Power Electronics and Electric Motors for Hybrid Vehicles, A Study of Silicon Carbide and Iron Powder Materials,” Master of Science Thesis, Chalmers University of Technology (2007).

Despite advances in electrical machine construction, there is still a great need for high efficiency, relatively low cost electrical machines that can be utilized in alternative energy technologies such as wind and wave power, electrical and hybrid vehicles, and so forth, and particularly electrical machines that do not require rare earth magnets for efficient operation.

### SUMMARY OF THE INVENTION

It is accordingly an objective of the invention to provide electrical machines that may economically be applied to a variety of applications to improve energy utilization and/or power generation efficiency.

If is also an objective of the invention to provide permanent magnet-type, magnetic core electrical machines that operate at high efficiency without the need for rare-earth permanent magnets (though rare-earth permanent magnets could still be used in these machines to provide even greater efficiency).

To accomplish these objectives, the invention provides three preferred embodiments of the invention, each involving a different type of high efficiency magnetic core electrical machine.

The first set of high efficiency magnetic core electrical machines utilize, in accordance with the principles of a first preferred embodiment of the invention, three-dimensionally converging circumferential, axial, and radial flux paths to increase the flux density through individual stator coils. The axial and radial flux paths are provided by circumferentially extending arms of three dimensional pole structures that may be assembled to form discrete rings, the pole structures further including arms that extend transversely to the rings in both radial and vertical directions to thereby provide flux paths that converge from three different dimensions. The three dimensional poles structures may include coupling structures, such as mortise and tenon arrangements, for easy assembly and to increase the surface area of the interface between the pole structures.

A second set of high efficiency magnetic core electrical machines utilizes, in accordance with the principles of a second preferred embodiment of the invention, auxiliary movable permanent magnet structures situated in the flux return paths of pole structures that may otherwise be conventional. The permanent magnet structures are freely movable relative to the pole structures to follow changes in the flux passing through the pole structures, for example by rotating, to provide a boost effect that increases the flux density in the return path.

A third set of high efficiency magnetic core electrical machines utilize, in accordance with the principles of a third preferred embodiment of the invention, variation of the flux-switching mono coil arrangement disclosed in U.S. Pat. No. 7,646,126. This set of high efficiency magnetic core electrical machines varies the basic mono coil design by applying the flux switching concept to a wide range of electrical machine configurations, including spherical and disc-shaped electrical machines as well as cylindrical electrical machines, and by varying the configuration or arrangement of the pole structures, the permanent magnet structures, and even the windings. Included in this set of electrical machines are mono coil electrical machines with anti-cogging features and improved cooling features, electrical machines with multiple coils that use similar flux switching, and three dimensional mono coil electrical machines, as well as mono coil electrical machines with modular coil/magnet arrangements, and even linear electrical machines utilizing principles of mono coil electrical machines and that could be applied, by way of example and not limitation, in sensors or ocean wave electricity generation systems. These electrical machines may use modular construction and alignment techniques similar to those of the first preferred embodiment, including a variety of interlocking arrangements utilizing interlocking or self-aligning structures such as mortise and tenon, tongue and groove, dovetail, and wedge configurations that are broadly applicable to a wide variety of different electrical machines, including multiple coil as well as mono coil electrical machines, and linear as well as rotary machines.

### BRIEF DESCRIPTION OF THE DRAWINGS

FIG. 1 is an isometric view showing a permanent magnet rotor and three-dimensional stator (or permanent magnet stator and three dimensional rotor) for an electrical machine constructed in accordance with the principles of a first preferred embodiment of the invention.

FIG. 1a is an isometric view of the stator structure of FIG. 1.

FIG. 1b is an isometric view of an electrical machine that includes the rotor and stator structures of FIGS. 1 and 1a.

FIG. 2 is an isometric view of a variation of the stator structure of FIG. 1, with two flux return rings.

FIG. 2a is an isometric view showing one of the flux return rings of FIG. 2.

FIG. 3 is an isometric view of a further variation of the electrical machine of the first preferred embodiment.

FIG. 3a is an isometric view of an individual pole structure module or unit for the electrical machine of FIG. 3.

FIG. 4 is an isometric view of yet another variation of the electrical machine of the first preferred embodiment.

FIG. 4a is an isometric view of an individual pole structure module or unit for the electrical machine of FIG. 4.

FIG. 4b is a plan view of the electrical machine of FIG. 4.

FIG. 4c is a second isometric view of the pole structure module or unit shown in FIG. 4a.

FIG. 5 is a side view of a portion of the stator structure of FIGS. 1, 1a, and 1b, showing the manner in which flux propagates in a first plane.

FIG. 5a is a top view of one of the individual pole structure modules or units used in the stator structure of FIGS. 1, 1a, and 1b, showing the manner in which flux propagates in a second plane transverse to the first plate.

FIG. 5b is an isometric view of the pole structure of FIGS. 5 and 5a, showing the manner in which axial and radial sets of flux lines converge to increase flux density in the pole arms.

FIG. 6 shows a coil arrangement for use in the first preferred embodiment.

FIG. 7 is an isometric view of a variation of the electrical machine of FIGS. 2 and 2a.

FIG. 7a is an isometric view of an individual pole structure module or unit for use in the electrical machine of FIG. 7.

FIG. 8 is an isometric view of a variation of the electrical machine of FIGS. 4 and 4a-4c.

FIG. 8a is an isometric view of an individual pole structure of the electrical machine of FIG. 8.

FIG. 9 is an isometric view showing an alternative manner of constructing a stator according to the principles of the first preferred embodiment of the invention.

FIGS. 9a and 9b show a single flux ring and a multi-dimensional stator structure constructed using the method illustrated in FIG. 9.

FIG. 10 is an isometric view of the electrical machine of a second preferred embodiment of the invention, with flux-amplifying rotatable auxiliary permanent magnets.

FIGS. 10a-10c are plan views of the electrical machine of FIG. 10, illustrating the manner in which the auxiliary permanent magnets rotate in response to movement of the main permanent magnets on the rotor.

FIG. 10d shows a variation of the embodiment of FIG. 10, in which the auxiliary permanent magnets are provided in radially-extending pole arms.

FIG. 10e shows a further variation of the embodiment of FIG. 10, in which multiple auxiliary permanent magnets are provided for each magnetic flux circuit, and the auxiliary permanent magnets have multiple poles.

FIG. 10f is a cutaway isometric view of a variation of the electrical machine of FIG. 10e.

FIGS. 10g and 10h are isometric views of linear electrical machines that include auxiliary permanent magnets.

FIG. 10i is an isometric view of a further variation of the electrical machine of FIG. 10.

FIGS. 11a and 11b are isometric views of a pole structure used in a mono coil electrical machine constructed in accordance with the principles of a third preferred embodiment of the invention.

FIG. 12 is an exploded isometric view of an electrical machine utilizing the pole structure of FIGS. 11a and 11b.

FIG. 13 is a cut-way isometric view, taken from the side, of the electrical machine of FIG. 12.

FIG. 14 is a cut-way isometric view of a two-phase electrical machine that utilizes series-connected mono coil units of the type illustrated in FIG. 13.

FIG. 15 is an isometric view of the coils and stator structure of a three-phase electrical version of the electrical machine of FIG. 14.

FIG. 16 is an exploded isometric view of a ball-shaped variation of the mono coil electrical machine of the third preferred embodiment.

FIG. 17 is an isometric view of the outer housing of the electrical machine of FIG. 16.

FIG. 18 is an isometric view of the inner pole structure of the electrical machine of FIG. 16.

FIG. 19 is a cross-sectional side view of the electrical machine of FIG. 16.

FIG. 20 is a cross-sectional isometric view of the pole structure and coil holder assembly included in the electrical machine of FIG. 16.

FIGS. 21 and 22 are isometric views of a variation of the electrical machine of FIGS. 15-19.

FIG. 23 is an isometric view of a further variation of the mono coil electrical machine of the third preferred embodiment in which the electrical machine has a disc-shaped.

FIG. 24 is a cutaway isometric view of the electrical machine of FIG. 23.

FIG. 25 is an isometric view of a pole structure for use in the electrical machine of FIGS. 23 and 24.

FIG. 26 is an isometric view of a three-phase version of the electrical machine of FIGS. 22-25.

FIGS. 27 and 28 are, respectively, an isometric view and a cutaway isometric view of a variation of the disc-shaped electrical machine of FIGS. 22-25.

FIG. 29 is an isometric view of a multiple coil variation of the disc-shaped electrical machine of FIGS. 23-28.

FIGS. 30 and 31 are isometric views showing a magnet/coil structures for use in the electrical machine of FIG. 29.

FIG. 32 is an isometric view of a variation of the electrical machine of FIG. 29, with alternative permanent magnet/coil structures.

FIG. 33 is an exploded isometric view of a permanent magnet/coil structure for use in the electrical machine of FIG. 32.

FIGS. 34 and 35 are isometric views showing further variations of the electrical machine of FIG. 29, utilizing horseshoe magnets.

FIG. 36 is a plan view of the electrical machine of FIG. 35.

FIGS. 37 and 38 show permanent magnet and flux reversal structures for linear electrical machines that utilize principles of the third preferred embodiment of the invention.

FIG. 39 is an isometric view of an individual pole structure for the linear electrical machine of FIG. 38.

FIGS. 40 and 41 are respective isometric and front views of coil structures for variations of the linear electrical machines of FIGS. 37 and 39.

FIG. 42 is an isometric view of a further variation of the linear electrical machines of FIGS. 37-41.

FIG. 43 is an isometric view of a soft magnetic pole/coil module or unit for yet another variation of the electrical machine of the third preferred embodiment.

FIG. 44 is an isometric view of an electrical machine constructed from the modules or units illustrated in FIG. 44.

FIG. 45 is an isometric view of another variation of the mono coil electrical machine of the third preferred embodiment.

FIG. 46 is a cut-away isometric view of the electrical machine of FIG. 45.

FIG. 47 is an isometric view of a two phase variation of the electrical machine of FIGS. 45 and 46.

FIGS. 48 and 49 are isometric views of a mono coil electrical machine having tab-and-slot pole structure alignment features to simplify assembly.

FIGS. 50-52 are isometric views showing a mono coil electrical machine having alternative alignment features.

FIGS. 53-55 are isometric views showing a mono coil electrical machined constructed according to the principles of the third preferred embodiment of the invention, but with mortise and tenon alignment similar to that included in variations of the first preferred embodiment.

FIG. 56 is an isometric view of a three phase variation of the electrical machine of FIGS. 53-55.

FIG. 57 is an isometric view of another variation of the electrical machine of FIGS. 53-55.

FIG. 58 is an isometric view of a partially disassembled two-phase mono coil electrical machine with self-alignment features.

FIG. 59 is a plan view showing an alternative pole structure configuration for the electrical machine of FIG. 58.

FIG. 60 is an isometric view showing a split ring variation of the mono coil of electrical machine that includes the pole structure configuration of FIG. 59.

FIGS. 60A and 60B show further variations of the split ring pole structures shown in FIG. 60.

FIG. 61 is an isometric view showing a partially disassembled multiple phase electrical machine with alternative self-alignment features.

FIG. 62 is an isometric view of an alternative pole structure for the electrical machine of FIGS. 53-55.

FIG. 63 is a plan view showing a variation of the pole structure of FIG. 62.

FIGS. 64 and 65 are isometric views showing a stator structure for a mono coil electrical machine that utilizes the pole structure of FIG. 63.

FIGS. 66 and 67 are isometric views of a stator structure suitable for use in larger mono coil electrical machine applications for which molded magnetic components are impractical.

FIGS. 68 and 69 are isometric views of multiple coil variation of the stator structure of FIGS. 66 and 67.

FIGS. 70 (a)-70 (e) are schematic views illustrating coil windings and magnetic flux paths for various mono coil electrical machines of the third preferred embodiment.

FIGS. 71(a) and 71(b) are schematic cross-sectional views of coil arrangements suitable for use in connection with electrical machines of the third preferred embodiment.

FIG. 72 is an isometric view of a multiple coil stator with inventive pole structure alignment features.

FIG. 73 is an isometric view showing individual pole structures used in the stator of FIG. 72.

FIG. 74 is an isometric view of an electrical machine that includes pole structures similar to those of FIG. 53, but with an alternative permanent magnet arrangement.

FIG. 75 is an isometric view of a pole structure corresponding to the one shown in FIG. 54, but with an integrated permanent magnet.

FIG. 76 is an isometric view of an electrical machine including a rotor having wedge-shaped permanent magnets.

FIGS. 77-79 are isometric views of a multiple coil electrical machine with axially self-aligning pole structures.

FIG. 80 is a cut-away side view of the electrical machine of FIGS. 77-79.

FIG. 81 is an isometric view of self-aligning pole structure corresponding to the one shown in FIG. 80, but for a linear electrical machine.

FIG. 82 is a cut-way isometric view of a linear electrical machine that utilizes the pole structure of FIG. 81.

FIG. 83 is an isometric view of an electrical machine with anti-cogging features.

FIG. 83(a) is an isometric view of a variation of the electrical machine of FIG. 83, in which the stator rather than the permanent magnets is skewed.

FIG. 83(b) is an isometric view of an alternative skewed stator arrangement.

FIGS. 84-87 are isometric views of linear electrical machine with anti-cogging features.

FIG. 88 is a schematic circuit diagram of a control circuit for a dual coil electrical machine.

### DETAILED DESCRIPTION OF THE PREFERRED EMBODIMENTS

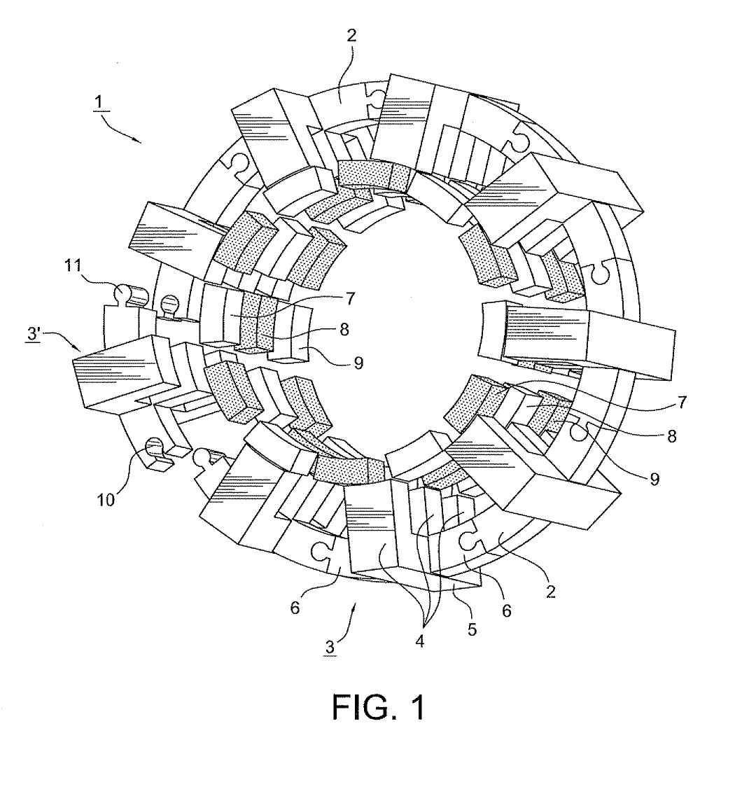

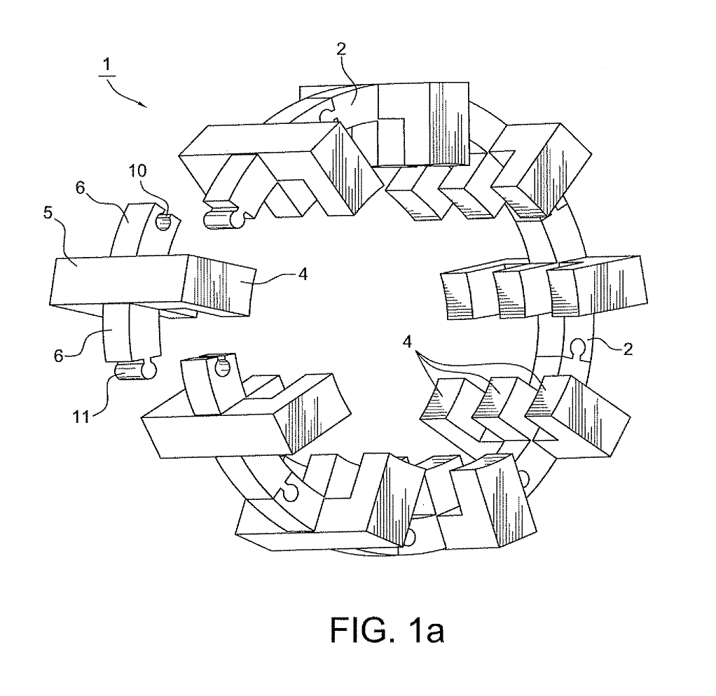

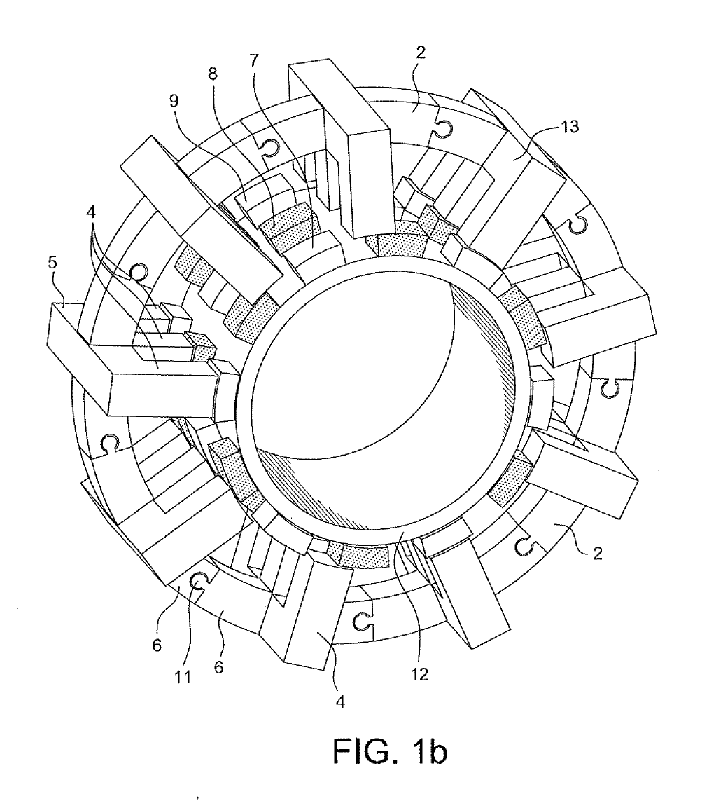

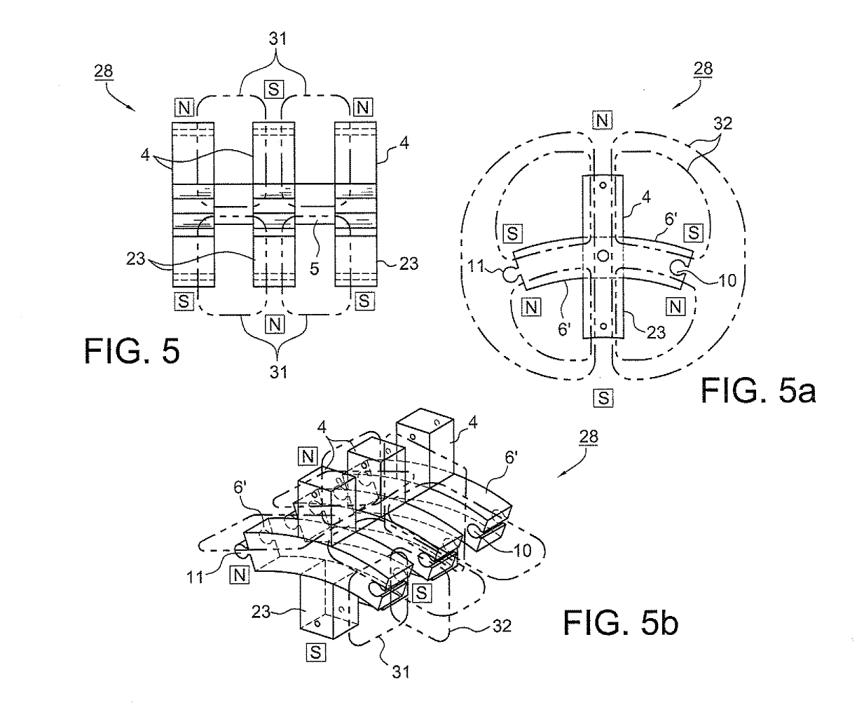

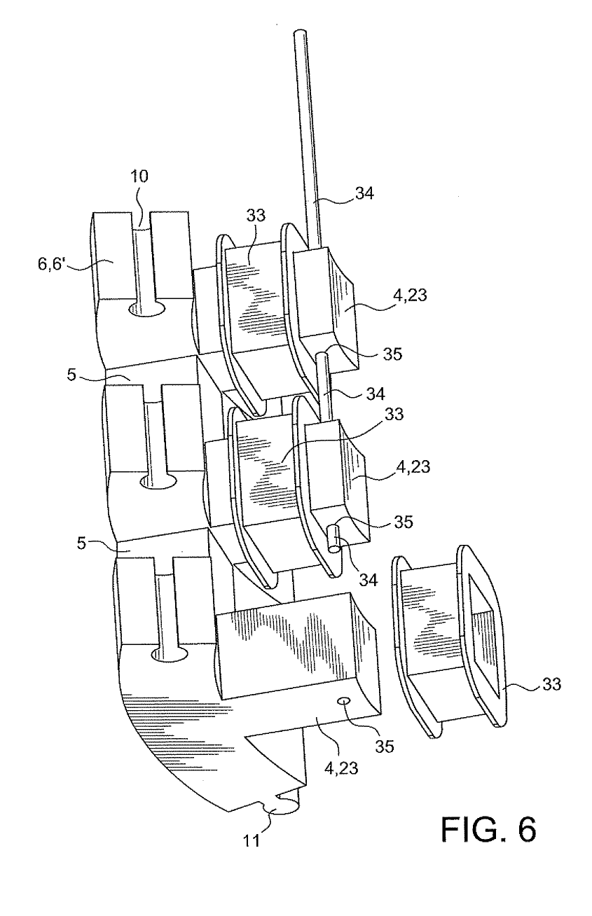

As illustrated in FIGS. 1, 1a, and 1b a stator 1 is arranged to provide three-dimensionally converging axial, radial, and circumferential flux paths, and includes at least one annular flux return ring 2 that include a plurality of individual pole structure modules or units 3, each including three radially extending pole arms 4, a vertical connecting arm 5 that together with the pole arms 4 forms an “E” or comb shape, and circumferentially extending arc shaped connecting extensions 6. The ends of pole arms 4 face, and magnetically interact with, respective upper, middle, and lower permanent magnets 7-9, which are supported by a rotor structure 12 (shown in FIG. 1b). The individual pole structure modules or units 3 are joined at the connecting extensions 6 by connection structures that may take the form of mortises 10 and tenons 11. One of the pole structure modules or units 3, indicated by the label 3′, is illustrated as being detached from the other modules or units. Reference numeral 13 in FIG. 1b indicates magnetic flux lines that flow between magnets 7-9, as will be explained in more detail below in connection with FIGS. 5, 5a, and 5b. Each of the pole arms 4 will be provided with a winding (not shown in FIGS. 1, 1a, and 1b, but an exemplary version of which is shown in FIG. 6) so that the electrical machine of FIGS. 1, 1a, and 1b can operate either as a motor or a generator.

As illustrated in FIGS. 1, 1a, and 1b, the rotor structure 12 on which the permanent magnets 7-9 are mounted is a magnetically permeable rotor cylinder to provide return flux paths from magnet to magnet. However, it will appreciated by those skilled in the art that the structure of the rotor may be varied so long as it provides flux paths between the rotors, and furthermore that while structure 1 is described as a “stator” and structure 12 as a “rotor,” operation as an electrical machine only requires relative rotation between structures 1 and 12, so that the “rotor” 12 may actually be fixed and “stator” 1 cased to rotate, or both stator 1 and rotor 12 may be rotatable. In addition, while the number of permanent magnets in the illustrated embodiment differs from the number of poles to provide an anti-cogging effect, the absolute and relative numbers of poles and permanent magnets may also be varied as desired.

The material of the stator structure may be any soft magnetic material. An especially advantageous material in terms of each of manufacture and magnetic properties, however, is the so-called moldable soft magnetic compound (SMC). Another potentially advantageous material is plastic bonded iron powder (PBIP). One advantage of this embodiment of the present invention is that it provides for increased flux density at the poles for greater electro-mechanical efficiency, eliminating the need to use rare earth permanent magnets. However, it is within the scope of the invention to use rare earth permanent magnets as well as permanent magnets made of other materials.

The stator structure illustrated in FIG. 1 can be manufactured by any conventional technique, but as illustrated, the structure includes a particularly advantageous modular construction that utilizes magnetic pole structure modules or units 3 joined by mortises 10 and tenons 11, or other joining structures. The stator illustrated in FIG. 1 is formed of nine such modules or units 3, but the number of sections may be varied as required by the desired characteristics of the electrical machine in which the stator is used. Each of the modules or units 3 illustrated in FIG. 1 is identical, but it is also within the scope of the invention to vary the shape of one or more units.

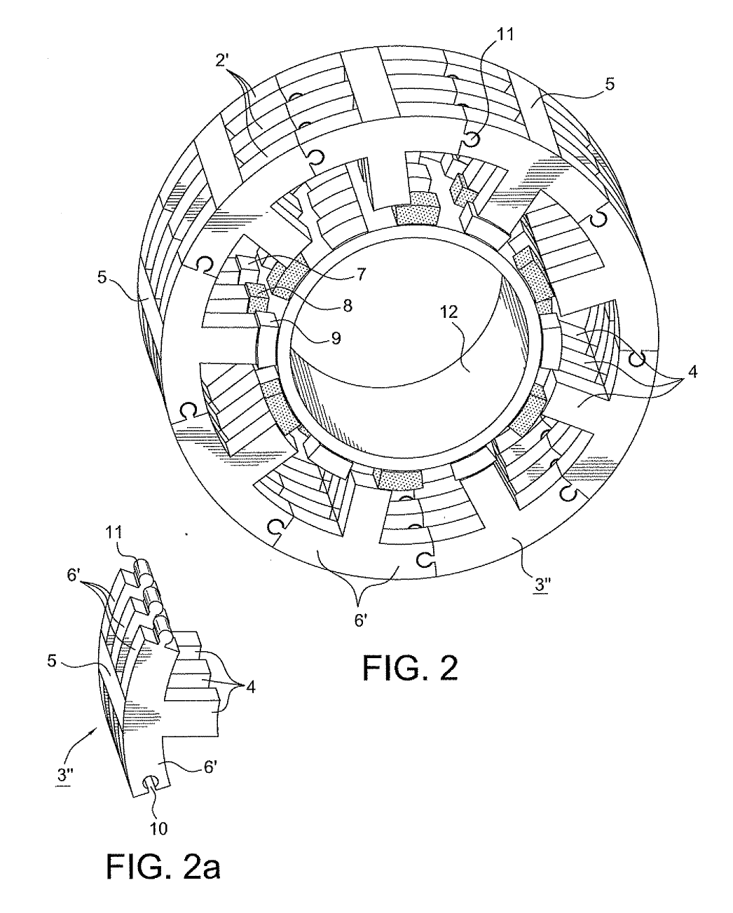

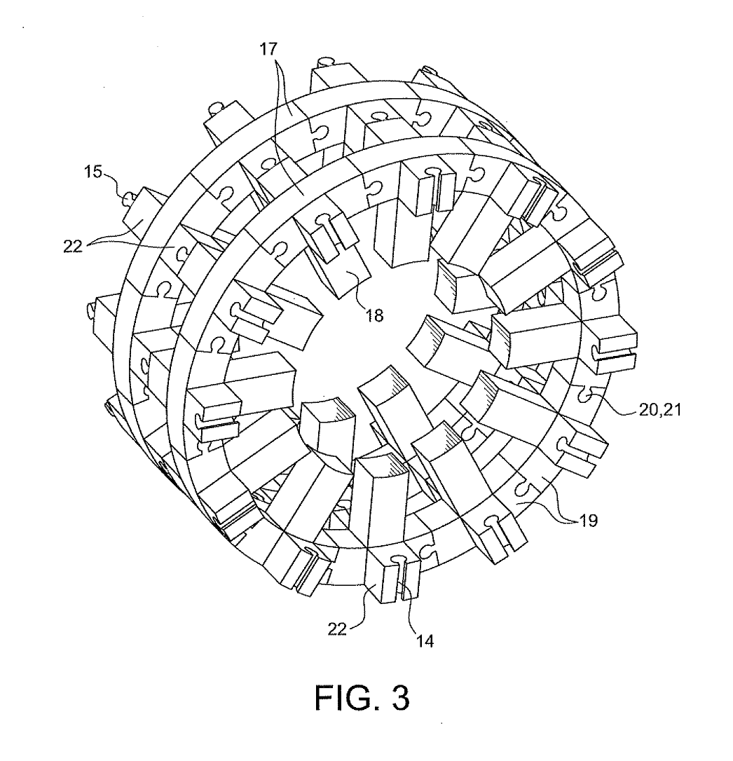

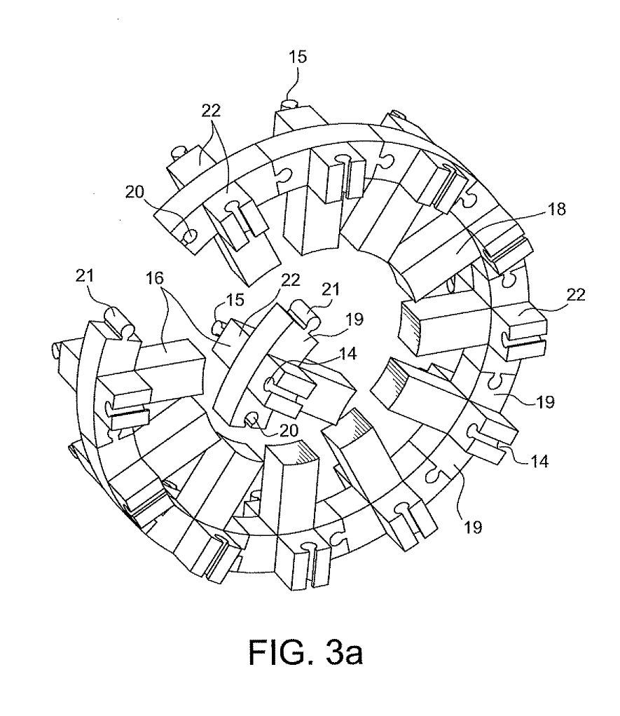

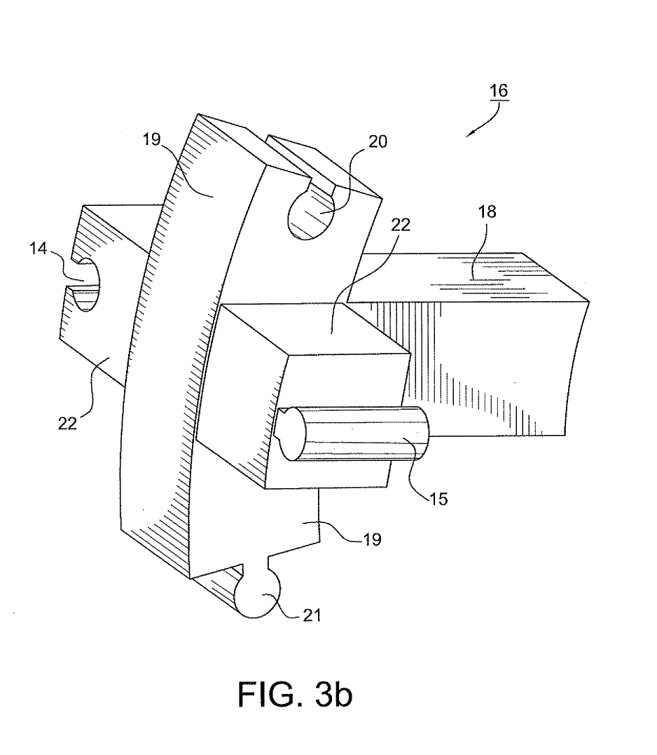

In addition, the shapes of the modules or units 3 may be varied to include additional poles and/or to form additional flux return paths or rings. For example, the pole structure modules or units 3 may each have three pole arms 4 and two arc-shaped connecting extensions 6 extending from vertical connecting arm 5 to form a single flux return ring 2 as illustrated in FIGS. 1, 1a, and 1b, or may be varied to form modified pole structure modules or units 3″ as shown in FIGS. 2 and 2a, each pole structure module or unit 3″ including three pole arms 4 and six connecting extensions 6′, each extension 6′ including a mortise 10 or tenon 11 and extending from vertical connecting arm 5 to form three flux return rings 2′. Alternatively, joining means such as mortises 14 and tenons 15 may be included on vertical arms of pole structure modules or units 16 shown in FIGS. 3, 3a, and 3b such that an arbitrary number of stator rings 17 may be formed, each of the pole structures or modules 16 including a radially inward extending pole arm 18, arc-shaped horizontal joining arms 19, each with a mortise 20 or tenon 21, and vertical joining arms 22, each with one of the above-mentioned mortises 14 and tenons 15. In each of these embodiments, the pole arms 4 will be provided with windings (not shown).

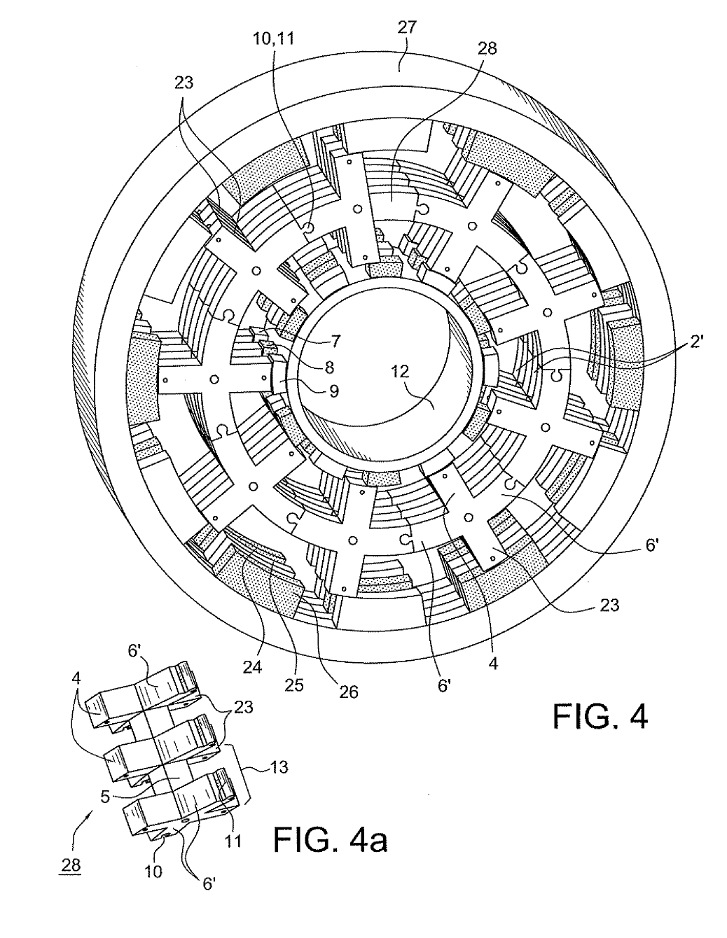

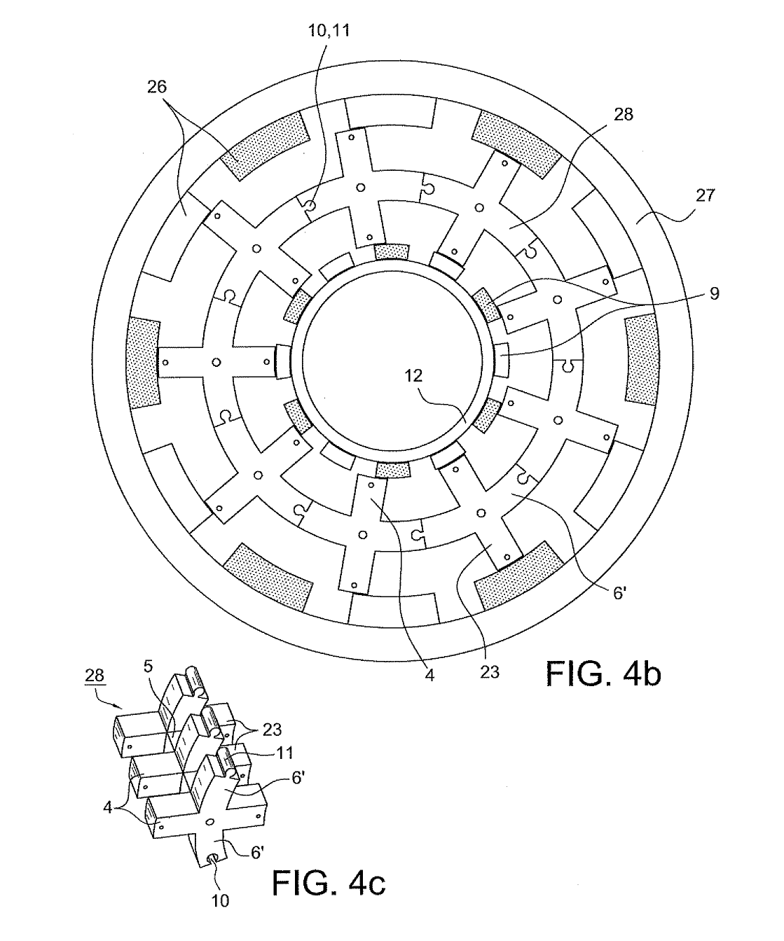

FIGS. 4 and 4a-4c show a variation of the arrangement shown in FIGS. 2 and 2a, in which a second set of pole radially outwardly extending pole arms 23 and a second set of permanent magnets 24-26 are provided on a second magnetically-permeable cylinder 27 to provide increased torque or electricity generating capacity. As with the variations shown in FIGS. 1-3, the “stator structure” of FIGS. 4 and 4a-4c, which includes pole structure modules or units 28, and the cylinders 12 and 27, which respectively include the first set of permanent magnets 7-9 and the second set of permanent magnets 24-26, need only be relatively movable, and that either the stator structure or the cylinders may be fixed or movable. Elements shared by the electrical machines of FIGS. 2,2a and 4,4a-4c have been given common reference numerals. Pole arms 23 will be provided with windings (not shown) in the same manner as pole arms 4, for example by utilizing the exemplary structure illustrated in FIG. 6.

FIGS. 5, 5a, and 5b illustrate the manner in which sets of magnetic flux lines, originating from the permanent magnets 7-9 and 24-26 and indicated by reference numerals 31 and 32, propagate through the pole arms 4 and 23 of the pole structures 28, the vertical connecting arms 5, and the rings 2′ of the embodiment of FIGS. 4 and 4a-4c. The same general principles apply to the stator structures of FIGS. 1-3 and corresponding magnetic flux lines 13 are also shown in FIGS. 1b and 4a.

In order to enable propagation of magnetic flux and enable torque or electrical current to be generated as a result of the interaction between the faces of pole arms 4 and the first set of permanent magnets 7-9, and (if included) between pole arms 23 and the second set of permanent magnets 24-26, permanent magnets 7-9 and 24-26 are arranged to alternate in polarity in both the axial and circumferential directions, so that no two axially or circumferentially adjacent permanent magnets have the same polarity. As a result, two transverse sets of flux lines are generated, with the flux paths converging in the radially inwardly and outwardly extending pole arms 4 and 23. The first set of flux paths 31 shown in FIG. 5 extends vertically through the arms 4 and 23 of each pole structure unit or module 28 and the vertical connecting arm 5. The second set of flux paths 32 shown in FIG. 5a extends horizontally through the arms 4 and 23 and the arc-shaped extensions 6′ of the modules or units 28. As illustrated in FIG. 5b, the flux paths 31,32 converge in the pole arms 4 and 23, thereby providing a greater flux density in the pole arms, and consequently either greater torque when the electrical machine is a motor due to the increased flux between the pole arms and the magnets, or greater energy density in windings around the pole arms when the electrical machine is used as a generator. In the embodiments with a single inwardly extending set of pole arms 4, all of the flux converges on the pole arms 4 for a similar effect.

The increased flux density in the pole arms 4 and 23 is the same as would be achieved by increasing the strength of individual permanent magnets, for example by using rare earth magnets rather than conventional permanent magnets. As a result, the illustrated structure allows an electrical machine with relatively weaker and less-expensive conventional permanent magnets to achieve efficiencies comparable to an electrical machine with rare earth permanent magnets, and an electrical machine with rare earth permanent magnets to provide even greater efficiency than is possible with current electrical machines using rare earth permanent magnets.

FIG. 6 shows, by way of example and not limitation, a coil winding arrangement that may be used in connection with any of the three-dimensional electrical machine embodiments described herein. Although it is possible for the coils to be wound directly on the pole arms 4 and/or 23 of these embodiments, the coil-winding arrangement of FIG. 6 includes pre-wound bobbins 33 held in place by either an adhesive or a suitable fastening arrangement, such as pin or wire 34 which extends through holes 35 in the pole arms to secure the bobbins to the pole arms.

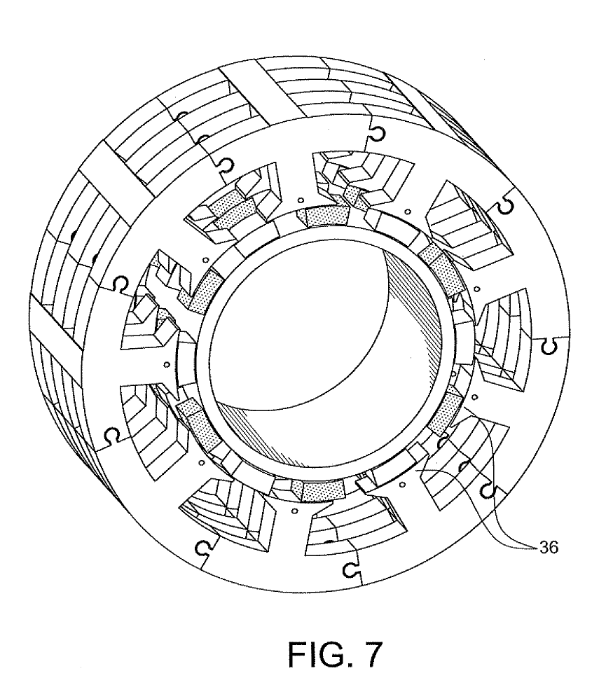

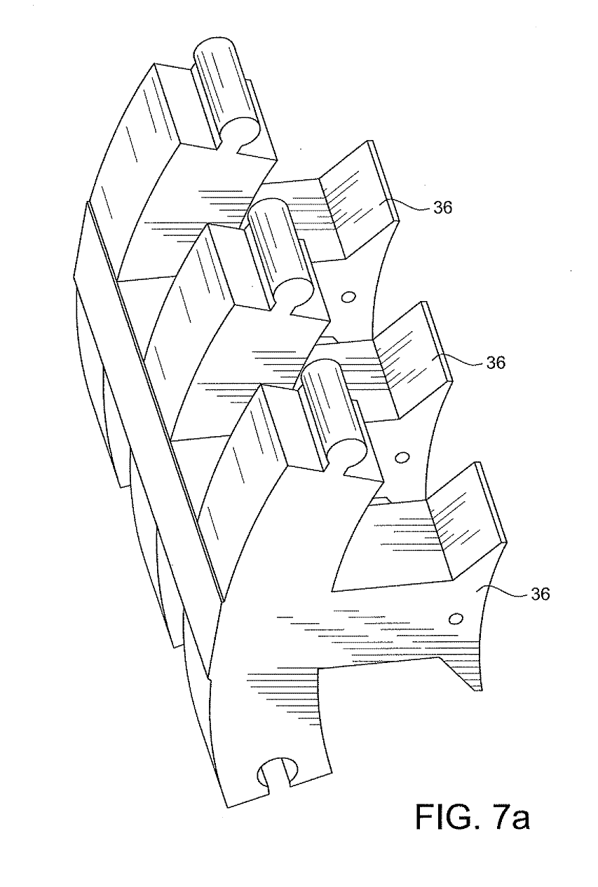

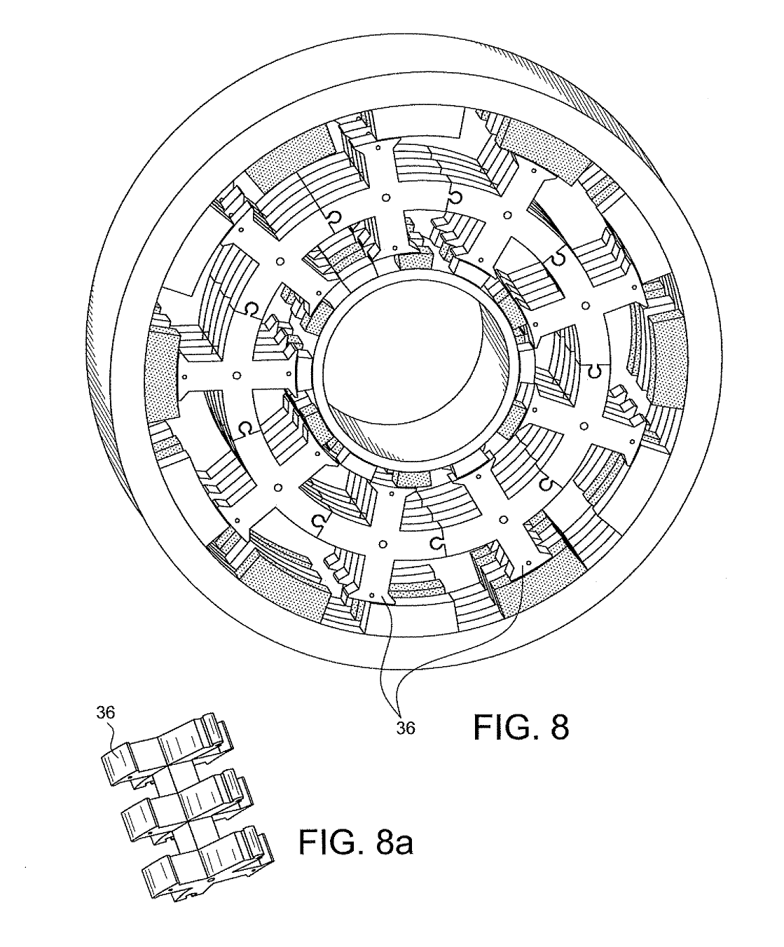

The shapes of the poles may also be varied as desired. For example, to increase the pole area, ends 36 of the poles may be flared or widened as illustrated in FIGS. 7 and 7a, which show an electrical machine that otherwise corresponds to that of FIGS. 2 and 2a. The same flaring may be applied to other embodiments, for example as illustrated in FIGS. 8 and 8, which show an electrical machine that otherwise corresponds to that of FIGS. 4 and 4a-4c.

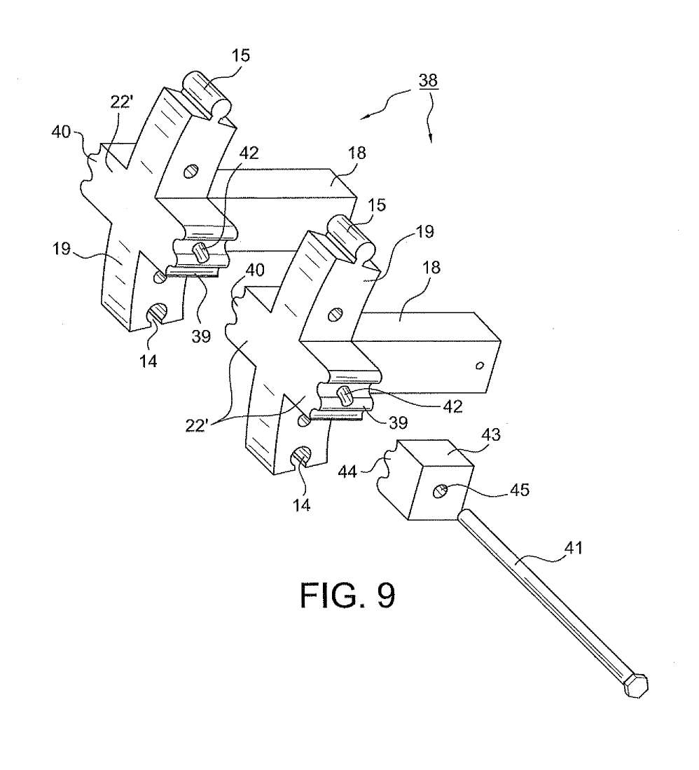

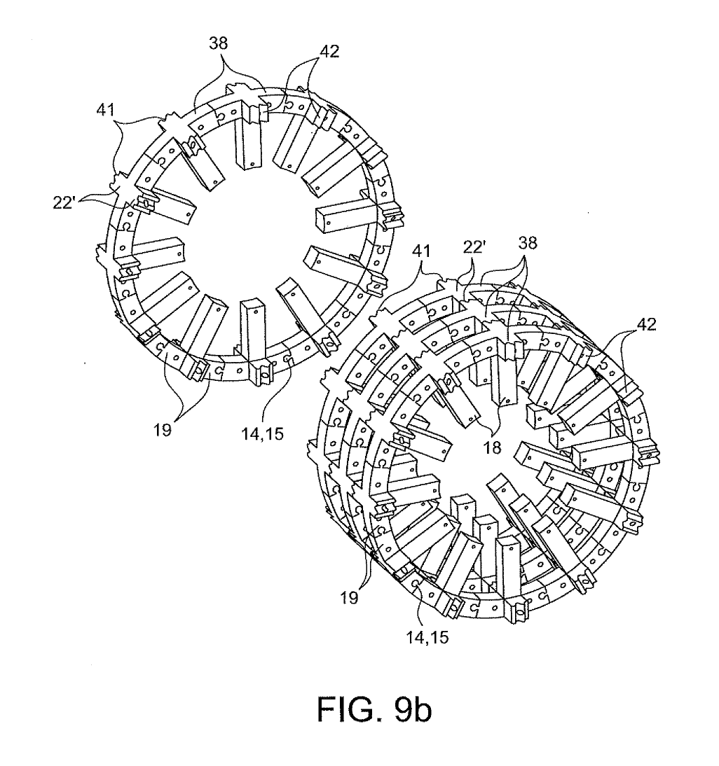

FIG. 9 shows an alternate construction of a pole structure modules or units 38 for a three-dimensional electrical machine of the type illustrated in FIGS. 3, 3a, and 3b, in which at least one of the mortise and tenon joints 14/15 of the vertical connecting arms 22 is replaced by non-interlocking interfaces 39 and 40 held together by a pin 41 that extends through holes 42 in the modified vertical connecting arms 22′ of the modules or units 38 to be connected or joined. As with the mortise and tenon arrangement 14,15 illustrated in FIGS. 3, 3a, and 3b, interfaces 39 and 40 have a non-planar surface to increase the surface area for flux to pass from one module to another, and the mortise and tenon arrangement is still used for the curved sections 19, as illustrated in FIG. 9a, but the rings thus formed are pinned or screwed together as shown in FIG. 9b.

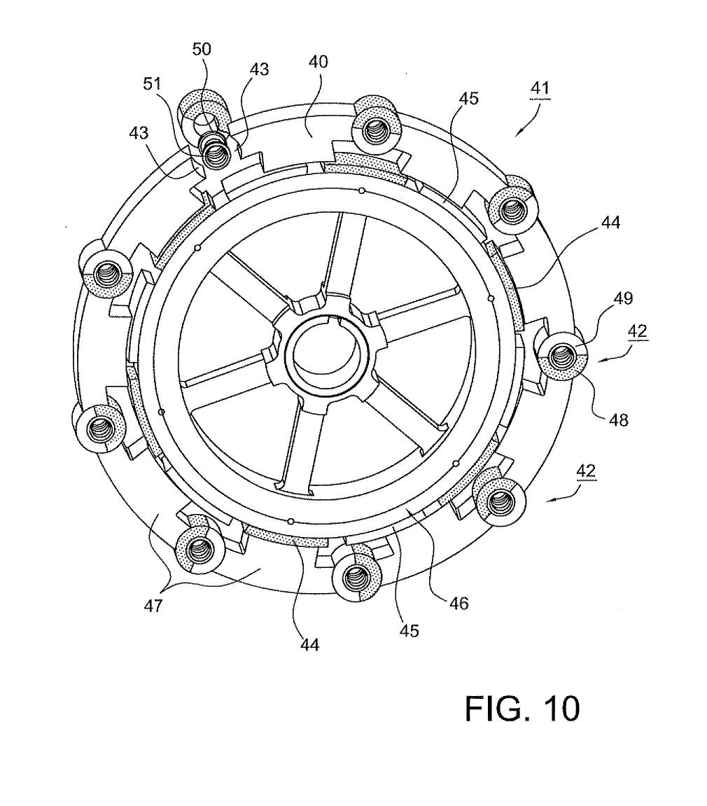

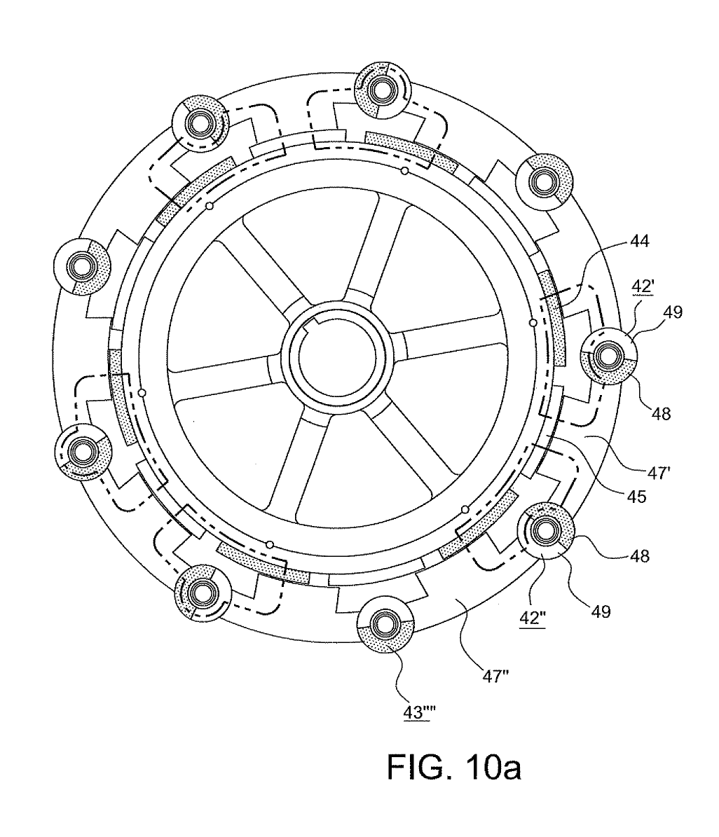

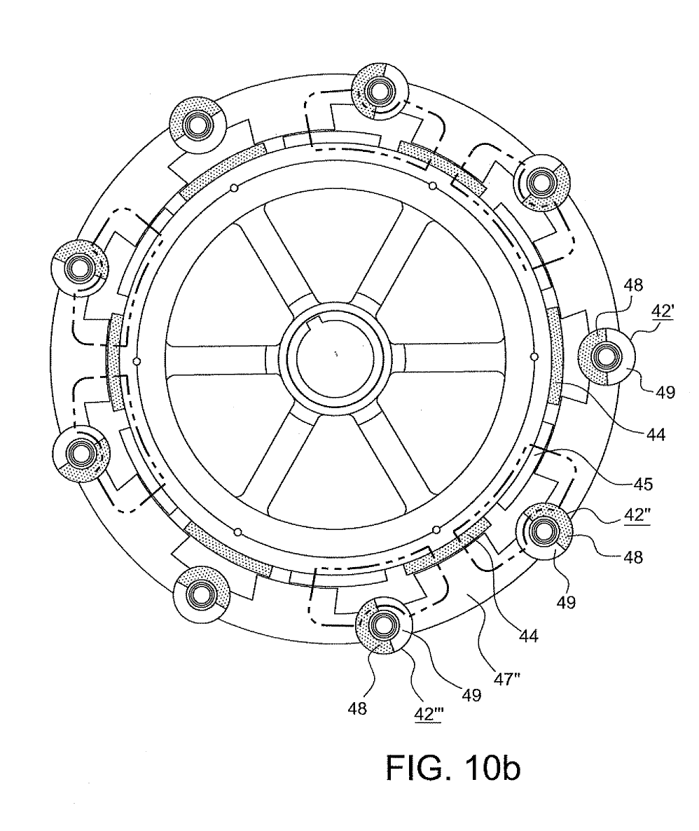

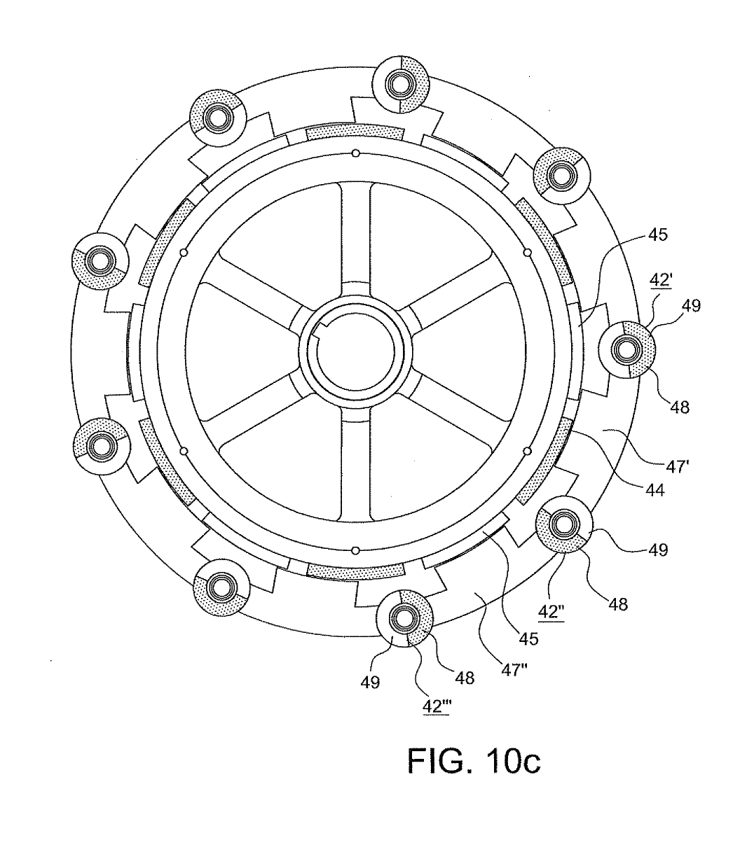

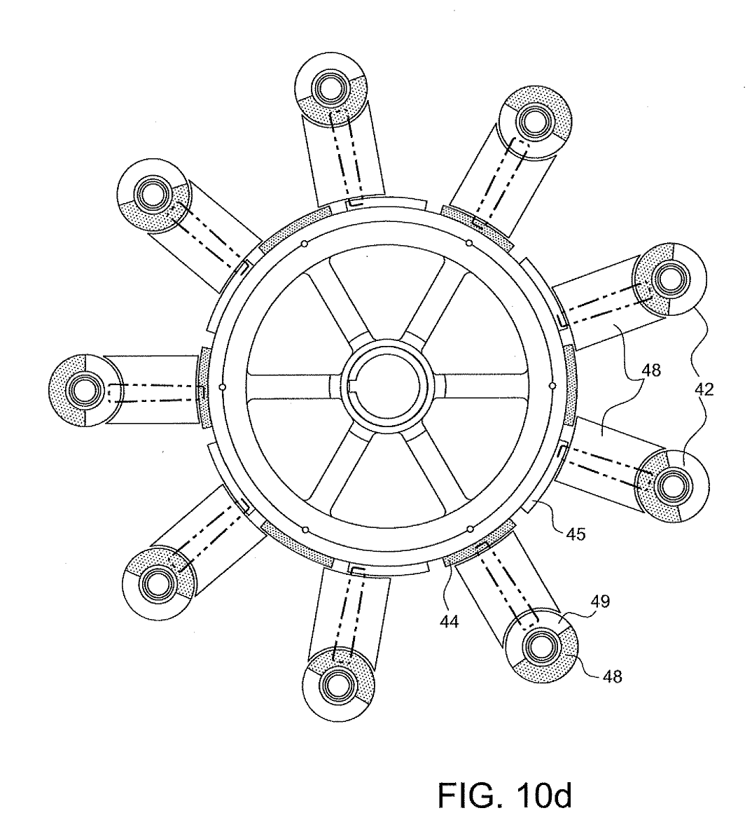

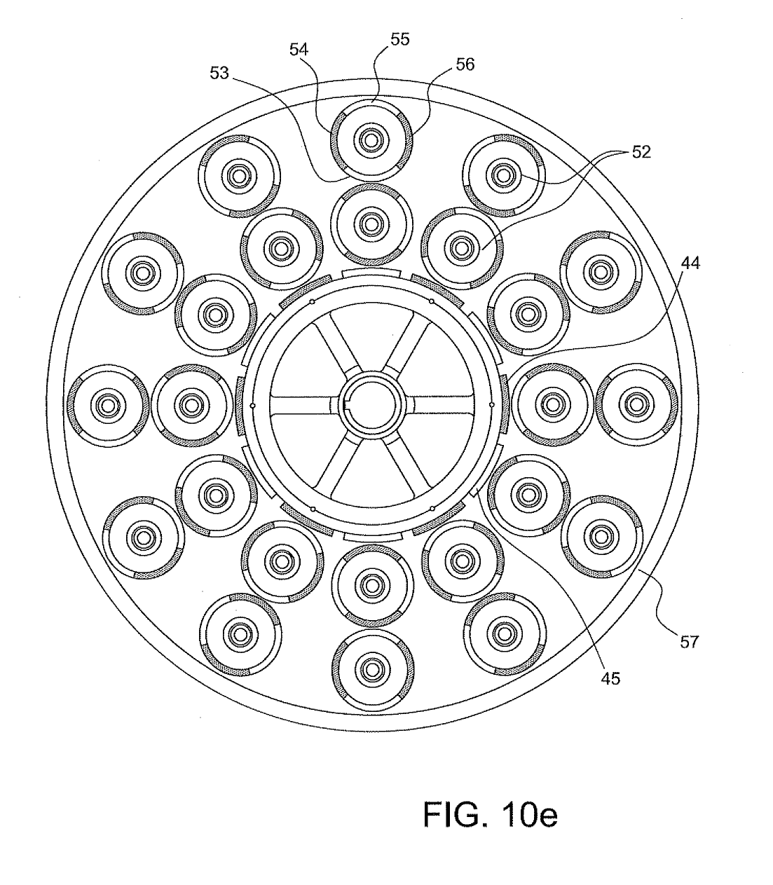

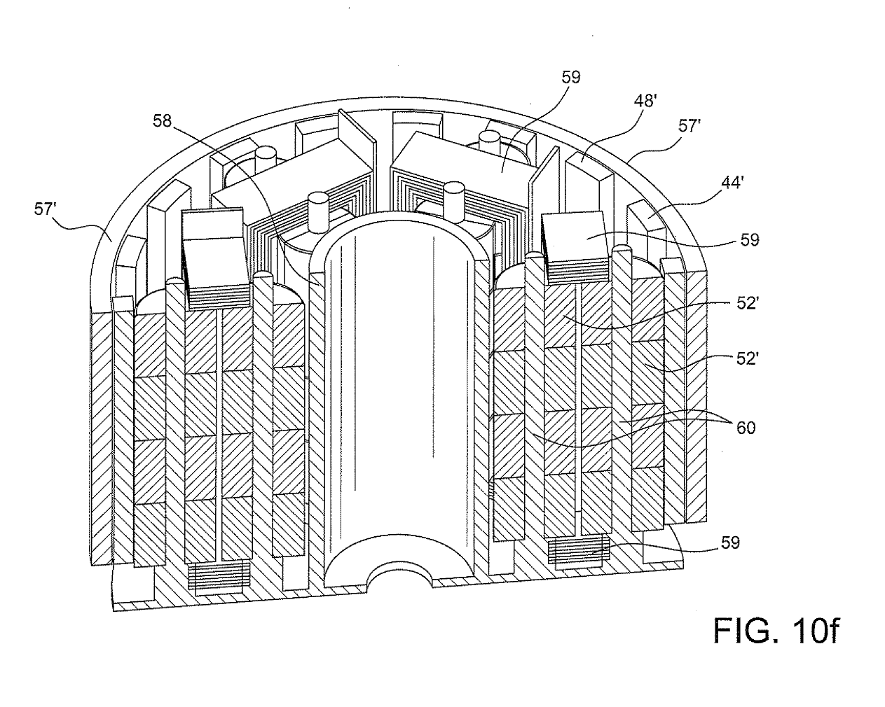

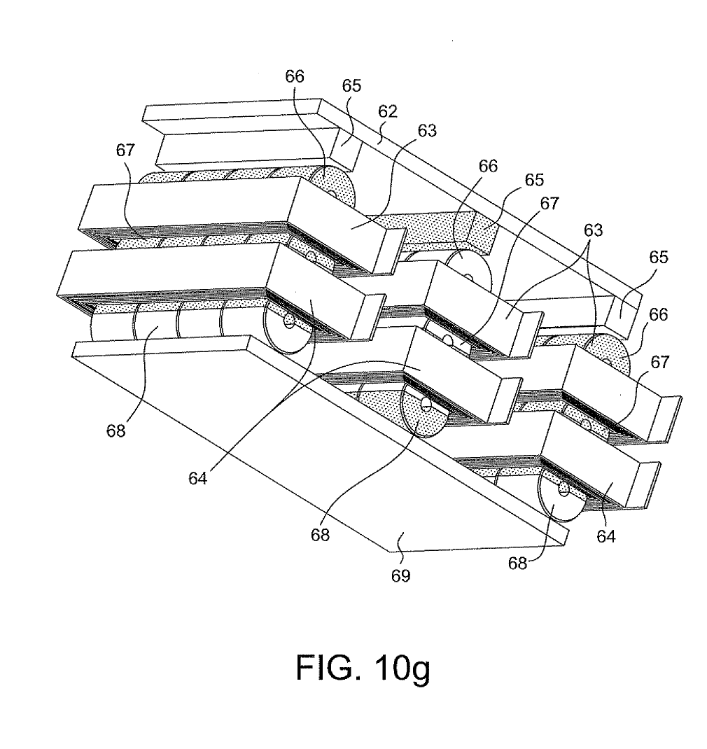

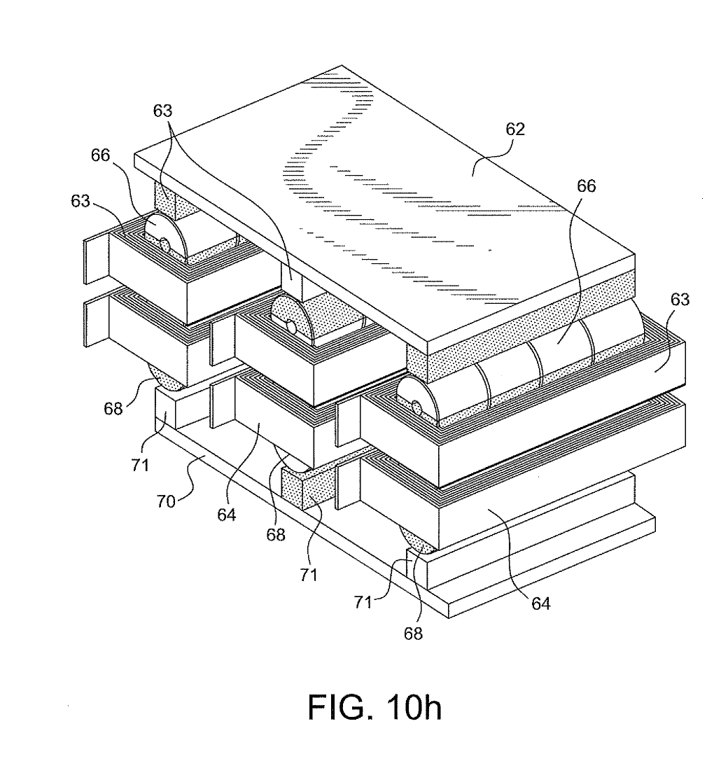

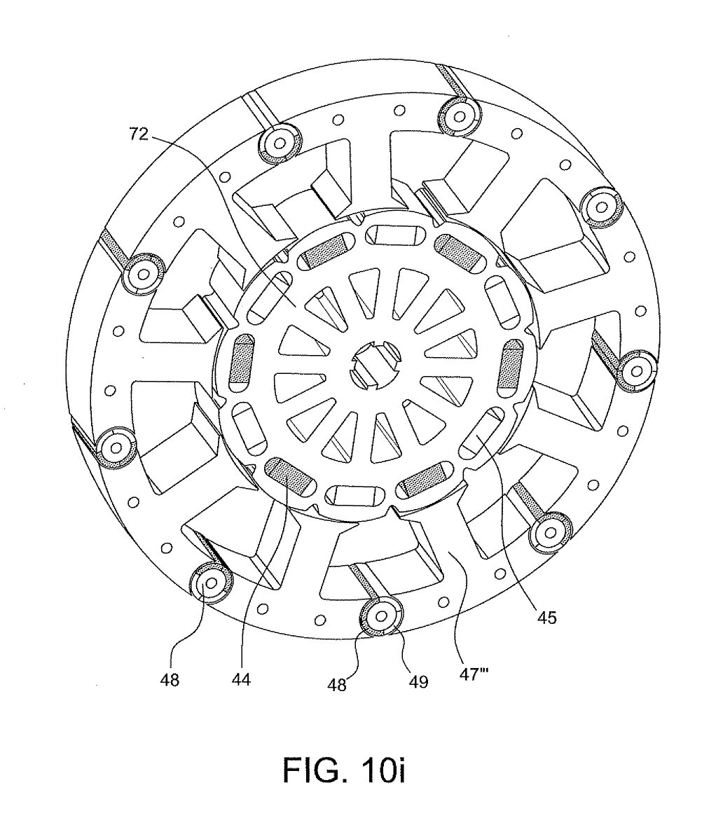

FIGS. 10 and 10a show a second preferred embodiment of the invention, in which the flux return ring 40 of a stator structure 41 includes additional rotating auxiliary permanent magnets 42. Because auxiliary permanent magnets 42 are rotatable, respective poles of the magnets will turn to face poles of opposite polarity that form on auxiliary pole faces 43 of the return ring 40 in response to movement of respective permanent magnets of opposite polarity 44,45 of a rotor structure 46 past the main pole arms 47 of the stator structure 40. As a result, the auxiliary permanent magnets 42 boost or amplify the reversing magnetic flux, thereby reducing energy losses in the ring and increasing the efficiency of the electrical machine. Auxiliary permanent magnets 42 are preferably cylindrical in shape, with each respective half cylinder 48,49 having an opposite polarity, the cylinders being mounted on axles (now shown) by means of bearings and/or fasteners 50,51 so as be freely rotatable in response to changes in the polarity of flux at the auxiliary pole faces 43.

The manner in which auxiliary permanent magnets 42 rotate can be understood by comparing FIGS. 10a, 10b, and 10c, which all show the same electrical machine as FIG. 10. For purposes of this description, two of the poles in each of FIGS. 10a-10c have been respectively labeled as pole arms 47′ and 47″, while one of the auxiliary permanent magnets 42 has been labeled as element 42′ and the other as element 42″. In the initial position shown in FIG. 10a, magnet 45 having a first polarity faces pole arm 47′, and therefore because opposite poles of a magnet attract, poles 48 of pole structures 42′ and 42″ both face in the direction of pole 47′. However, in the position shown in FIG. 10b, a permanent magnet 44 having a polarity opposite that of permanent magnet 45 has moved to face main pole 47″ while pole 47′ now faces magnets of opposite polarity, causing auxiliary magnet 42′″ to rotate 90 degrees such that pole 49 now faces in the direction of pole arm 47″. Further rotation of the rotor brings permanent magnet 45 back to a position opposite the pole arm 47″, causing the magnets 42″ and 42′″ to rotate an additional 180° so that poles 48 now face the pole arm 47″. Thus, the magnets 44 all rotate independently so that opposite poles 48,49 face whichever pole arms 47 that are being passed by permanent magnets 44 or 45 of opposite polarity, providing a continuous flux boosting or amplifying effect.

The rotating auxiliary permanent magnets 42 of the embodiment of FIG. 10 need not be placed in a flux return ring, but rather may be placed at the end of radially extending pole arms 48, as shown in FIG. 10d, or elsewhere in the stator structure.

In addition, the number of auxiliary permanent magnets of the embodiment of FIG. 10 is not limited to one for each pole, and the number of poles is not limited to two for each auxiliary permanent magnet. For example, FIG. 10e shows a further variation of the embodiment of FIG. 10, in which multiple auxiliary permanent magnets are provided for each magnetic flux circuit, and the auxiliary permanent magnets 52 each have multiple poles. By way of example and not limitation, two auxiliary permanent magnets 52, each with four poles 53-56, may be provided for each main permanent magnet 44,45. In this embodiment, the radially innermost set of auxiliary permanent magnets 52 may be coupled to the rotor by a drive wheel or drive train (not shown) to rotate in synchronism therewith, while the radially outermost set of auxiliary permanent magnets may be freely rotatable to follow the reversing flux provided by the first set of permanent magnets. In addition, the outermost cylinder 57 may be made of a permeable material such as steel to provide a closed loop magnetic flux return path.

FIG. 10f shows a variation of the electrical machine of FIG. 10e, in which the permanent magnets 44′,45′ are positioned on the outer cylinder 57′ to form a rotor, and the inner cylinder 58 provides a fixed flux return path. FIG. 10e also shows the placement of coil windings 59 around the respective auxiliary permanent magnets 52′. In this arrangement, as the outer cylinder 57′ rotates, main permanent magnets 44′ and 45′ successively pass rotatable auxiliary permanent magnets 52′, causing the auxiliary permanent magnets to rotate around axles 60 and in turn inducing a flux in the coil windings 59, made of a suitable electrically conductive material such as copper. The rotating auxiliary permanent magnets 52′ also induce flux in inner cylinder 58 to complete a magnet circuit between adjacent auxiliary permanent magnets. In order to permit rotation of the auxiliary permanent magnets 52′, thin gaps are provided between the inner and outer auxiliary permanent magnets, and between the auxiliary permanent magnets and the outer and inner cylinders. As illustrated, each auxiliary permanent magnet 52′ includes two hemi-cylindrical poles, although the number of poles may be increased as illustrated in FIG. 10e.

The principle of using rotatable auxiliary permanent magnets to increase flux density, as illustrated in FIGS. 10a-10f, may also be applied to a linear electrical machine arrangement, as illustrated in FIGS. 10g and 10h. As illustrated in FIG. 10g, a linear electrical machine arrangement includes an armature 62 that is movable relative a set of coils 63,64 (or a set of coils 63,64 that is movable relative to armature 62). The armature 62 includes a set of main permanent magnets 65, with adjacent magnets being of opposite polarity, and the armature 62 preferably being made of a magnetically permeable material. A set of rotating auxiliary permanent magnets 66-68 is provided for each main permanent magnet 65. The auxiliary permanent magnets are freely rotatable in response to follow the changing polarity of the main permanent magnets 65 as the main permanent magnets are moved relative to the closest auxiliary permanent magnets 66, movement of which in turn causes corresponding rotation of auxiliary permanent magnets 67 and then auxiliary permanent magnets 68. The changing magnetic fields resulting from rotation of the auxiliary permanent magnets in turn induces currents in the coils 63,64. A flux return path may be provided by soft magnetic member 69 extending parallel to the armature 62, but fixed relative to the coils. As with any electrical machine, the electrical machine of FIG. 10g may also be operated as a motor or linear actuator by appropriate energization of the coils 63,64 to cause rotation of the auxiliary permanent magnets 66-68 and corresponding movement of the main permanent magnets 65 and armature 62 (or movement of the coils 63,64 relative to the armature 62 and main permanent magnets 65). As with the rotary electrical machines of FIGS. 10a-10f, the numbers of coils, main permanent magnets, and auxiliary permanent magnets may be varied, each auxiliary permanent magnet may two poles or a multiple of two poles and, in addition, a second armature 70 with a second set of main permanent magnets 71 may also be provided, as illustrated in FIG. 10h.

Finally, with respect to the second preferred embodiment of the invention, FIG. 10i shows a modification of the electrical machine of FIGS. 10 and 10a-10c, including a modified magnetically-permeable rotor structure 72 that surrounds the permanent magnets 44,45, and in which the pole structures 47′″ are flared to provide improved magnetic coupling with the rotor structure 72. Those skilled in the art will appreciate that the variations illustrated in FIGS. 10d-10h are just some of the numerous variations of the rotating auxiliary magnet embodiment of FIG. 10.

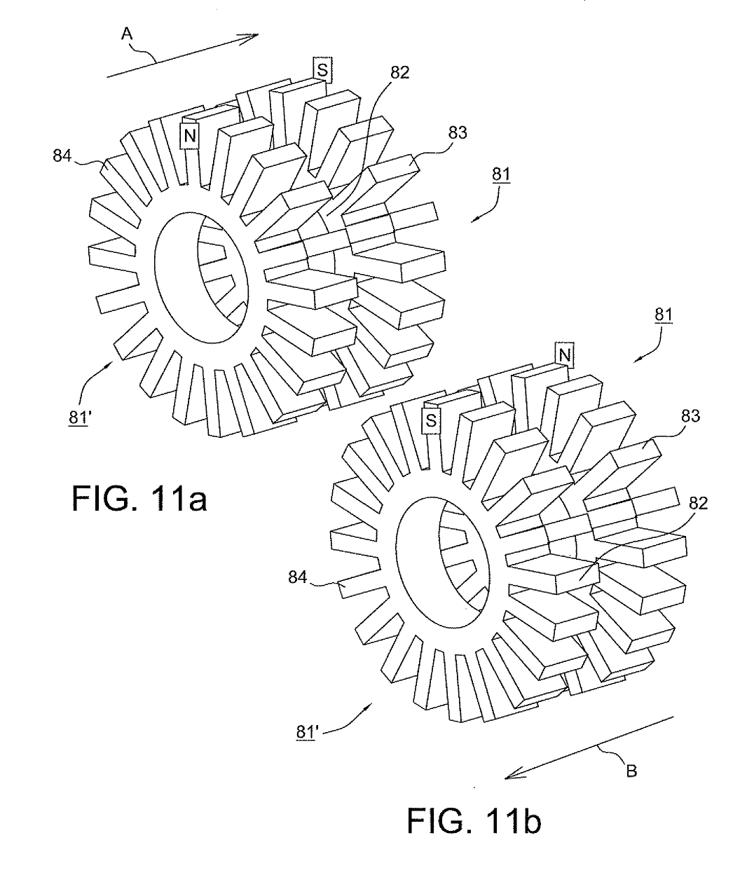

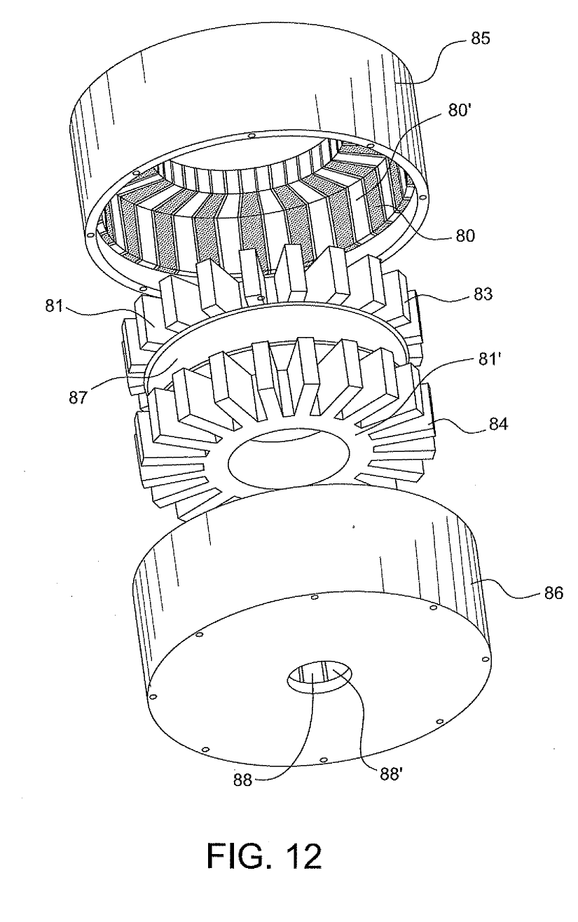

The embodiment of FIGS. 11a, 11b, 12, and 13 takes a different approach to increasing flux density. In this embodiment, magnetic flux is induced by movement of permanent magnets 80 and 80′ of opposite polarity (see FIG. 12) with respect to a pair of relatively rotating pole structures 81 and 81′. In particular, as shown in FIG. 11a, as a permanent magnet 80 of first polarity on a first housing half 85 passes a pole 83 of the first rotating pole structure 81 (or pole 83 passes magnet 80), magnetic flux is induced in the first rotating pole structure and caused to flow in the direction of, for example, arrow A, from the pole 81 through a connecting cylinder 82 fixed to the first rotating pole structure and from the connecting cylinder 82 to a pole 84 of the second rotating pole structure 81′. The second rotating pole structure 81′ is also fixed to the connecting cylinder 82 and faces a permanent magnet 88 or 88′ of opposite polarity on a second housing half 86. Subsequently, as a permanent magnet 80′ of opposite polarity on the first housing half 85 passes the pole 83, the direction of magnetic flux through the connecting cylinder 82 reverses, as indicated by arrow B. The flux then continues to reverse each time a permanent magnet 80,80′ of opposite polarity passes the pole 83, inducing an alternating current in a winding or coil 87 that surrounds the connecting cylinder 82.

The embodiment of FIGS. 11a, 11b, 12, and 13 is known as a “mono coil” electrical machine because the coil or winding 87 that surrounds the magnetic flux carrying connecting member 82 may be a single coil. The basic principle is, in the case of a generator, to induce current in the winding 87 by causing a reversing flux to pass through a structure 82 that passes through the winding or, in the case of a motor, to cause reversing fluxes in the pole structures 83,84 in response to alternating current in the coil or winding 87. Because it is necessary for the flux to flow in one direction at any given instant, the total number of pole structures 83,84 must be half the total number of permanent magnets 80,80′, so that only magnets of like polarity face the pole structures on each respective side of the pole structure at any given time.

As in any electrical machine, rotating and fixed structures may be interchanged since the motion only needs to be relative motion. All flux carrying structures must be made of a magnetically permeable material, but the invention is not limited to a particular material. These flux carrying structures may include housings 86 and 87, so as to provide flux return paths for the permanent magnets 80,80′ and 88,88′. Suitable materials for pole structures 81,81′ and connecting structure 82, from a manufacturing and cost standpoint, are a soft magnetic compound (SMC) or plastic bonded iron powder (PBIP), while the housing halves 86 and 87 may be made, by way of example and not limitation, of steel. As in the previously-described embodiments of the invention, the permanent magnets may be any material, with rare earth permanent magnets providing greater efficiency at greater cost.

A particular advantage of the electrical machine shown in FIGS. 11a, 11b, 12, and 13 is that the poles 83,84 extend radially to form fins. As the fins 83,84 move relative to the housing, they cause air to circulate within the housing of the electrical machine, thereby providing a cooling effect. In addition, the bobbin around which the coil 87 is wound may be arranged to serve as a heat sink, and the windings may be made of hollow copper tubes that can carry a coolant such as oil. It is even possible to use a fluid with magnetic properties as the coolant, with the changing flux through the coil helping to circulate the fluid by magnetic interaction.

Although the fins are illustrated as being aligned with the axis of the electrical machine, it will be appreciated that the angle of the fins may be varied, for example to prevent cogging.

In this embodiment, there are 20 fin-shaped poles 83,84 in each pole structure 81,81′, and 40 permanent magnets 80,80′ and 88,88′ in each of the housing halves 85,86. The permanent magnets 80, 80′ and 88, 88′ are aligned with the fins in an axial and radial fashion. However, it will be appreciated that the numbers of poles and permanent magnets may be varied so long as the pole and permanent magnets can be aligned to cause reversing magnetic fluxes as the poles move relative to the permanent magnets, i.e., so long as the number of permanent magnets of alternating polarity is twice the number of facing pole structures.

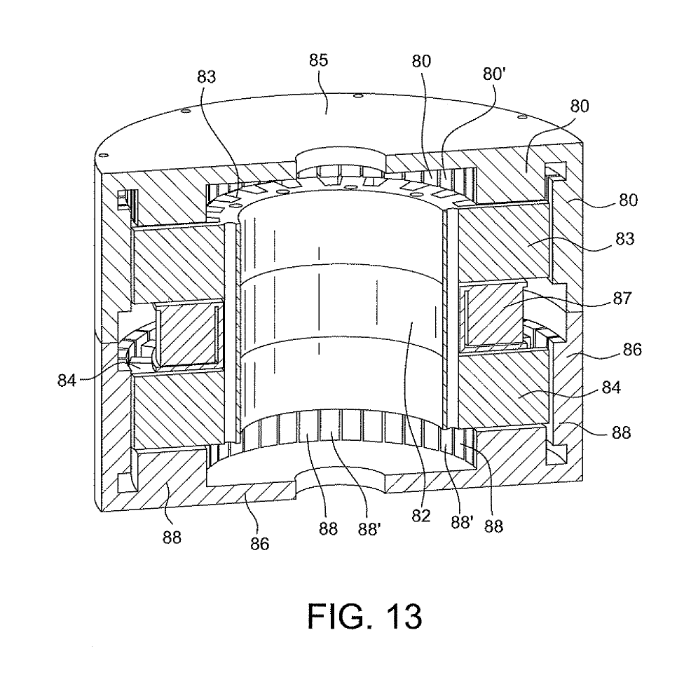

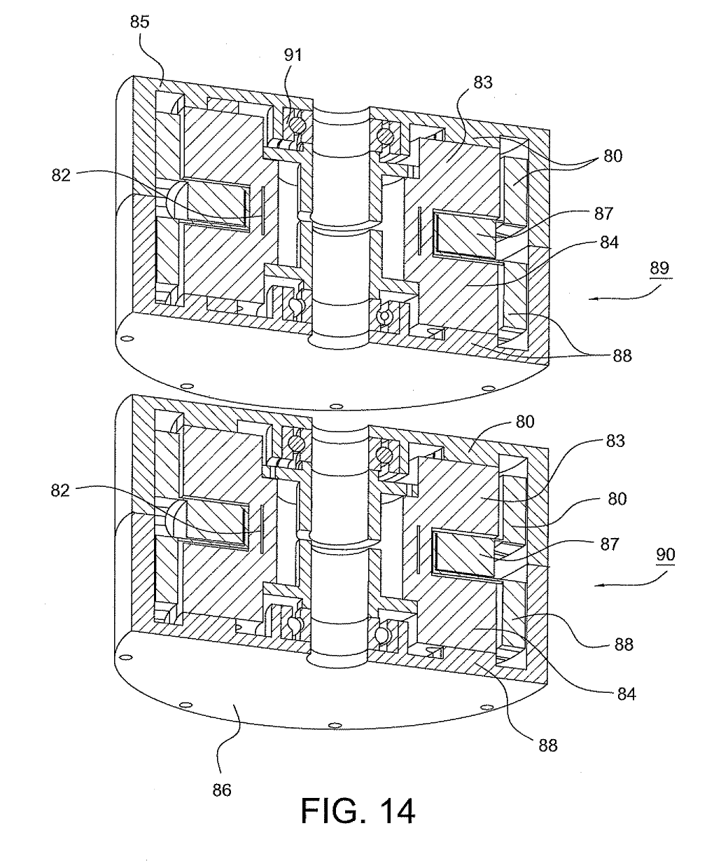

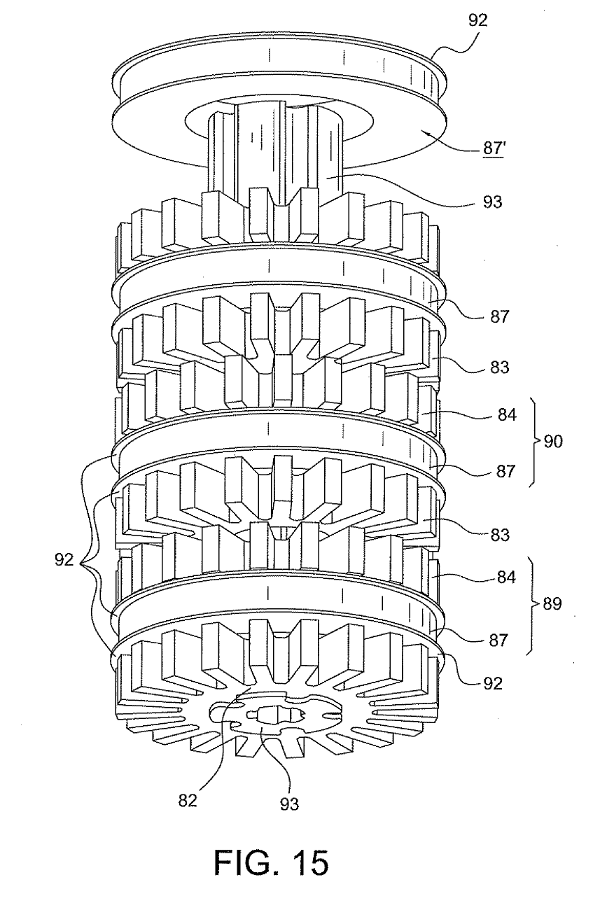

Although a mono coil is illustrated, it will be appreciate that multiple coils could be used, with windings in a same or opposite directions. In addition, mono coil generator units can be stacked in series to provide multiple phases, such as the two phase arrangement illustrated in FIG. 14 or the three phase arrangement illustrated in FIG. 15. For example, FIG. 14 shows a variation of the basic mono coil electrical machine of FIGS. 11a, 11b, and 12, in which multiple mono coil units 89,90 are arranged in series to thereby increase the number of phases of the currents in coils 87, while FIG. 15 adds an additional coil unit 94. The electrical machine shown in FIGS. 12 and 13 is a single phase A.C. electrical machine while the electrical machine shown in FIG. 14 is a two-phase A.C. electrical machine and the electrical machine shown in FIG. 15 is a three-phase low-cogging electrical machine. Also shown in FIG. 14 are bearings 91 that permit relative rotation of the poles 83,84 and the housing halves 85,86, while FIG. 15 includes an illustration of one of the bobbins, labeled as 87′, before assembly to spindle 93 to better show the structure of the coil bobbin 92.

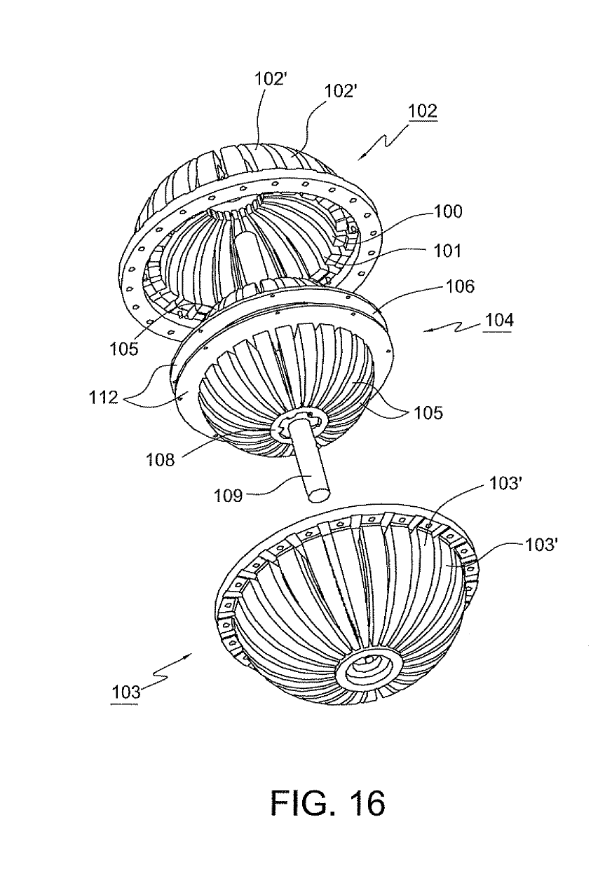

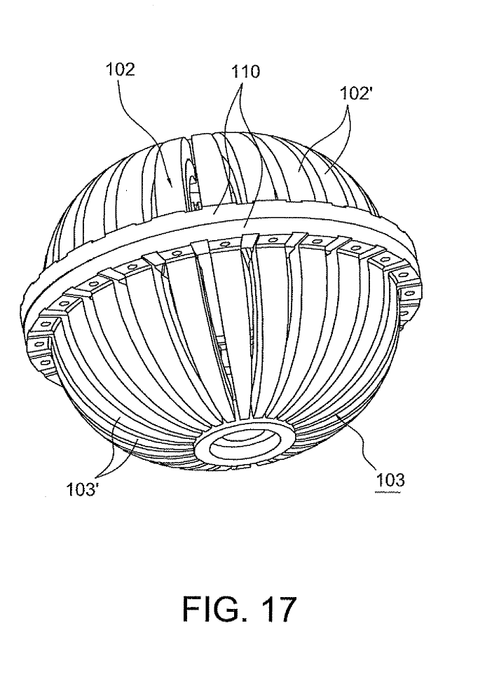

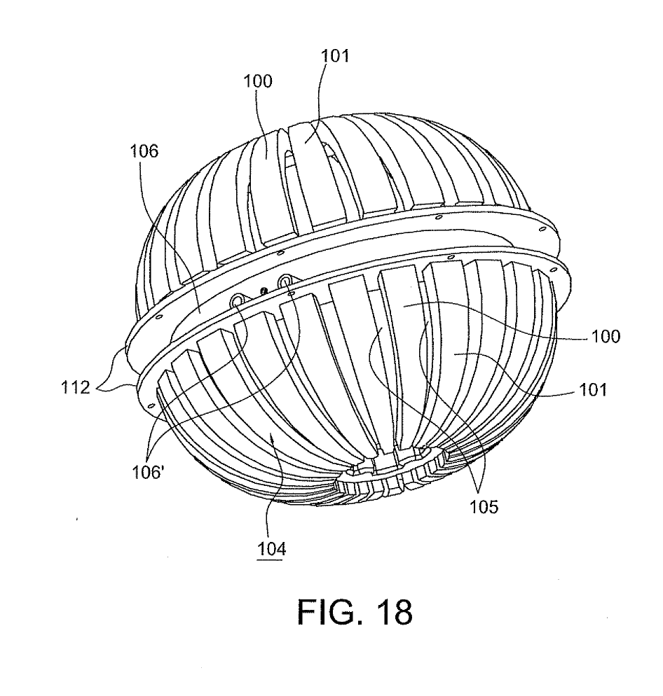

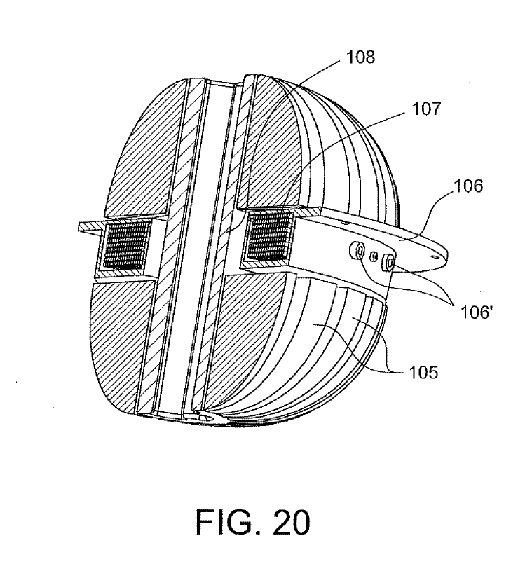

FIGS. 16-20 show a variation of the embodiment of FIGS. 11a, 11b, and 12-15, in which the mono coil electrical machine is modified to have a generally spherical or ball-shaped form. Although referred-to herein as a “ball generator,” it is will be appreciated that the electrical machine may also be configured to function as a motor.

As shown in FIGS. 16-20, the ball generator includes a mono coil structure in which permanent magnets 100,101 of alternating polarity are arranged on hemispherical housing halves 102,103 rather than on cylindrical housing halves, the pole structure 104 also having a generally spherical form made up of arc-shaped pole sections or slices 105. The number of pole sections is preferably half the number of permanent magnets 100,101 to ensure that each of the poles sees the same polarity of magnet at any instant.

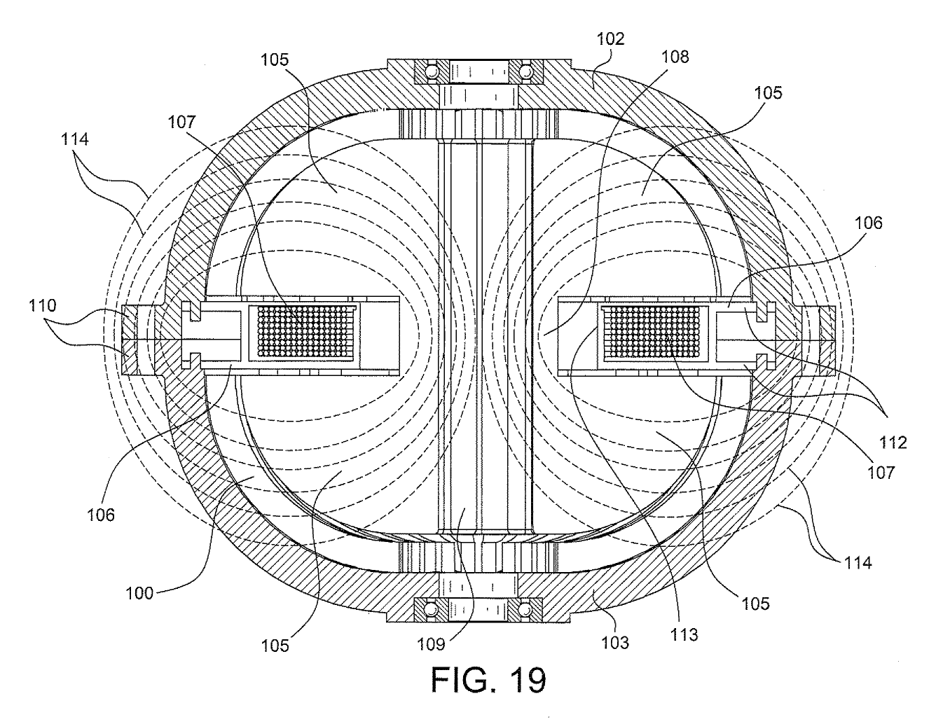

The pole structure 104 is arranged to rotate within the housing 102,103 and an annular coil holder 106 is fixed between the to the pole structure 104. An annular coil holder 105 supports a mono coil 107 (shown in FIG. 19) with a reversing flux path extending through the mono coil being provided by a cylinder-shaped magnetically permeable structure 108 rotatably mounted on an axle 109 that connects and rotates with the housing halves 102,103. The housing halves are secured together by flanges 110 on each of the housing halves, and each of the housing halves is preferably made up of sections or slices 102′,103′ that correspond in shape to the permanent magnets 100,101 to thereby provide a ventilating effect for air circulation caused by the relatively rotating pole structure 104. Flanges 112 may be used to mount the coil holder 106 to the pole sections 105 while, as shown in FIG. 19, the coil-containing inner annular space 113 of the coil holder 106 may be arranged to carry a coolant, with appropriate feedthroughs 106′ for the coil wires. Relative rotation between the magnets 100,101 and the pole sections 105 is achieved by a bearing 115.

As illustrated in FIG. 19, the ball generator operates in the same manner as the cylindrical mono coil electrical machines of FIGS. 11a, 11b, and 12-15, with the mono coil 107 being stationary relative to the pole structure 104 and arranged to inductively interact with changing magnetic flux in the central cylinder 108, into which fluxes from the pole sections 105 converge to increase the magnetic flux density and therefore the efficiency of the electrical machine. The housing halves 102 and 103 are preferably also made of a soft magnetic material to form closed flux loops, indicated by lines 114 that extend completely around the coil 107.

The use of a single coil has the advantage of increasing the flux density through the coil while also lowering weight and cost, although this embodiment does require non-standard permanent magnet shapes that might increase the cost of the magnets. On the other hand, the ball-shape acts as an efficient return path for the opposing reversing fields, and the wedge shapes of the housing sections 102′,103′ and magnets 100,101 focus the flux lines in and out of the rotor. While a single coil is illustrated, it will be appreciated by those skilled in the art that the single coil could be replaced by or separated into multiple windings in order to provide different voltage outputs for a single generator.

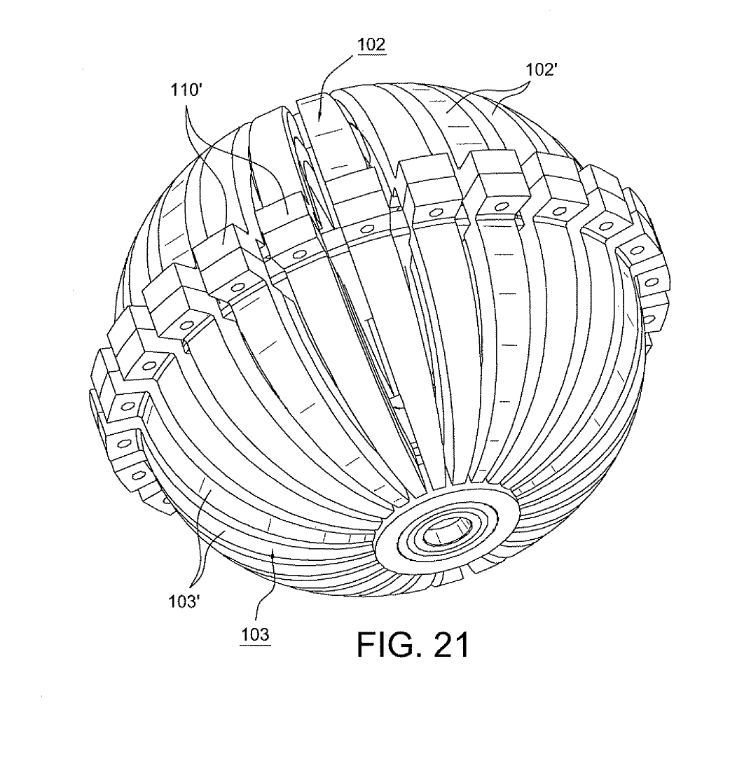

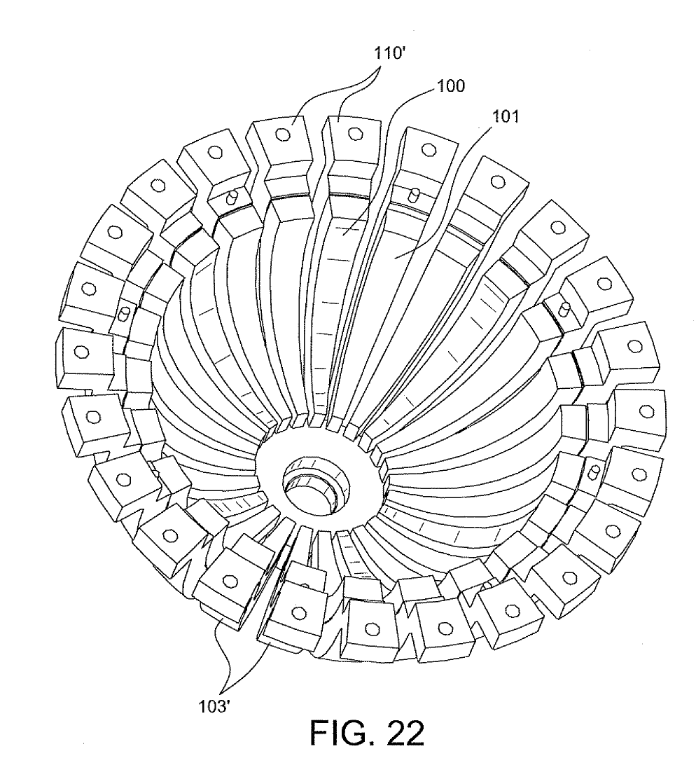

In the variation shown in FIGS. 21 and 22, the continuous flange 110 of the housing halves 102 and 103 is replaced by a discontinuous flange 110′, which has the effect of separating the magnetic flux through the housing into discrete return paths. This arrangement creates the possibility of adding auxiliary coils (not shown) to the return paths to shunt flux lines for power control, or even to produce power.

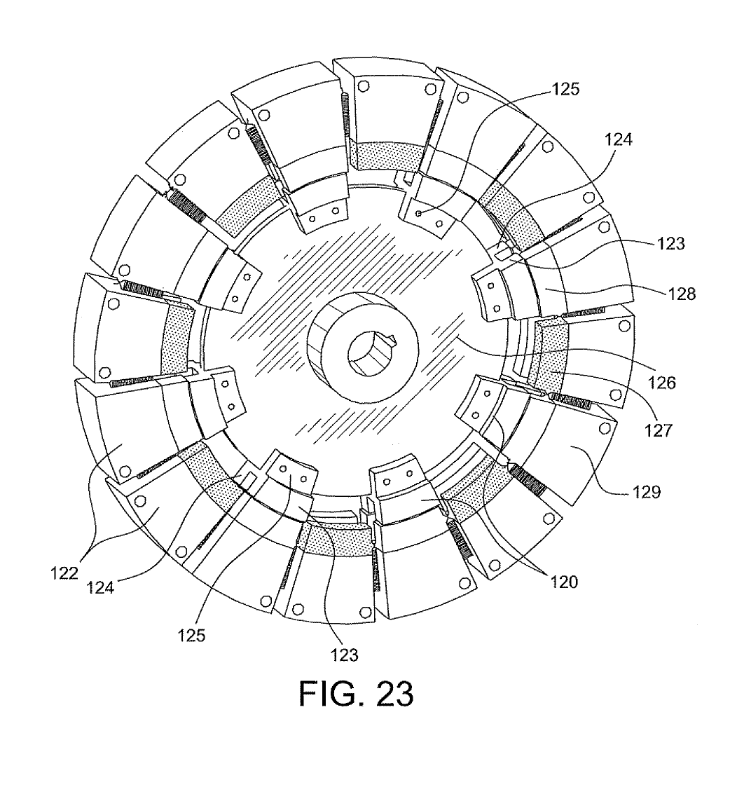

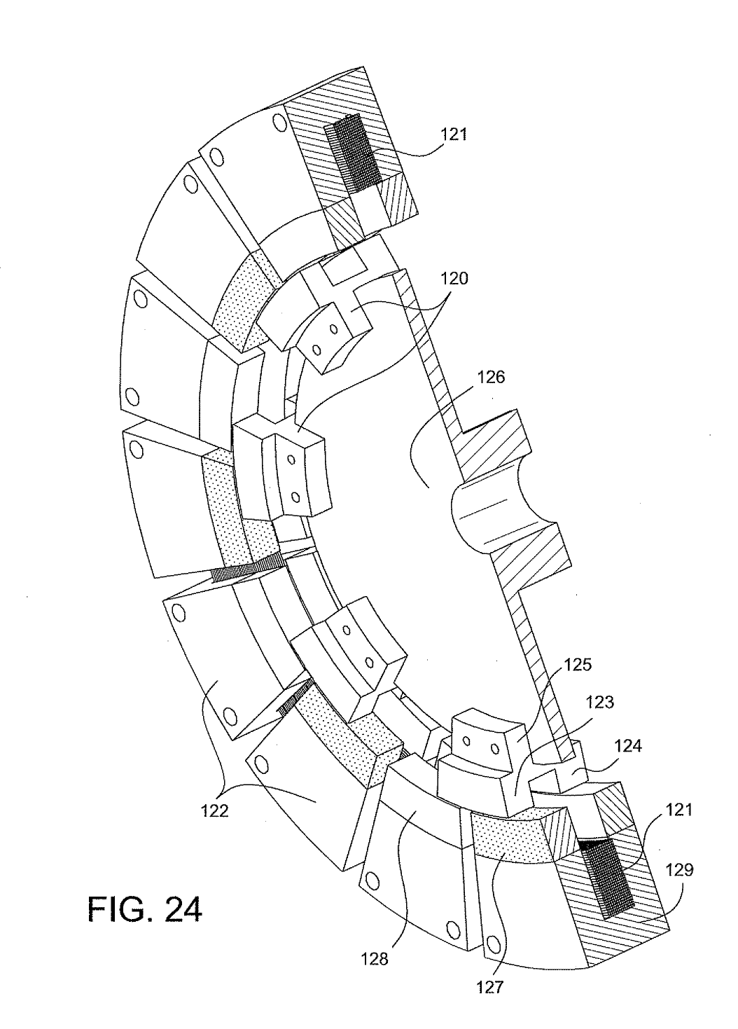

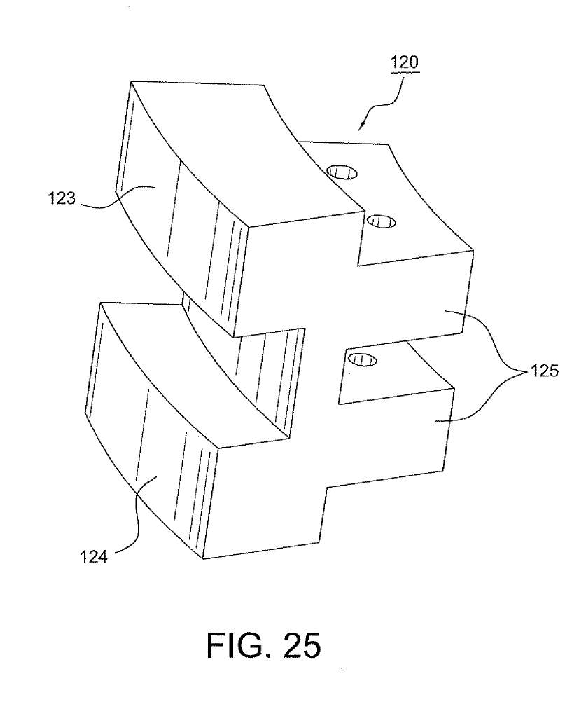

FIGS. 23-25 show a disc-shaped variation of the mono coil electrical machines of FIGS. 11a, 11b, and 12-24. The electrical machine illustrated in FIGS. 23-25 uses forked pole structures 120, as best seen in FIG. 25, to carry the reversing magnetic fluxes that induced an alternating current in the mono coil 121 shown in FIG. 24. The forked pole structures 120 include pole arms 123,124 and a c-shaped bracket 125 that is secured to a disc shaped plate member or hub 126. Disc-shaped member 126 is mounted for movement relative to a plurality of permanent magnet structures 122, each including a permanent magnet 127,128 and a c-shaped flux return member 124 that extends around the coil 121 to form a closed magnet circuit with a corresponding pole structure 120. Adjacent permanent magnets 127,128 have opposite polarities and the number of pole structures 120 is exactly half the number of permanent magnets 127,128 such that the flux through the pole structures reverses as the pole structures move between adjacent alternating polarity permanent magnets 127,128, causing corresponding reversals in current of the mono-coil.

By way of example and not limitation, the poles may be made of a soft magnetic compound (SMC) or plastic bonded iron powder (PBIP), or another magnetically permeable material such as steel, while the c-shaped flux return members 129 of the permanent structures 122 is preferably made of steel. The disc-shaped plate member or hub 126 on which the pole structures 120 are mounted may be made, for example, of steel or aluminum.

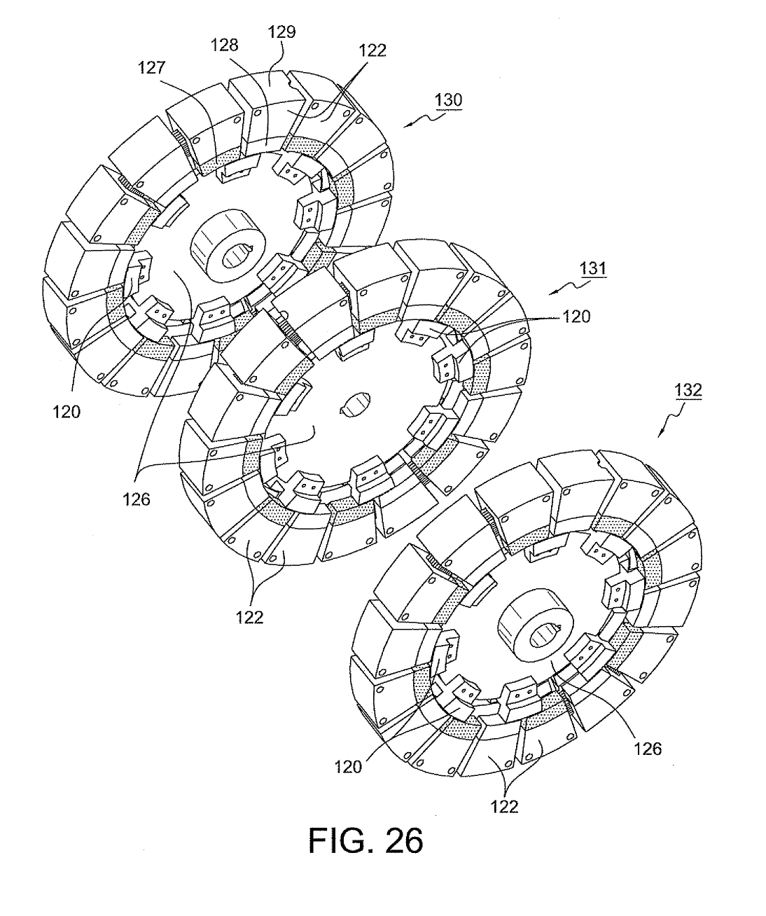

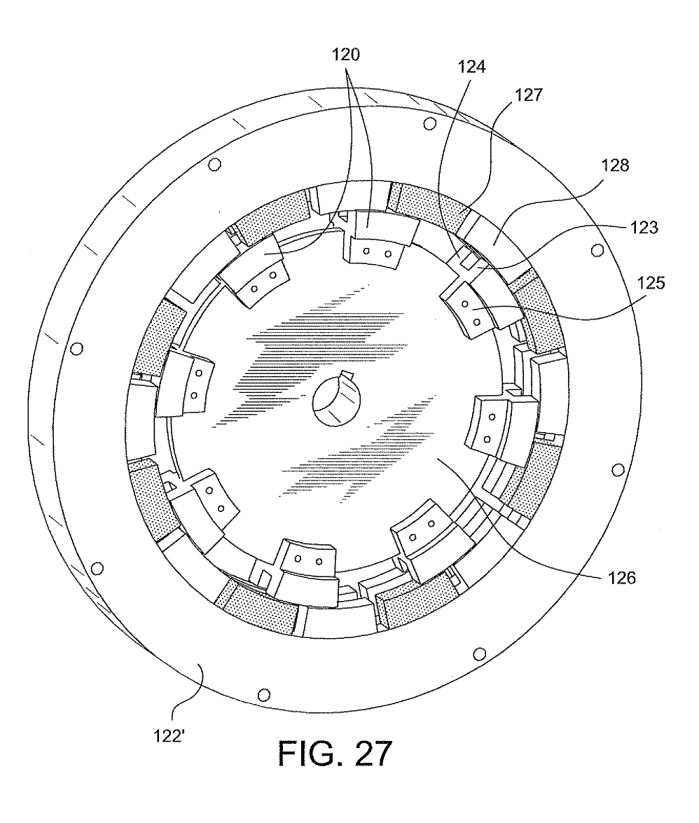

In variations of the disc-shaped electrical machine of FIGS. 23-25, disc-shaped electrical machines 130, 131, and 132 may be stacked to provide multiple phases, as illustrated in FIG. 26. In addition, as shown in FIGS. 26 and 27, the c-shaped permanent magnet structures 122 may be replaced by a single annular flux return member 122′, but the operation of the electrical machine is essentially unchanged.

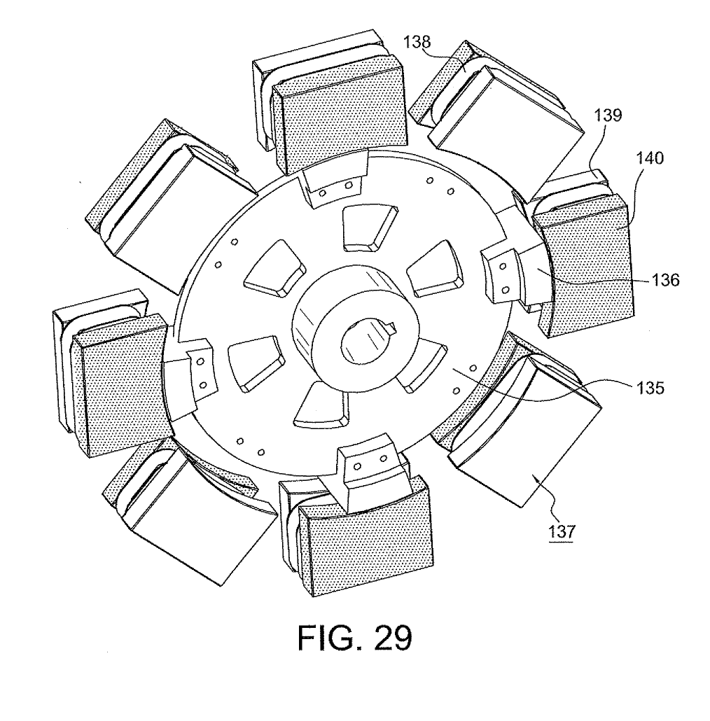

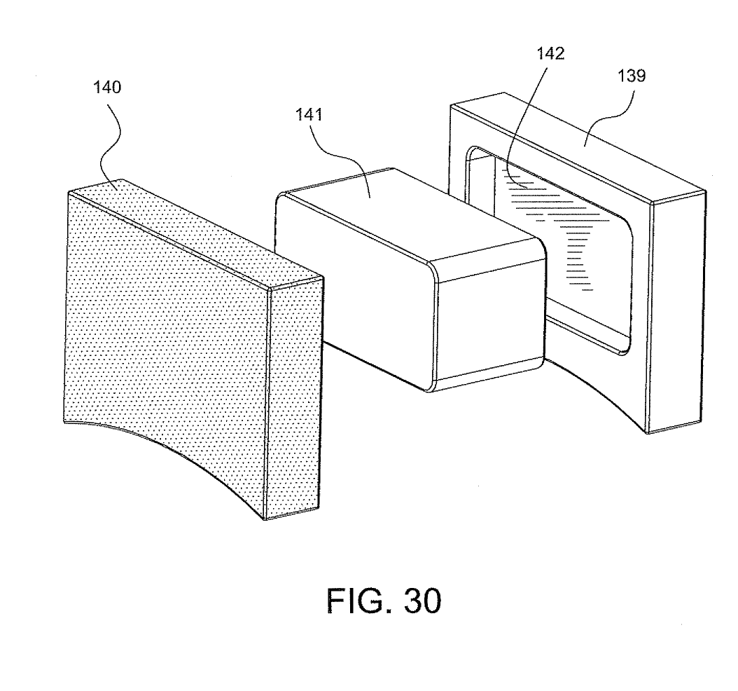

The principle of reversing flux through a mono coil can be adapted for multiple coils, as illustrated in FIGS. 29 and 30. The illustrated multiple coil electrical machine includes a rotating disc 135 with flux-reversing structures 136 that are similar to the pole structure 120 shown in FIG. 25 but without the need for separate pole arms, and discrete magnet/coil structures 137 including an individual coil 138 sandwiched between permanent magnets 139,140 of opposite polarity (or fixed disc and moving permanent/coil structures), with the number of pole structures being half the number of magnet pairs and the magnet pairs having opposite polarity around the circumference of the generator, so that the flux in the flux-reversing structures 136 changes direction as it passes from magnet pair to adjacent opposite-polarity magnet pairs 139,140.

In the configuration illustrated in FIG. 29, the current in the coil is induced by changing flux in the return path surrounding the coil caused by the effect of passing soft magnetic flux-reversing structures 136 on the fields surrounding permanent magnets 39,40. The flux in the return path does not actually reverse, but rather is distorted by the passing flux reversal structures 136. This distortion is highly dependent on the spacing and shape of the respective sets of permanent magnets and flux-reversal structures, and thus a desired current can be achieved by appropriate selection of materials and shapes of the soft magnetic structures and permanent magnets. As a result, it will be appreciate that the invention is not limited to particular shapes and materials. On the other hand, it is also possible to place the permanent magnets on the rotor disc 135, and to make structures 139-141 shown in FIG. 30 entirely out of a soft magnetic compound (SMC) or plastic bonded iron powder (PBIP) so that flux reversals occur within the bobbin structure. In that case, the number of magnets on the rotor disc would need to be double the number of bobbin/coil structures.

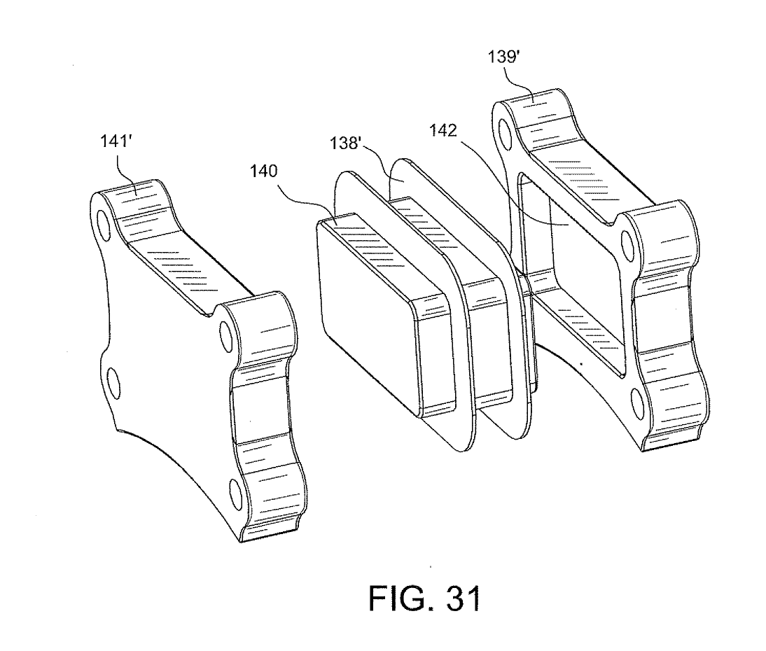

Instead of permanent magnet pairs, as shown in FIG. 29, the permanent magnet/coil structures 137 may utilize single dipole magnets 141 held by soft magnetic holder structures 139 and 140 that respective form the spindle and flanges of respective coil bobbins. In particular, the permanent magnets 139,140 of the permanent magnet/coil structures 137 may be formed with recesses 142 for holding the permanent magnet 141 which forms the central spindle of the bobbin, around which the coil is wrapped or positioned on a suitable holder. FIG. 31 shows a variation of the magnet/coil arrangement of FIG. 30, in which the permanent magnet/coil structures 139′, 140′ are modified to include mounting holes, and a coil holder 139′ is positioned on the permanent magnet/spindle 141.

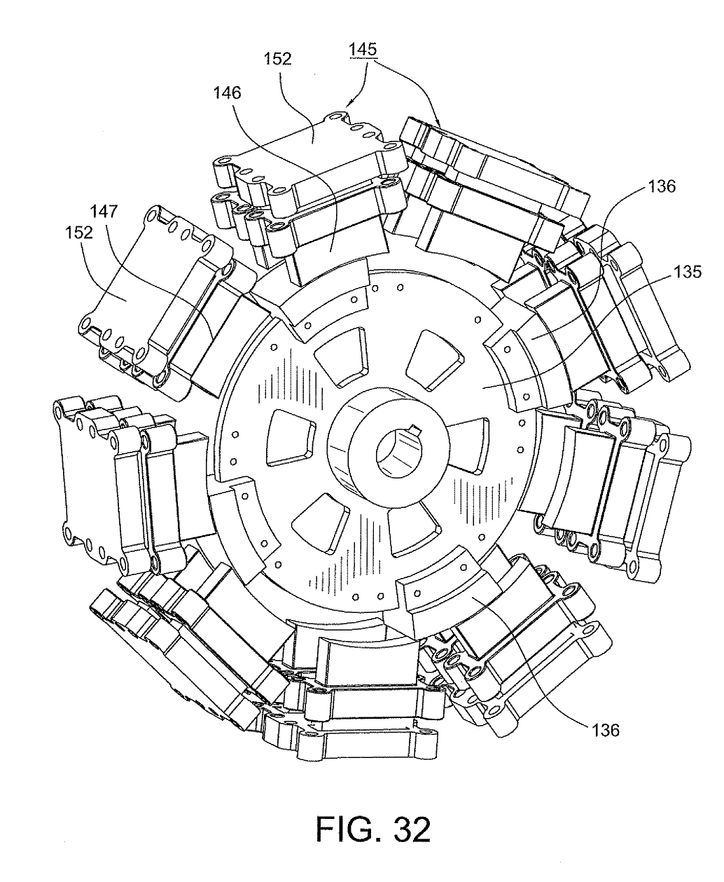

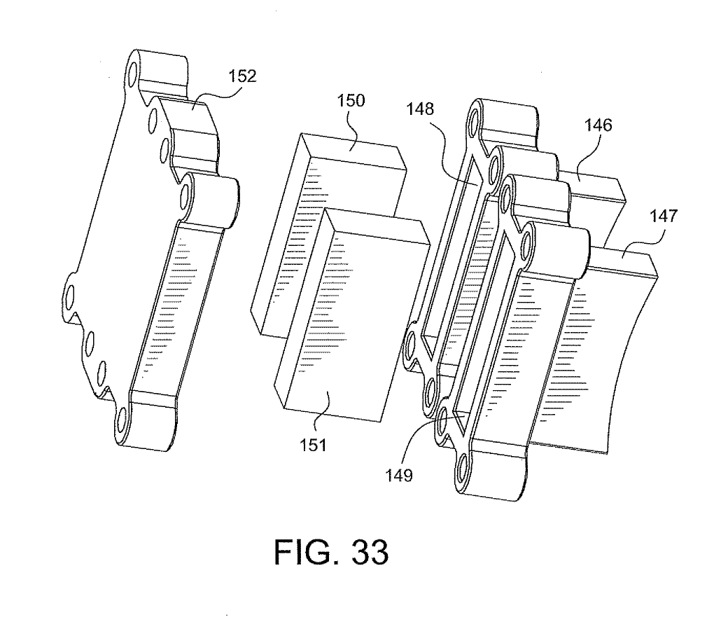

FIGS. 32 and 33 show another permanent magnet/coil structure 145 that may be used in connection with the rotor 135 and flux reversal structures 136 of FIG. 29. In this arrangement, each permanent magnet/coil structure 145 includes two soft magnetic core structures 146,147 having pockets 148,149 for respective opposite-pole permanent magnets 150,151 and a common flange 152 made of a soft magnetic material. By way of example and not limitation, the coil (not shown) may be wound around one or both of the permanent magnets, around soft magnetic core structures 146,147, or around soft magnetic core structures 146,147 and common flange 152.

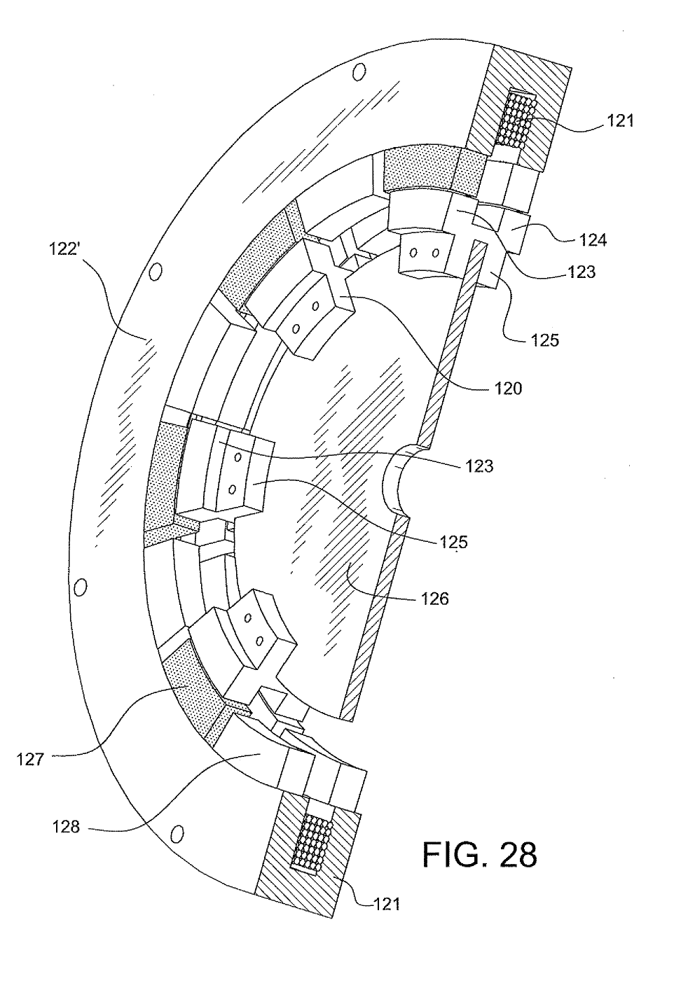

FIG. 34 shows a variation of the electrical machine of FIGS. 27 and 28, in which the permanent structures are in the form of horseshoe magnets 153 that extend around a mono coil 154. The rotor 135 and flux reversal structures 136 may be identical to those used in the embodiment of, for example, FIG. 29, although other functionally equivalent structures may be substituted. Alternatively, as shown in FIG. 35, the mono coil 154 may be replaced by individual coils 154′ wrapped around the horseshoe magnets 153. As with the other flux-reversal machines, the number of permanent magnet/coil structures is twice the number soft magnetic flux reversal structures.

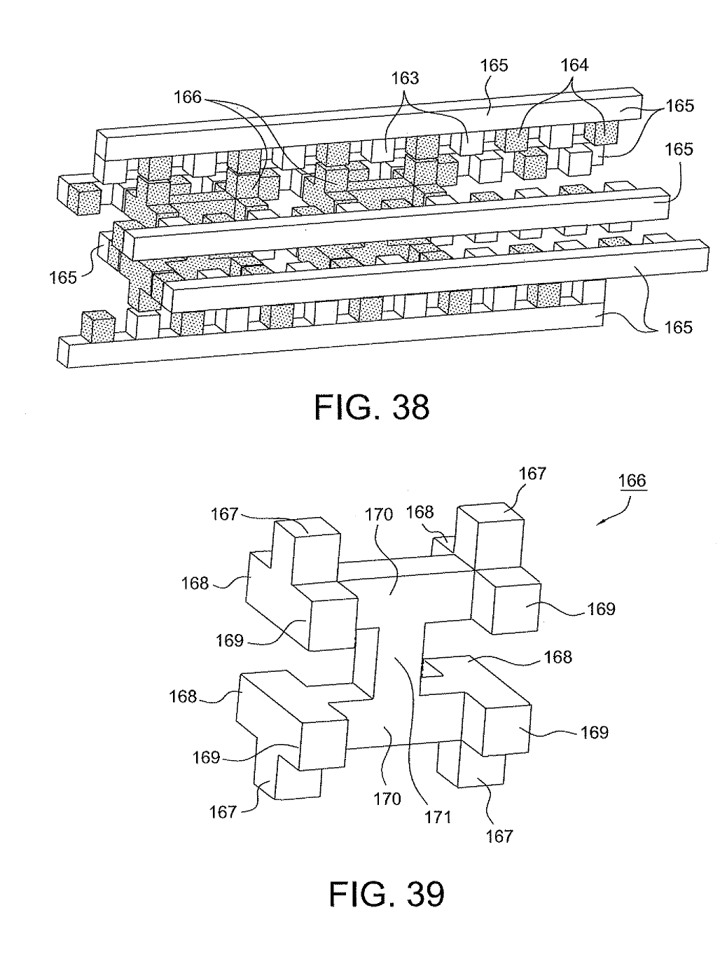

FIG. 38 shows an application of the flux reversal principles of the third preferred embodiment to a linear electrical machine. In this application, the flux reversal structures for armature sections 155 are arranged to face permanent magnets 160,161 of opposite polarity situated on stator structures 162, preferably made of a soft magnetic material to provide a flux return path for the permanent magnets. While the geometric configuration of the armature sections 155 may be varied in a variety of ways, the illustrated armature sections 155 include pole arms 156 extending parallel to the axis of the electrical machine and connected by a transverse section 157. Poles 158 also extend transversely from the pole arms 156 to face permanent magnets 160 or 161 of like polarity. It will be appreciated that an number of poles can be included on the armature sections so long as the poles on one side of a single armature section all face permanent magnets of like polarity, and the poles on the other side all face permanent magnets having an opposite polarity to the permanent magnets faced by the poles on the first side, so that flux in the transverse section 157 reverses polarity as the armature section moves along the axis of the electrical machine. While coils (not shown) could be wrapped around any section of the armatures or the stator, transverse sections 157 provide a convenient location for coils mounted on the armature. Each coil may carry a different current phase.

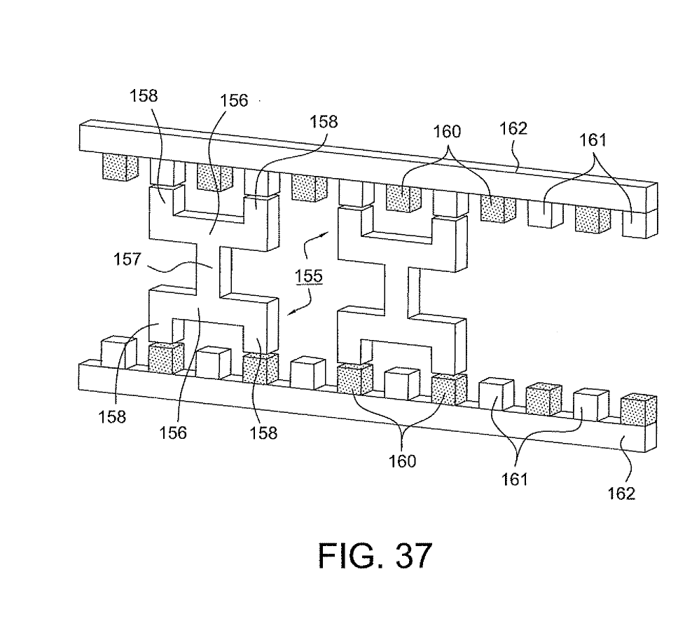

FIGS. 38 and 39 illustrate a three-dimensional version of the electrical machine of FIG. 37 that provides a higher energy density in a manner similar to the three-dimensional stator structures of the first preferred embodiment. In this variation, permanent magnets 163,164 of opposite polarity are arranged on six stator structures 165, and each armature section 166 includes three transverse pole sections 167-169 extending from opposite ends of pole arms 170, which are again connected by transverse sections 171 around which coils (not shown) could be wound.

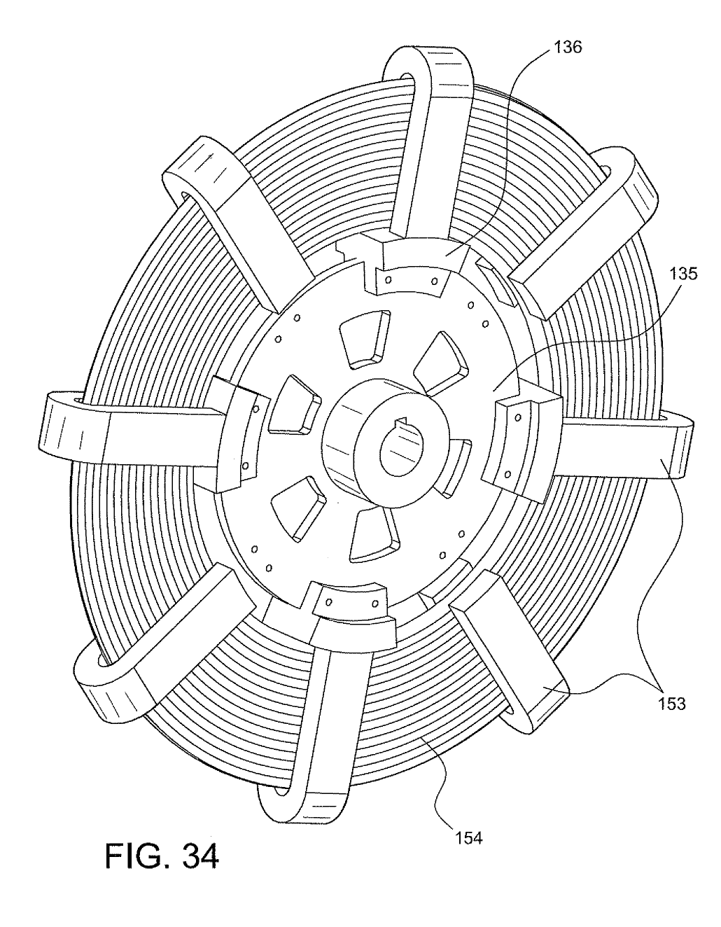

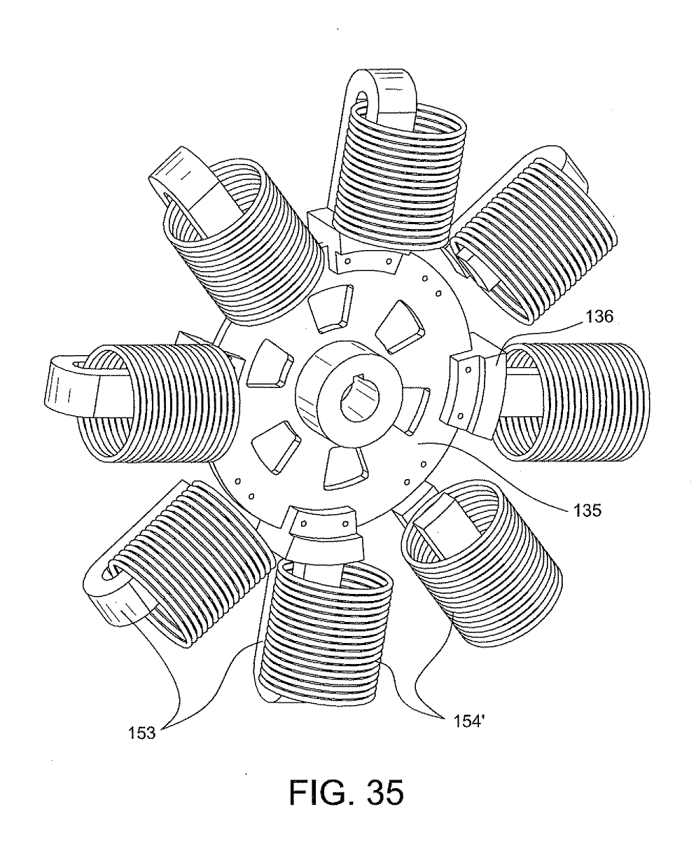

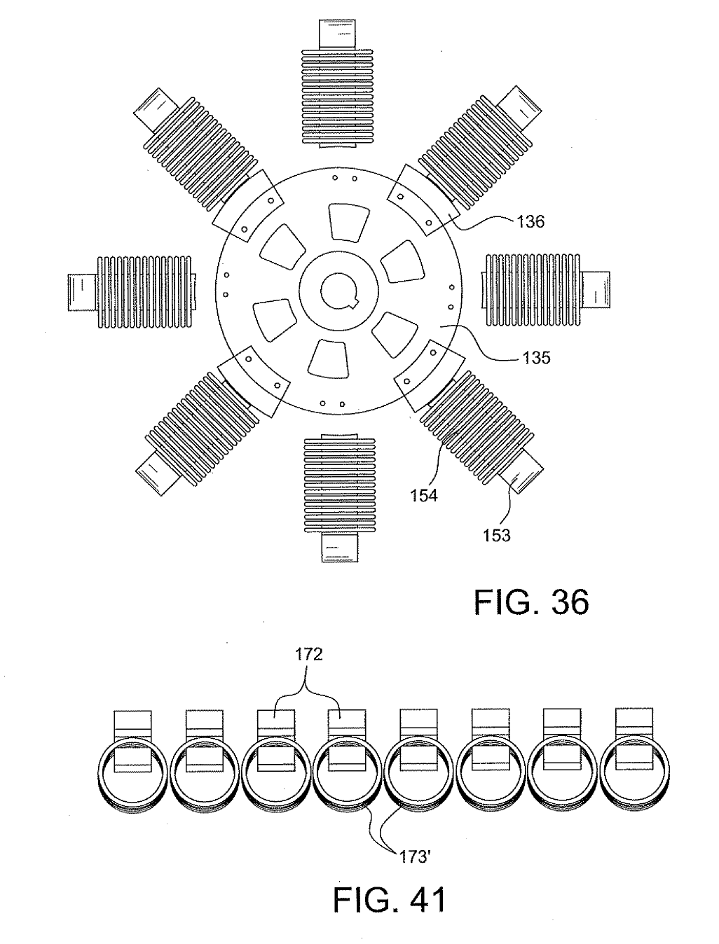

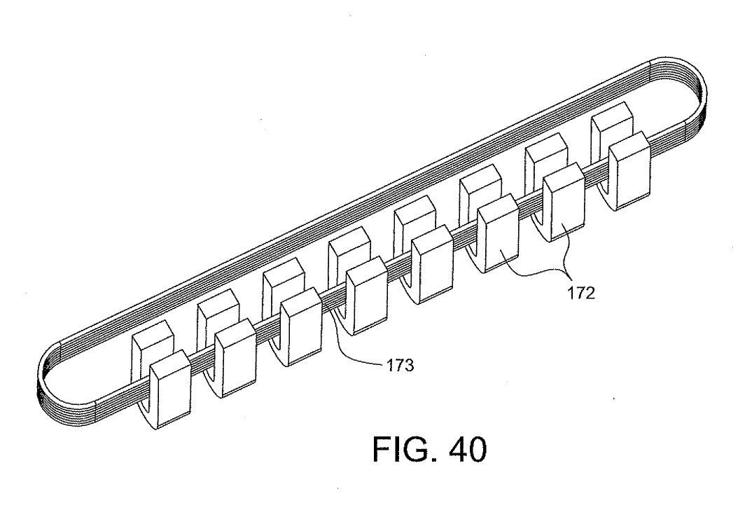

Instead of coils wound on the armature, the stator structures could be arranged to include permanent magnet/coil structures, for example by utilizing horseshoe magnets analogous to those of FIGS. 34-36. FIG. 40 shows a linear array of horseshoe magnets 172 and a mono coil 173 suitable for use with armature structures of the type shown in FIG. 37, while FIG. 41 shows the same horseshoe magnets 172 with individual coils 173′.

In a variation of the linear electrical machine of FIGS. 37-41, the flux reversal structures may be in the form of discs 174 connected by cylindrical connecting sections 175 and surrounding a shaft 176 to face opposite-polarity annular permanent magnets or permanent structures 177,178. Discs 174 may be arranged to move with the shaft relative to the permanent magnets 177,178, for example by being attached to a piston, or the shaft may be fixed and the permanent magnets 177,178 arranged to move relative to the discs 174. Coils 179 surround the cylindrical connection sections 175 and are connected to swap phases as a result of the north-south and south-north transition that occur as the discs 174 move past the magnets 177.

Those skilled in the art will appreciate that the linear electrical machine arrangements may be used not only as motors or generators, but also as displaced sensors. The illustrated electrical machines are not intended to be limited to a particular application. One possible application is in wave power generators.

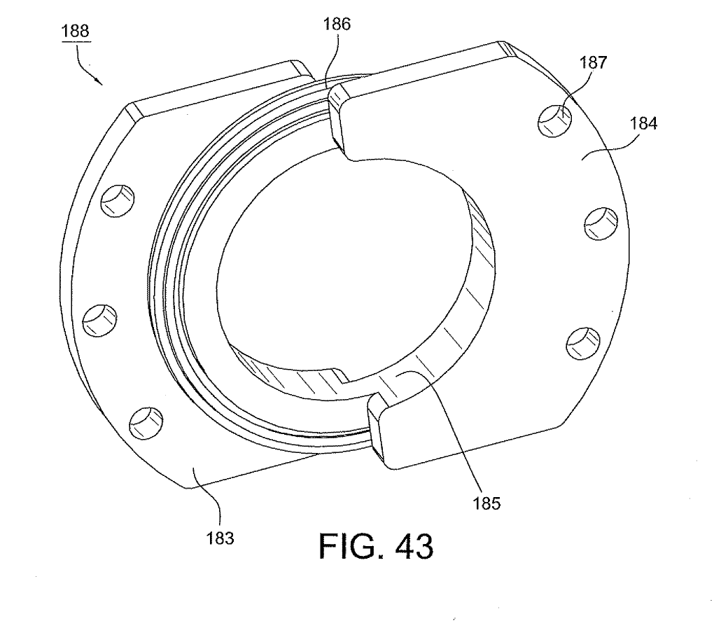

FIG. 43 shows a soft magnetic pole/coil support unit or module 188 that may optionally be used in yet another variation of the mono coil electrical machine of the third preferred embodiment. These units are for use in a rotary electrical machine and include soft magnetic (e.g., SMC or PBIP) pole structures 183,184 extending from an integrally molded connecting section 185 around which the coil 186 may be wound. The pole structures 183,184 include openings 187 through which shafts may be extended to align other magnet/coil units.

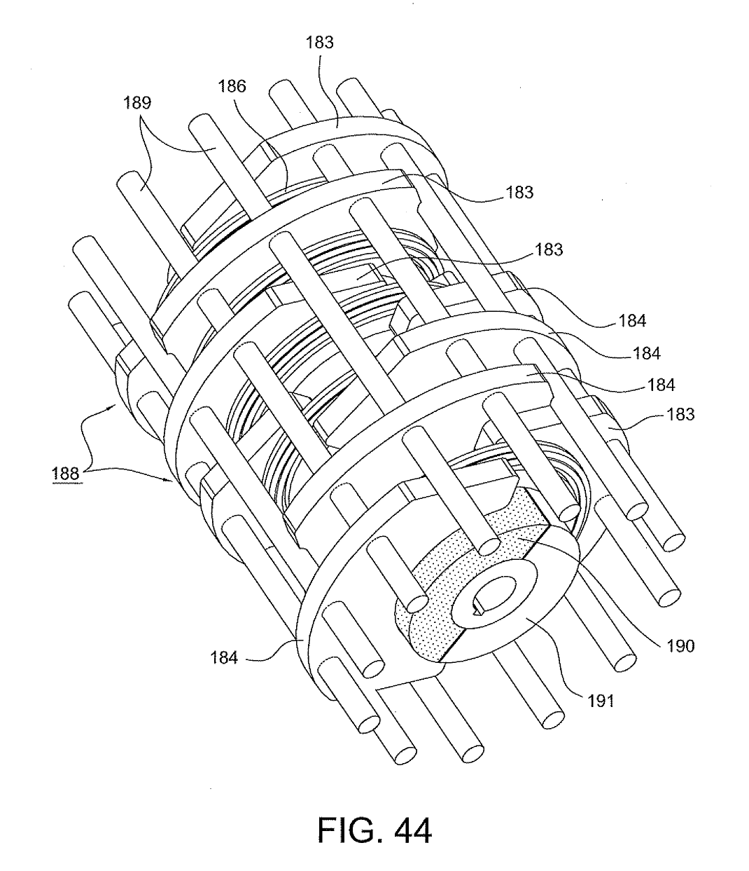

FIG. 44 shows a low cogging electrical machine using multiple stacked soft magnetic pole/coil support units or modules 188 of the type shown in FIG. 43. Adjacent ones of the modules 188 are aligned by the shafts 189 to be at 60 degree angles to provide six phases. The structure resulting from the combination of units or modules 188 is arranged, as illustrated in FIG. 44, to surround a simple permanent magnet rotor made up of semicircular opposite polarity permanent magnets 190 and 191, though other rotor configurations are possible and within the scope of the invention.

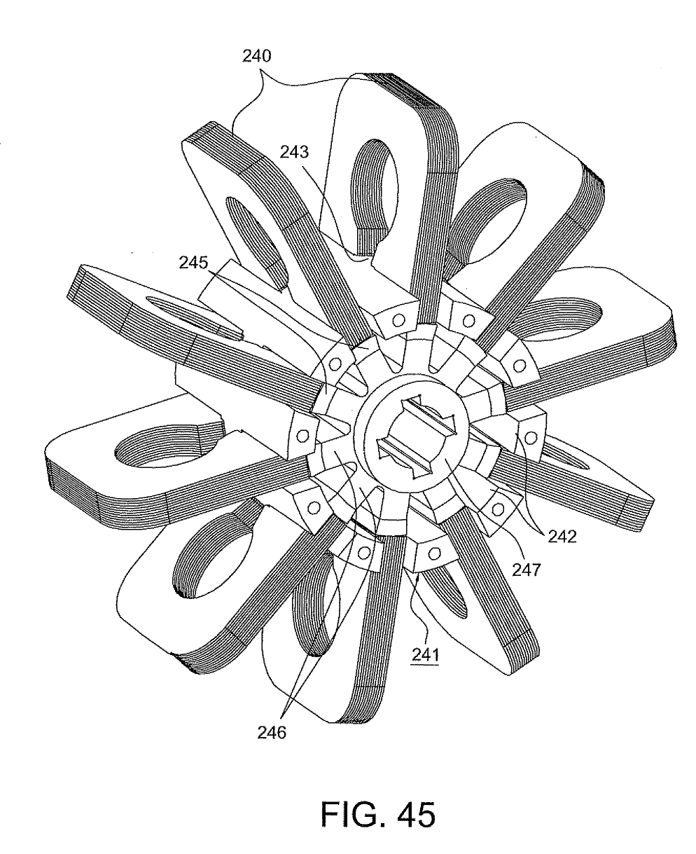

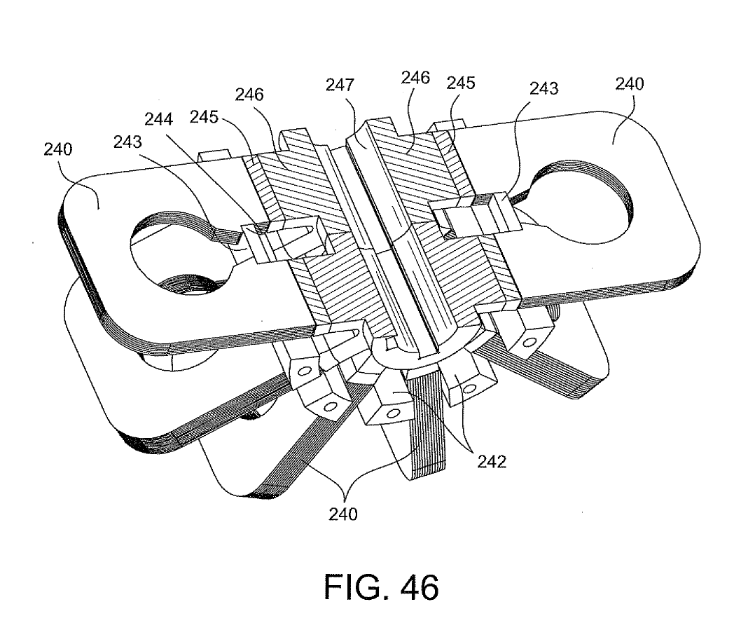

FIGS. 45 and 46 show a variation of the third preferred embodiment in which a plurality of radially-extending horseshoe or c-shaped coils 240 are keyed to a flux reversing soft magnetic structure 241 made up of arms 242 extending between the coils and connecting sections 243 that extend through the coils and engage notches 244 that serve to align the coils with the permanent magnets 245 on radially-extending spokes 246 of rotor 247. In this electrical machine, every other coil may be wrapped in reverse to produce a single phase generator. The radially-outward orientation of the coils leaves plenty of space for a high number of turns.

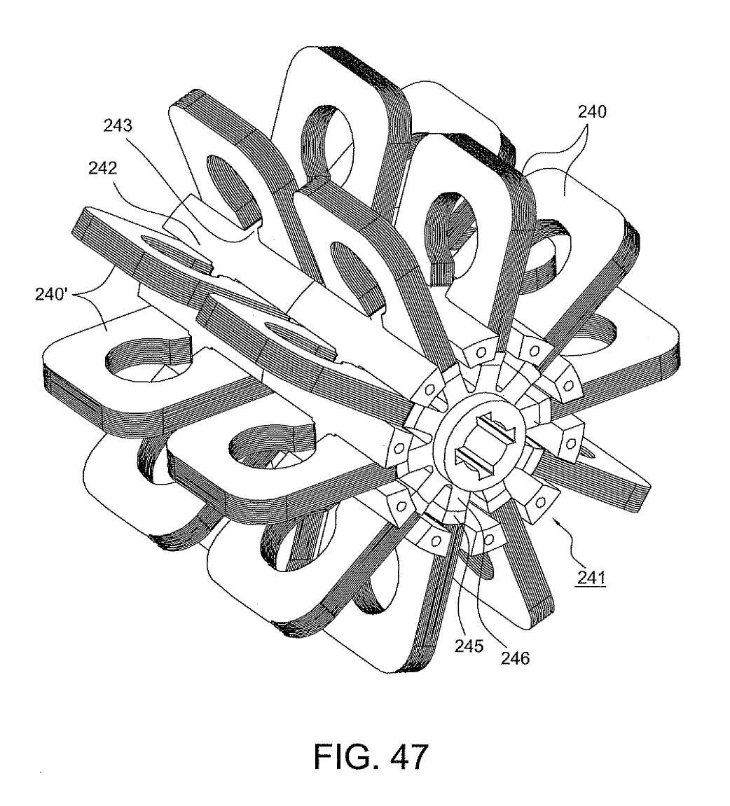

FIG. 47 shows a variation of the electrical machine of FIGS. 45 and 46, in which a second set of coils 240′ is added to form a two-phase electrical machine. The flux reversal and permanent structures of this variation may be identical those of FIGS. 45 and 46.

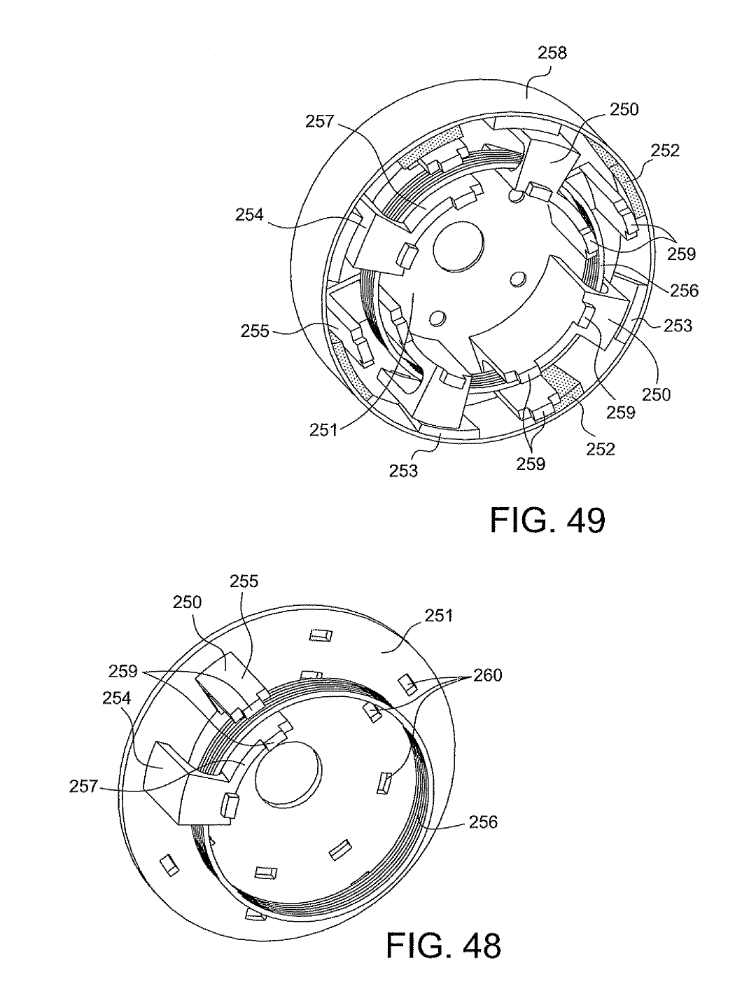

FIGS. 48 and 49 illustrate the construction of a single-phase mono coil electrical machine, in which a plurality of split dove-tail pole structures 250 extending transversely from a non-magnetic mounting plate 251 are arranged to provide series paths for the switching fluxes that result from movement of opposite-polarity magnets 252,253 past the pole structures 250. As can be best seen in FIG. 48, each pole structure includes a generally downwardly facing U-shaped section 254 and a generally upwardly facing U-shaped section 255, each arranged to accommodate passage of the mono coil 256. A connecting section 257 extends between U-shaped sections 254 and 255 on a radially-inward side of the coil to provide a flux path between the U-shaped sections. The U-shaped sections have a spacing corresponding to that of the opposite-polarity magnets 252,253 so that when a magnet of one polarity passes one U-shaped section, a magnet of opposite polarity passes the corresponding second U-shaped section, inducing a flux to flow in a first direction between the U-shaped sections, and such that continued movement of the magnets past the U-shaped sections causes repeated flux-reversals in the pole structures 250 to induce a current in the mono coil 256. As shown in FIG. 49, the magnets 252,253 are fixed to a hub 258 that rotates relative to the stationary pole structure mounting plate 251. Mounting and alignment of the pole structures 250 to mounting plate 251 and a corresponding mounting plate (not shown) on an opposite side of the pole structures may be facilitated by including tabs 259 and corresponding slots 260.

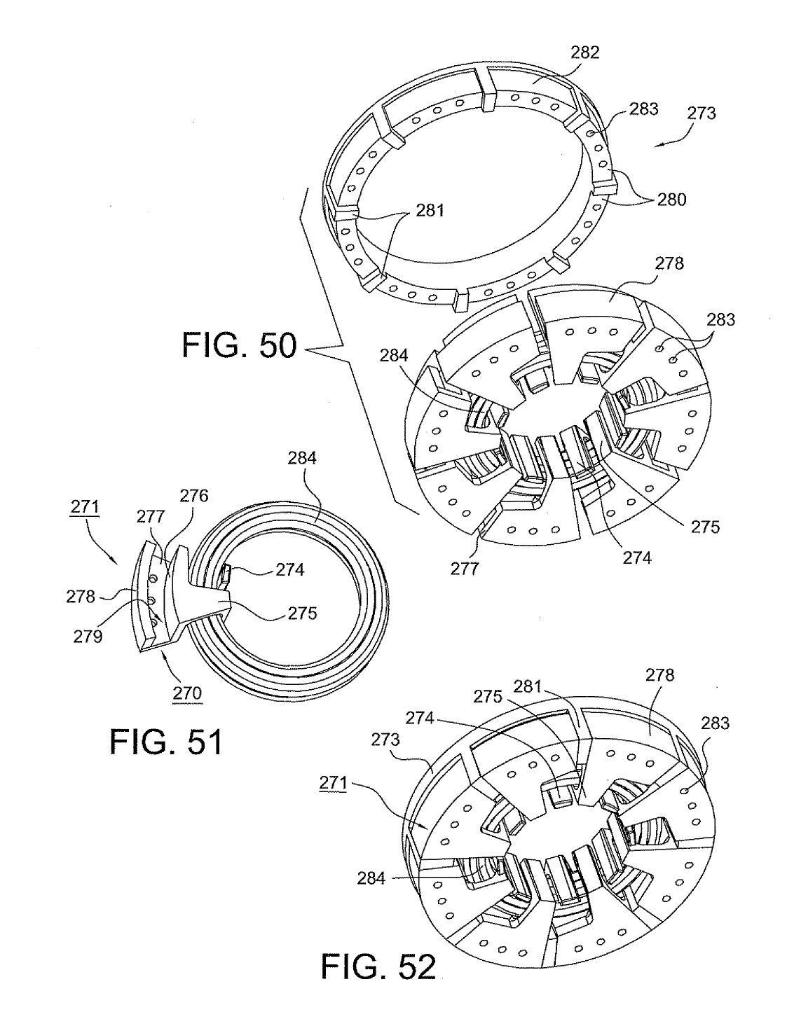

FIGS. 50-52 show an alternate construction of the single-phase mono coil electrical machine of FIGS. 48 and 49, in which the tab-and-slot alignment arrangement is replaced by an arrangement in which mounting extensions 270 are added to the pole structures 271, the mounting extensions being arranged to mate with alignment structures in a non-magnetic alignment ring 273. As in the embodiment of FIGS. 48 and 49, each pole structure 271 includes oppositely-directed U-shaped sections 274,275 and a connecting section 276, but the pole structures further include mounting extensions 270 that include a radially outward extending flange 277 and a transversely extending flange 278 that together with the connecting section 276 define a mounting/alignment groove 279. The mounting/alignment grooves 279 of each pole structure 271 fit over corresponding mounting sections 280 of alignment ring 274, the mounting sections being separated by partitions 281 that confine the pole structures 271 to a particular mounting section of the ring, with the space between the mounting sections 280 and the outermost surface of the partitions 281 forming grooves or slots 282 for receiving the transversely extending flanges 278. The pole sections may be secured to the alignment ring by any suitable fastening or adhesive arrangement, including pins, bolts, screws, or the like (not shown) and corresponding openings 283 for receiving the pins or slots. The interaction between the pole structures 271 and the coil 284 may be the same as described above in connection with the mono coil electrical machine of FIGS. 48 and 49.

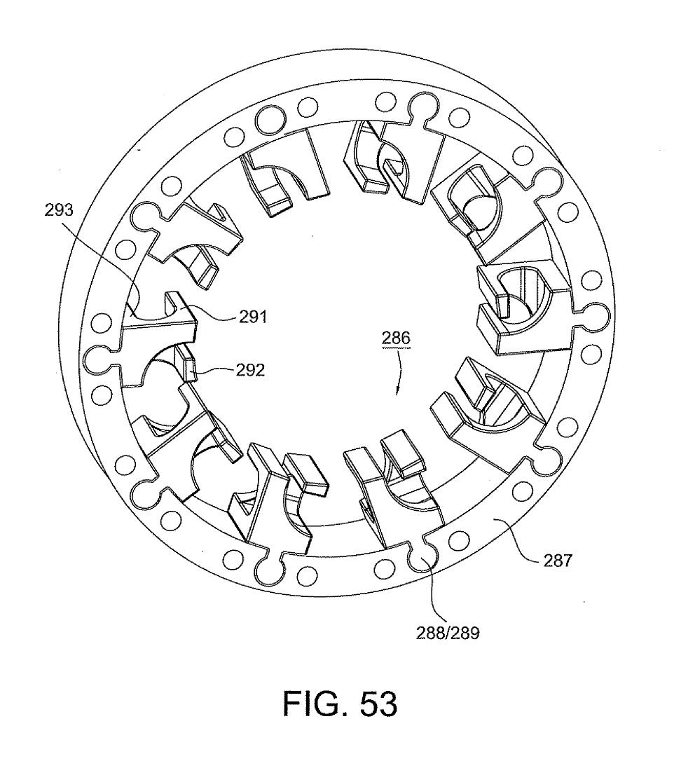

FIG. 53 shows a variation of the electrical machines of FIGS. 48-52, in which the pole structures 286 are secured to a mounting ring 287 by a mortise 288 and tenon 289. Again, the pole structures include oppositely extending U-shaped sections 291,292 for accommodating a coil (not shown) and connecting sections 293. It will be appreciated that, as in the first preferred embodiment of the invention described above, the mortise and tenon joints may be replaced by corresponding interlocking shapes.

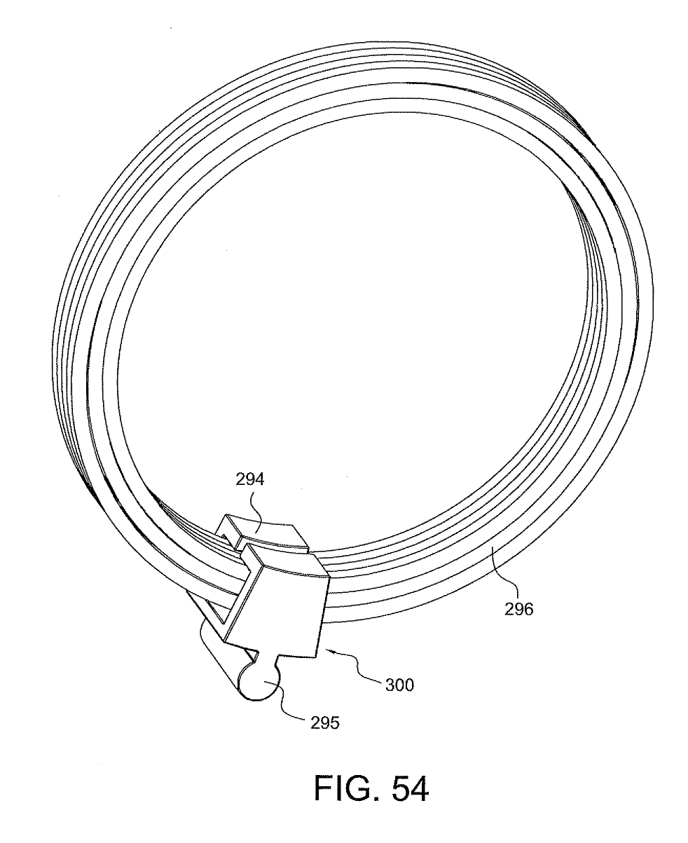

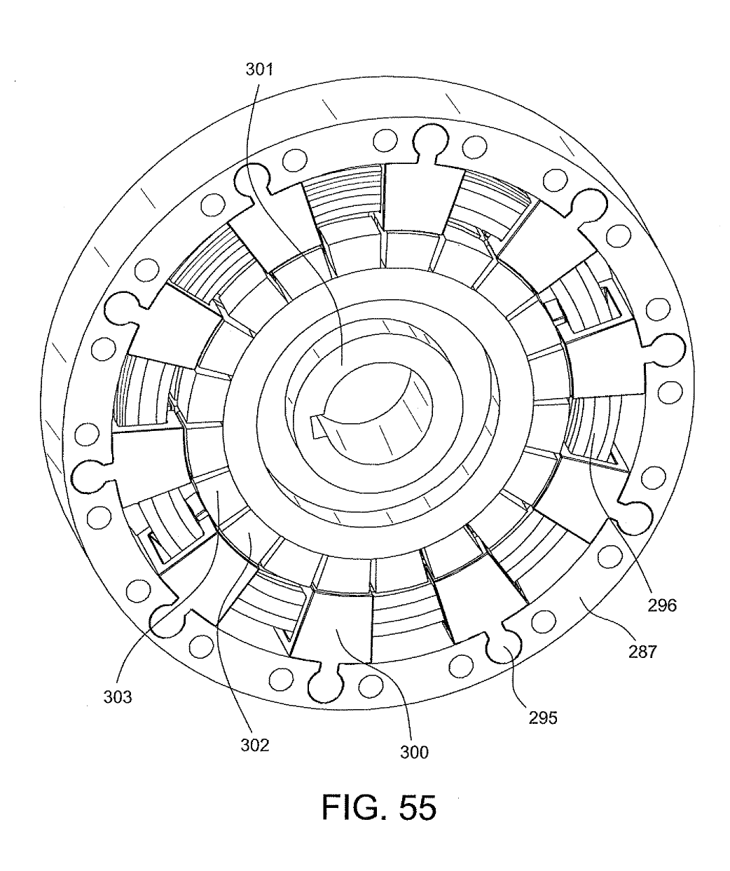

FIGS. 54-55 show a variation of the arrangement illustrated in FIG. 53, in which the pole structures 300 have simple C-shaped sections 294 and a tenon 295. The gap between the ends of the respective arms of the C-shaped sections facilitates insertion of a coil 296. The coil of this embodiment, as well as other embodiments of the invention, may be made of copper or any other suitable electrically conductive material, including superconducting materials, and may optionally be enclosed is some sort of tubing, such as an oil-filled tubing that serves to cool the windings.

In the arrangements shown in FIGS. 50-55, the pole structures extend radially inward from the non-magnetic support ring to face a relatively-rotating magnet structure such as hub 301 shown in FIG. 55, from which magnets 302,303 of opposite polarity extend. In the specific arrangement shown in FIG. 55, the number of the magnets is twice the number of pole structures so that the switching frequency of the arrangement shown in FIG. 55 is twice that of the arrangement shown in FIGS. 48-49.

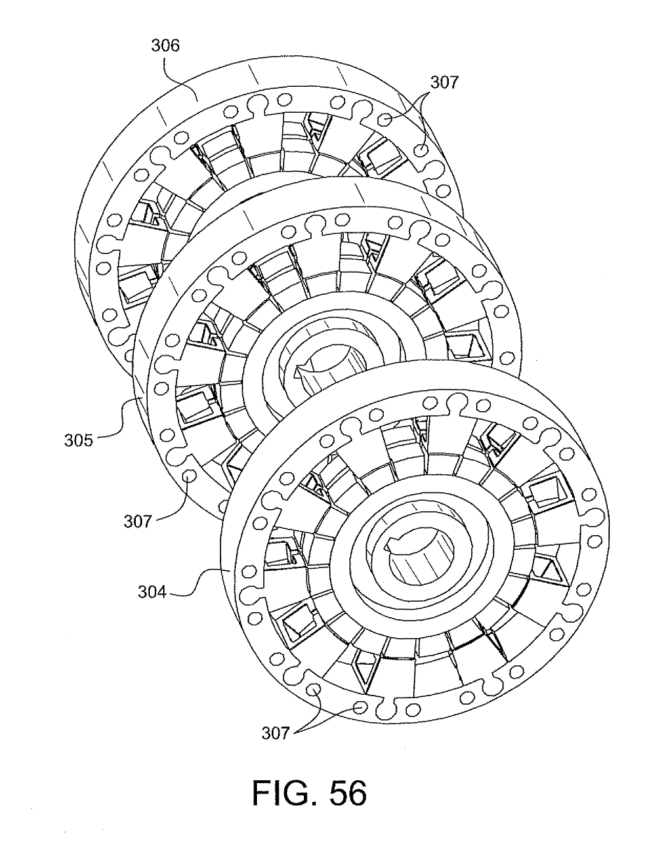

As with several of the above-described embodiments, individual electrical machines may be stacked to increase the number of phases, as illustrated in FIG. 56, which shows a three phase arrangement made up of electrical machines 304-306, which may be aligned by pins (not shown) extending through holes 307 in each of the electrical machines.

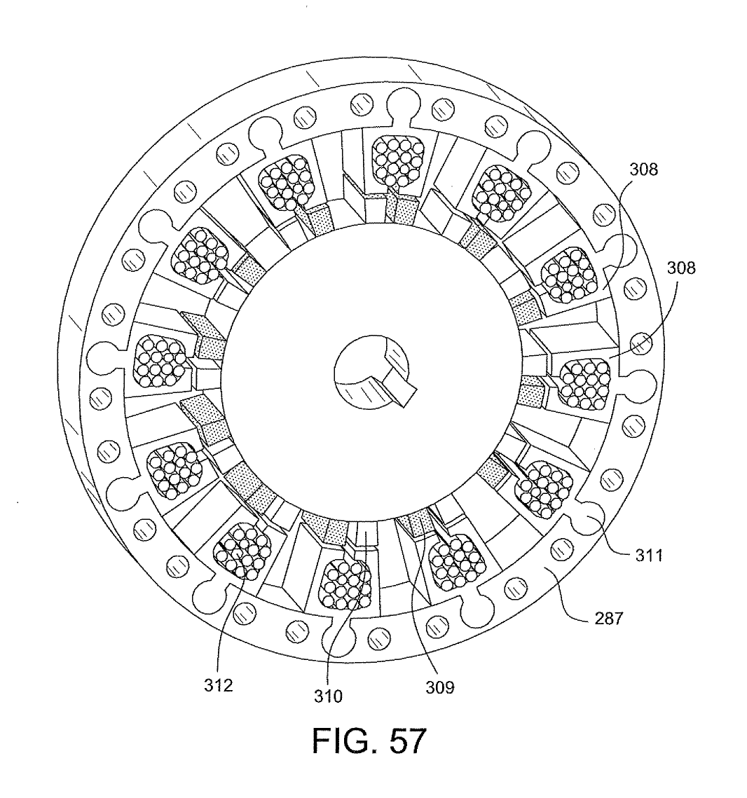

In the arrangement shown in FIG. 57, a further increase in switching frequency may be obtained by rotating the C-shaped pole structures 308 by 90 degrees, and providing a number of magnets 309,310 that is twice the number of pole structures, so that magnets of opposite polarity face respective arms of the pole structures. This embodiment may use the same non-magnetic ring 287 and mortise/tenon structures 311 as the electrical machines of FIGS. 52-56, but the coil 312 is threaded transversely through the respective pole structures. Coil 312 may be a single phase coil or be arranged to provide multiple phases.

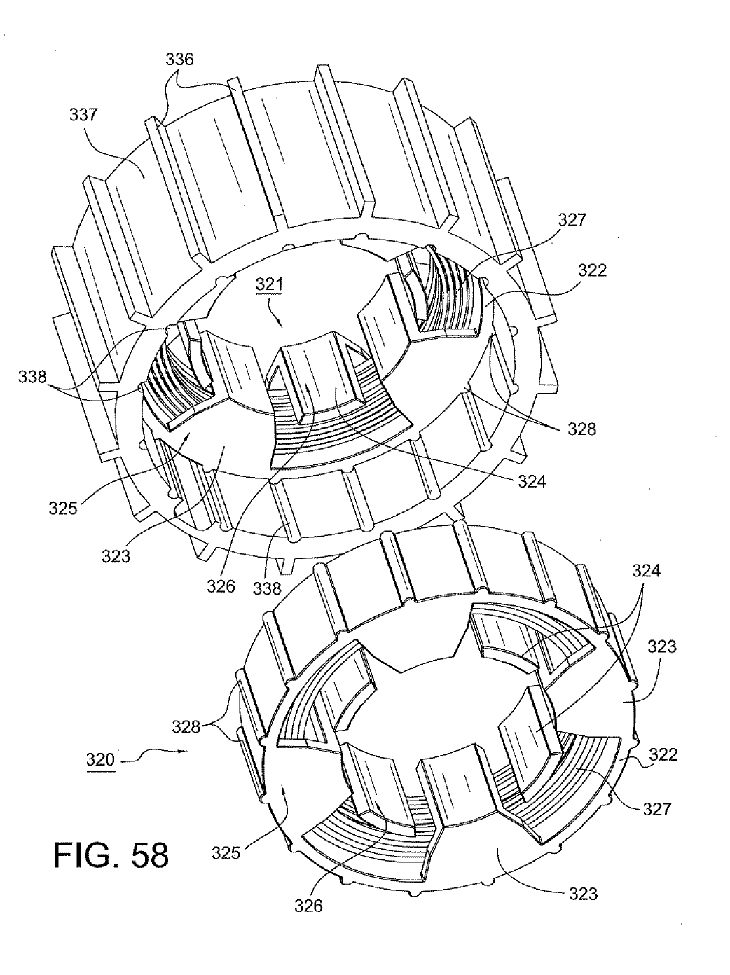

FIG. 58 shows a variation of the mono coil electrical machine in which parts 320/321 of the motor/generator housing are single cast to eliminate flux leakage at the interfaces between respective parts in multiple-piece assemblies. This design is especially suitable for relatively small motors and generators since single-casting is generally impractical for larger parts. Parts 320 and 321 may be identical single-cast soft magnetic housing/pole structures that are mutually aligned by an outer non-magnetic housing 337 having an interior surface with axial grooves 338 arranged to receive axially extending ribs 328 on the respective parts 320,321, to provide individual phases of a two phase electrical machine. Parts 320 and 321 may be cast from a suitable soft magnetic material such as SMC, while housing 337 may be made of a non-magnetic material such as aluminum.

Parts 320 and 321 each includes an outer ring 322 and a plurality of pole structures 323,324 extending in mutually opposite directions in a manner similar to the individual pole structures 250 shown in FIG. 49, but which are integrally cast with the outer ring 322. Each of the pole structures 323,324 includes a radially inward extending section 325 and an axially extending section 326, the radially inward extending sections 325 of adjacent pole structures 323 and 324 being joined with outer ring 322 at axially opposite sides of the outer ring. A single-phase mono coil 327 is situated in the spaces formed by the pole structures 323,324. The outer circumferential surface of the outer ring 322 includes the plurality of spaced, axially extending ribs 328 that serve to align part 320 with part 321 when both parts are fitted into appropriate grooves 338 of housing 337. In addition, housing 337 further includes axially extending outer ribs or pins 336 for aligning housing 337 with another part of the electrical machine, such as a hub for a permanent magnet rotor (not shown).

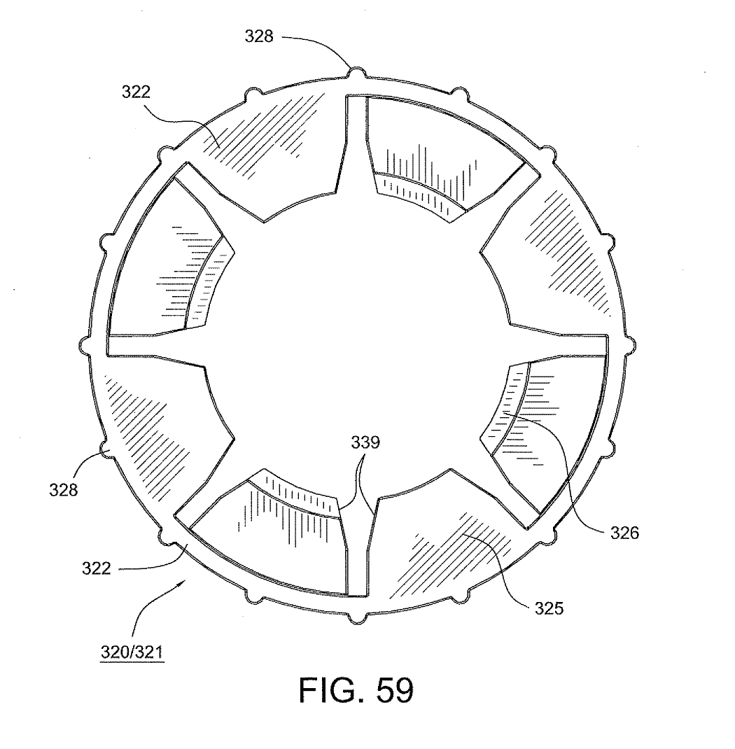

FIG. 59 is an end view of one of the parts 320,321 of FIG. 58, but in which bevels 339 have been added to widen the slots between pole structures and facilitate insertion of a respective coil winding 327.

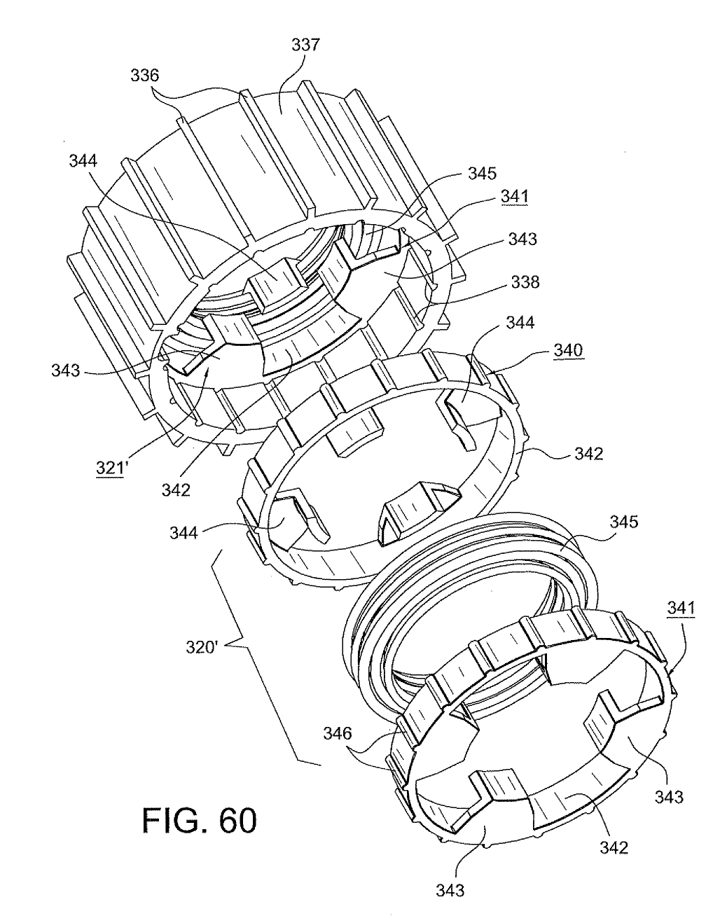

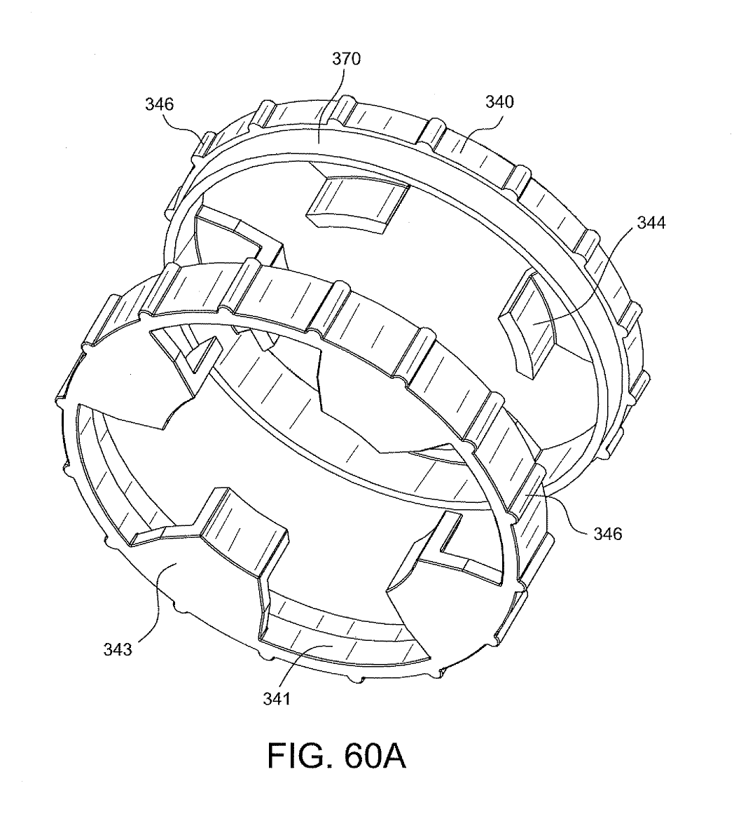

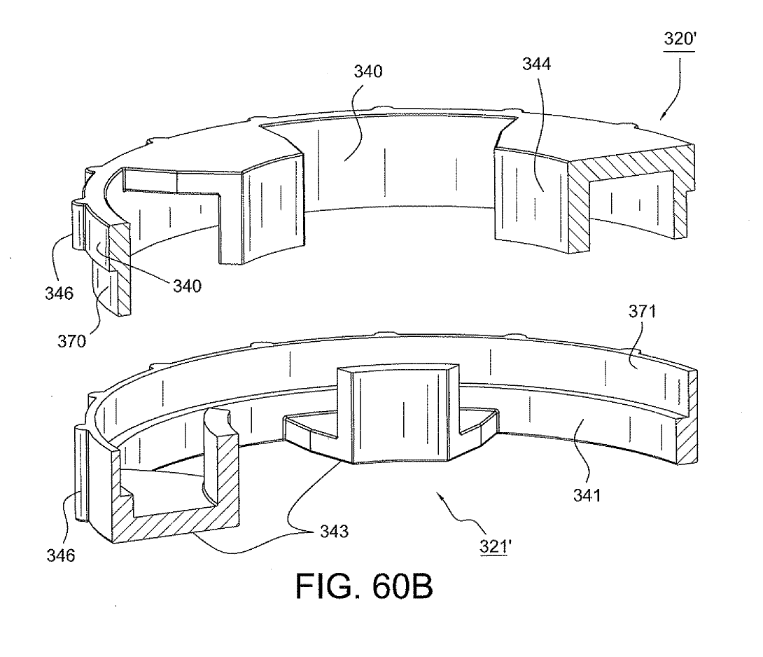

FIG. 60 shows a variation of the electrical machine of FIGS. 58 and 59, in which parts 320,321 are replaced by split ring assemblies 320′,321′, each made up of two single-cast pole structure units 340,341, each single-cast pole structure unit consisting of an outer ring 342 and integral pole structures 343,344 arranged to extend around a coil 345. As in the electrical machine of FIG. 58, axially extending ribs 346 are provided on the outer rings 342 of parts 320′ and 321′ to align the pole structures and provide multiple phases upon insertion of the ribs 346 into corresponding grooves 338 of housing 337. In a variation of the electrical machine of FIG. 60, the single-cast pole structure units 340,341 of respective ring assemblies 320/,321′ may be joined by male/female step interfaces 370,371. The inclusion of male/female step interfaces simplifies alignment of the individual single cast pole structure units 340,341 and has the additional advantage of providing an increased flux-coupling surface area and therefore improved magnetic flux coupling between the pole structure units.

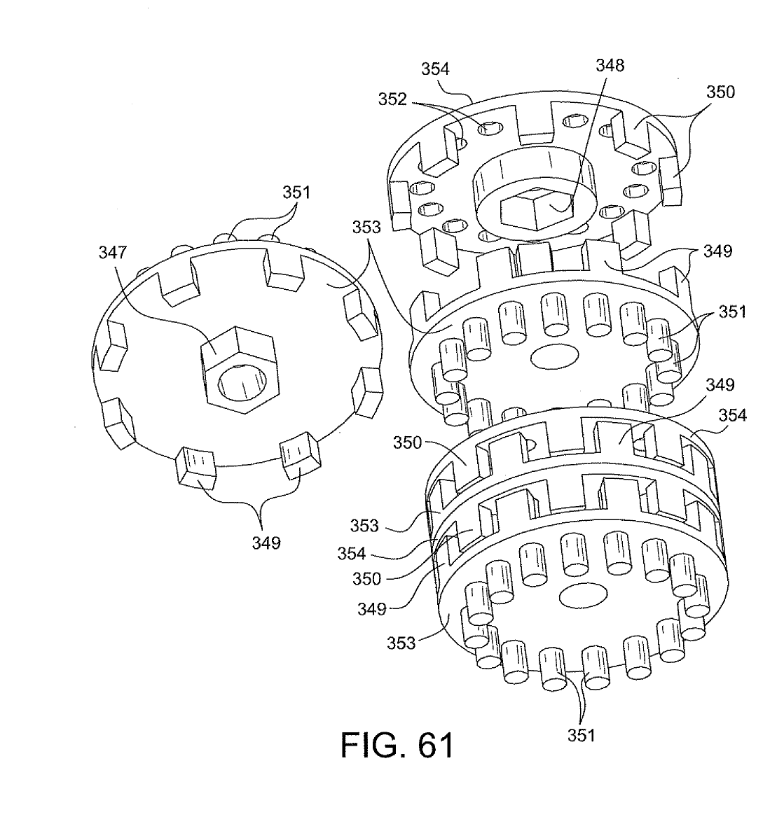

FIG. 61 illustrates a multiphase motor with alignment structures for aligning poles within the individual phases, and for aligning respective phases with respect to each other. Each phase is made up of a pair of complementary plates 353,354, one of which includes a multiple-sided central projection 347 and the other of which includes a corresponding multiple-sided opening 348 for aligning respective pole structures 349,350 when the projection 347 is fitted into opening 348. The individual phase assemblies are aligned to form a multiple phase structure by providing one of the plates 353,354 with a plurality of molded-in alignment pins 351 and the other of the plates 345,346 with corresponding plurality of openings 352. Coils (not shown) may be provided in the space within the pole structures 349,350. Since the various parts are single-cast, this structure is especially suitable for micro or miniature motors.

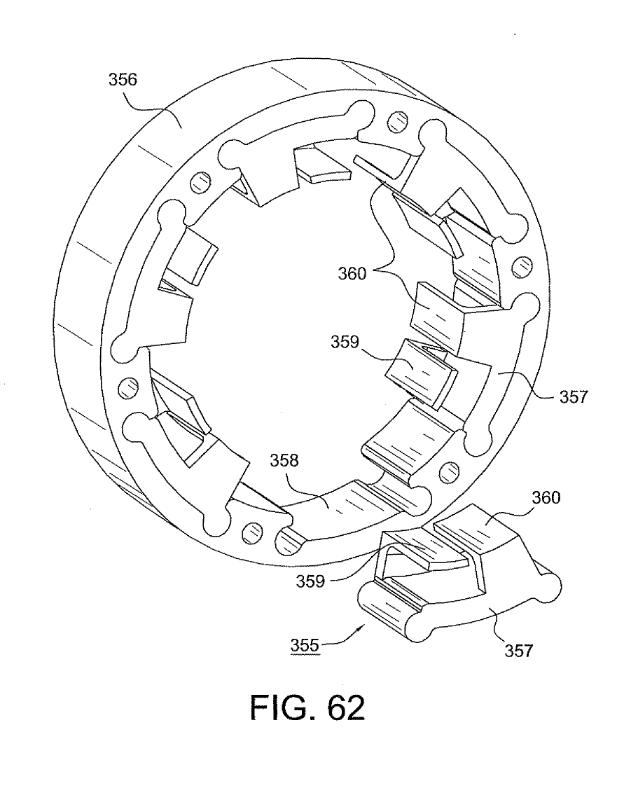

FIG. 62 shows a variation of the electrical machine of FIG. 53, in which pole structures 355 are secured to a mounting ring 356 by a dove tail or claw pole 357 and correspondingly-shaped recess or opening 358. As in the arrangements of FIGS. 48-53, the pole structures include oppositely extending U-shaped sections 359,360 for accommodating a coil (not shown). It will be appreciated that, as in the first preferred embodiment of the invention described above, the mortise and tenon joints may be replaced by corresponding interlocking shapes.

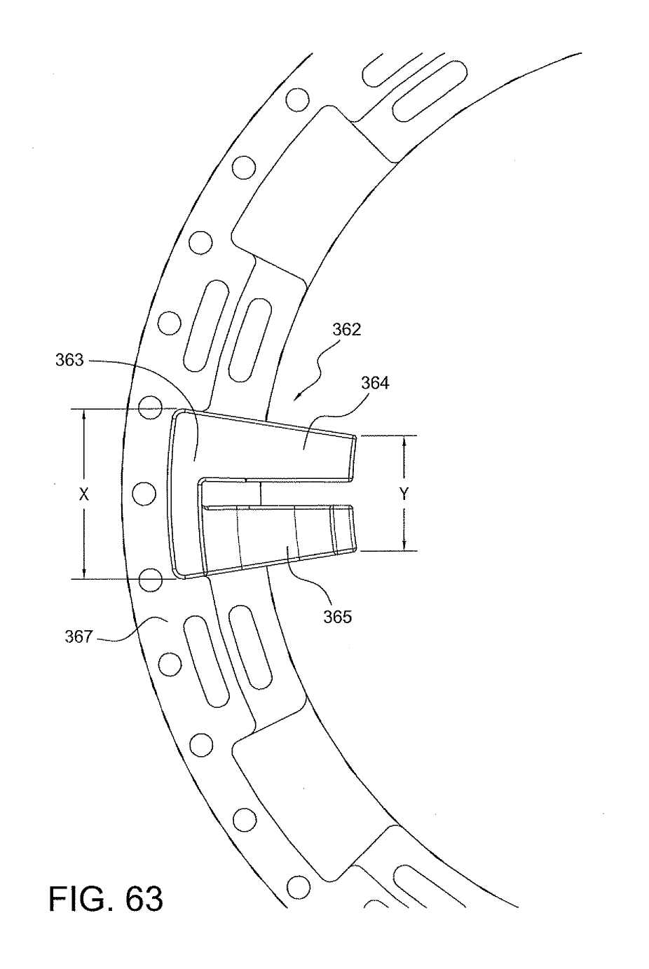

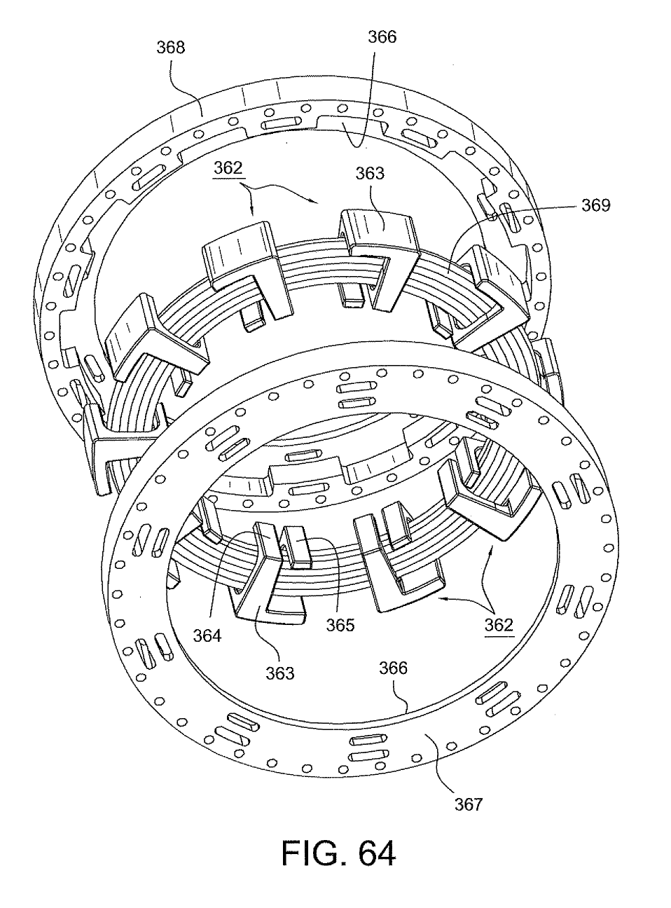

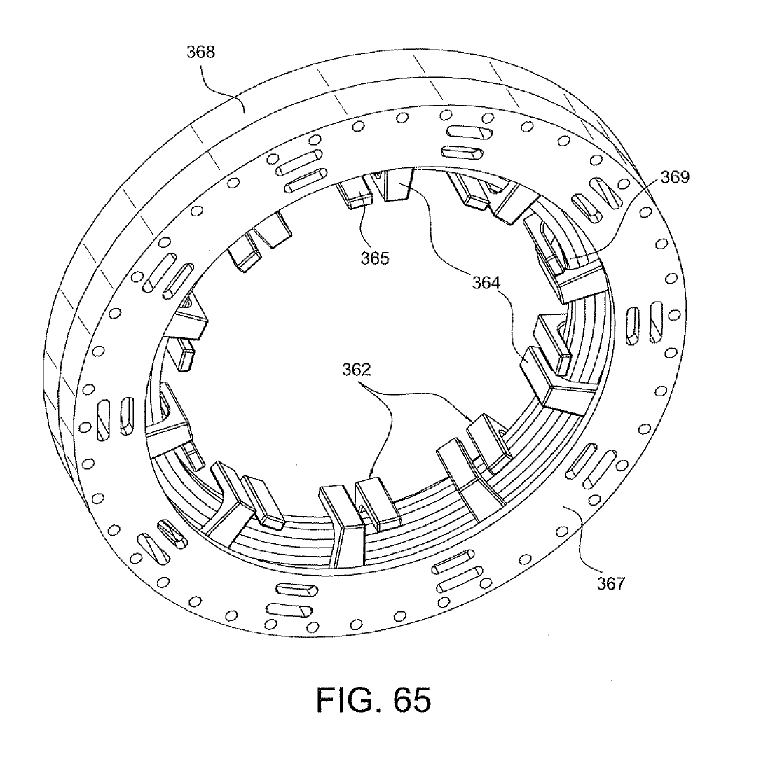

FIGS. 63-65 show an electrical machine pole structure/coil arrangement that utilizes a variation of the dove tail arrangement of FIG. 62. In the dove tail arrangement of FIGS. 63-65, pole structures 362 are arranged to have a wedge shape such that the width x of a connecting section 363 is greater than the width y of a pole section, the width y of the pole section being the sum of the widths of the two axially-extending, oppositely-directed poles 364,365 and a space between the poles. The pole structures fit into correspondingly-shaped recesses or openings 366 in respective split dove tail non-magnetic housings 367,368 that captures the poles structures 362 and a coil 369 when assembled together as shown in FIG. 65. The split dove-tail housings 367,368 of this arrangement are especially easy to machine and can be injection molded for low cost assembly. The dove tail design has the advantage of preventing the stator from touching the magnetic rotor and neighboring stator rings in case of a multiple phase machine.

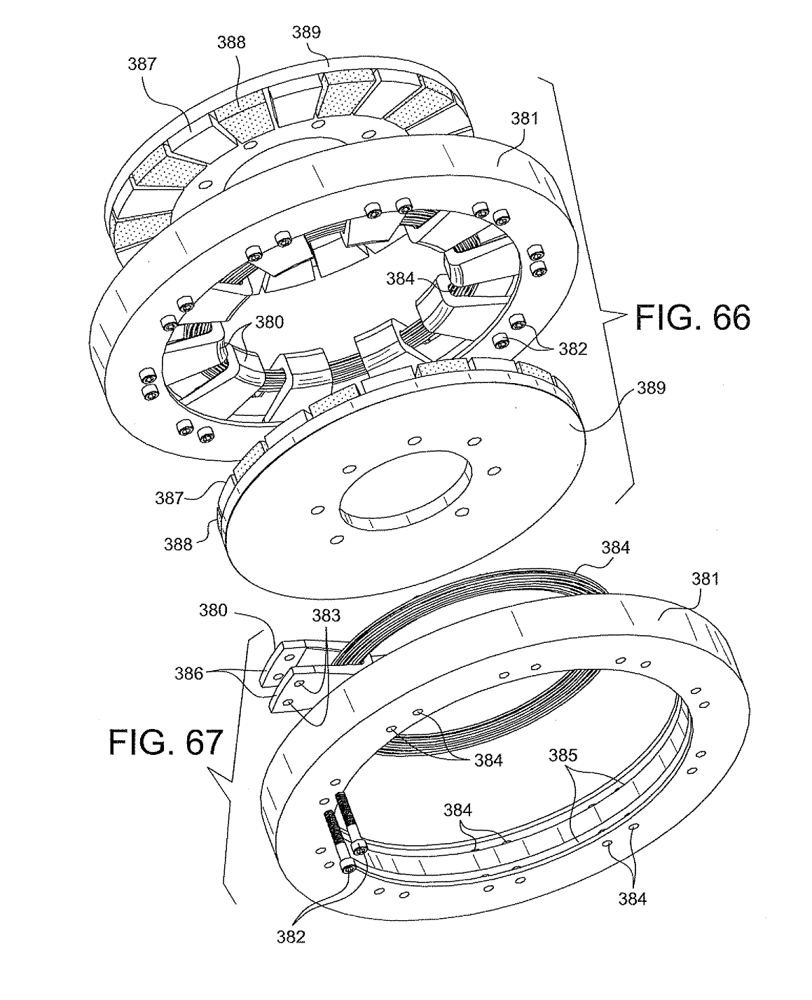

FIGS. 66 and 67 shows a mono coil electrical machine that utilizes discrete U-shaped molded pole structures 380 made of SMC or other appropriate magnetic material and secured to a non-magnetic housing ring 381 by bolts, screws, pins, or other appropriate fasteners 382. In contrast to the single-cast structures of FIGS. 48-65, the arrangement shown in FIG. 66 is suitable for larger electrical machines where single-casting is impractical. Ends 386 of the U-shaped pole structures 380 are inserted into slots 385 in the ring housings so that openings 383 in the pole structures 380 are aligned with openings 383 in the corresponding housing ring 381 to permit insertion of fasteners 382. A mono coil 384 is threaded through the openings in the pole structures 380 to form the mono coil pole structure assembly. Alternate magnetization of the pole structures to induce an alternating current in the mono coil, according to the principles of operation described above, may be provided in this arrangement by opposite polarity magnets 387,388 situated on metal magnetic plates 389, the total number of permanent magnets being twice the number of poles to achieve the flux reversal effect.

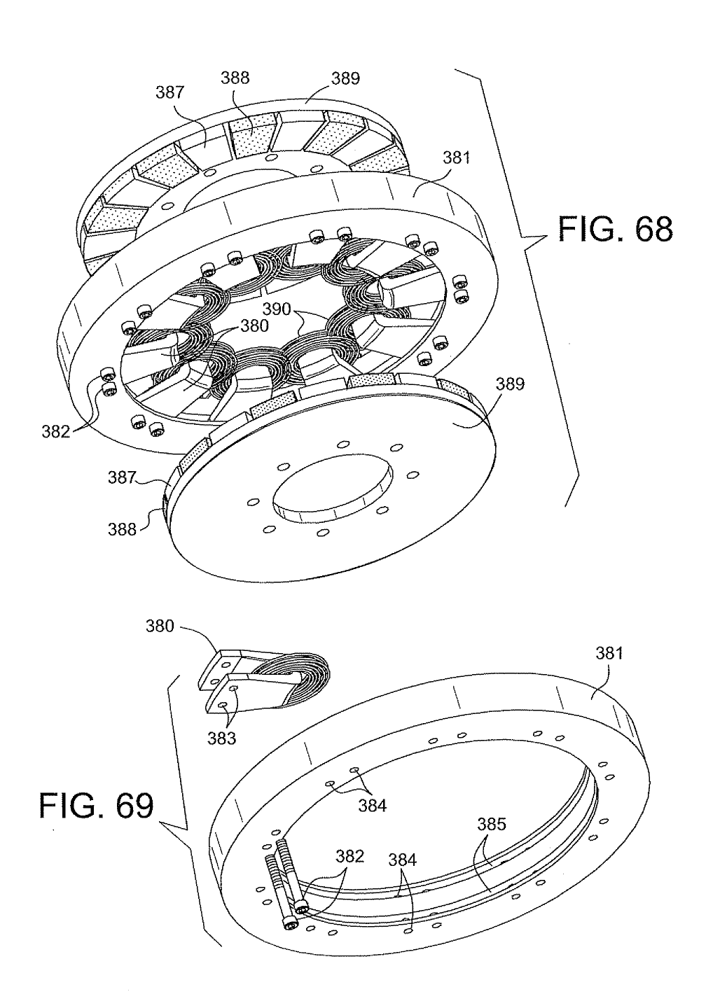

FIGS. 68 and 69 illustrate an arrangement that is identical to that shown in FIGS. 66 and 67, except that multiple coils 90 are substituted for the single mono coil 84 of FIGS. 66 and 67. The use of multiple coils permits multiple phase winding configurations and a high wire core volume.

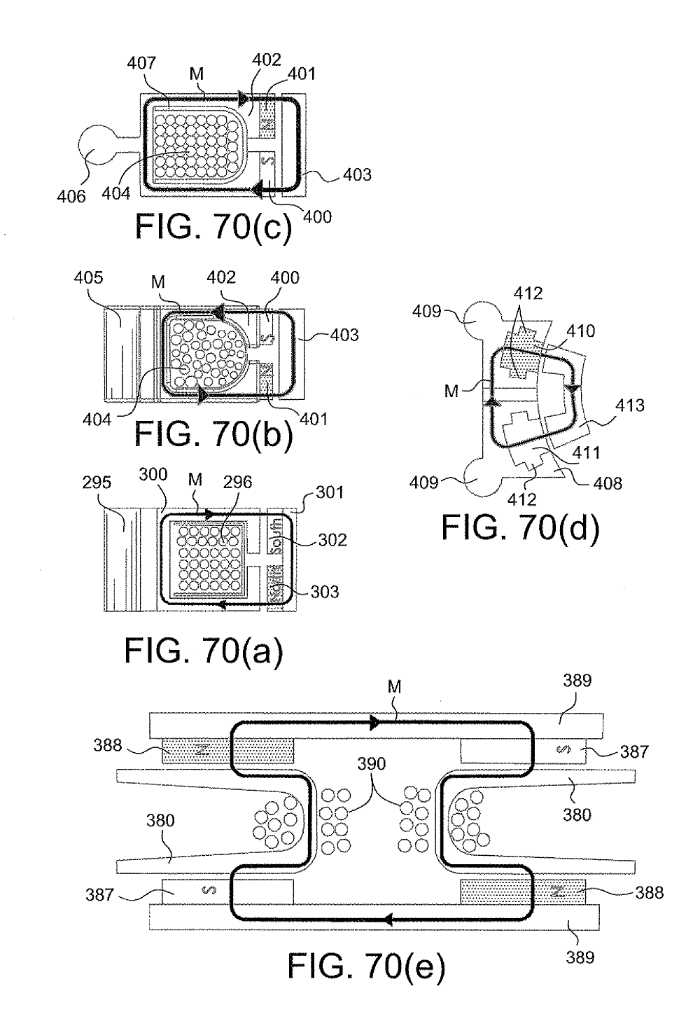

FIGS. 70(a) to 70(e) illustrate various alternative configurations for the coil and permanent magnet structures illustrated in FIGS. 48-69.

The electrical machine of FIG. 70 (a) corresponds to the electrical machine illustrated in FIG. 55, including pole structure 300, tenon 295, coil 296, rotor 301 and permanent magnets 302 and 303 mounted on the rotor 301 to form a switching magnetic flux path illustrated by arrow M. The arrangement of FIG. 70(a) may be varied by mounting the permanent magnets 400,401 on the pole structure 402 rather than on the rotor 403, as illustrated in FIG. 70(b). In addition, this variation includes alternative pole structure arm configurations in which the inside surfaces of the arms that surround coil 404 are curved. The arrangement of FIG. 70(b) may be further varied, as shown in FIG. 70(c) by orienting the tenon 406 at a transverse angle relative to the tenon 405 shown in FIG. 70(b). The variation also includes an optional insulation layer between the coil 404 and the pole structure 402.

FIG. 70(d) shows an alternative permanent magnet structure 408 with a claw pole joining structure 409 similar to the one shown in FIG. 62 and permanent magnets 410,411 held in place by mortise and tenon structures 412. The flux path M is completed through a sprocket rotor 413, with a coil or coils (not shown) being situated on either on the permanent magnet structure 408 or the rotor 413.

Finally, FIG. 70(e) illustrates the flux path for the electrical machine of FIGS. 68 and 69 with rotor plates 389, permanent magnets 387,388, U-shaped pole structures 380, and individual coils 390.

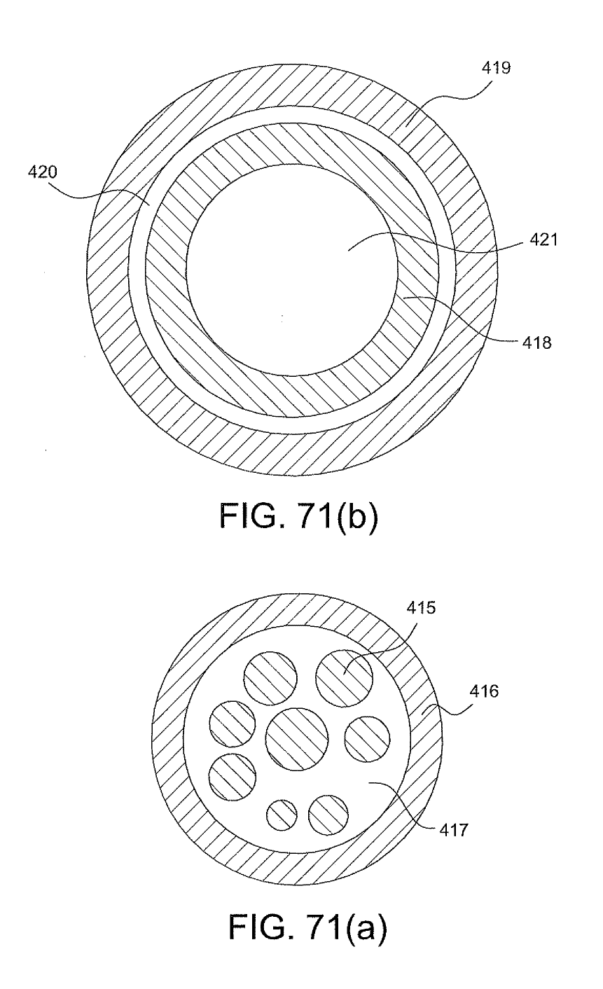

FIGS. 71(a) and 71(b) are schematic illustrations of coil arrangements for use in connection with the preferred embodiments. As illustrated in FIG. 1a, individual strands or conductors 415 are surrounded by an insulator 416 and the interior 417 of the insulator is filled with coolant in the form of a pressurized liquid or gas. The conductors 415 may be conventional copper or other metallic conductors, or superconductors. Heat transferred from the conductors to the pressurized coolant may be recovered to make additional power by using thermoelectric modules or by directing the coolant through a turbine. In the variation illustrated in FIG. 71 (b), a single tubular conductor or superconductor 418 is surrounded by insulated pressure tubing 419, and pressured coolant is provided both in the space 420 around the exterior of the conductor or superconductor 418 and also in the interior 421.

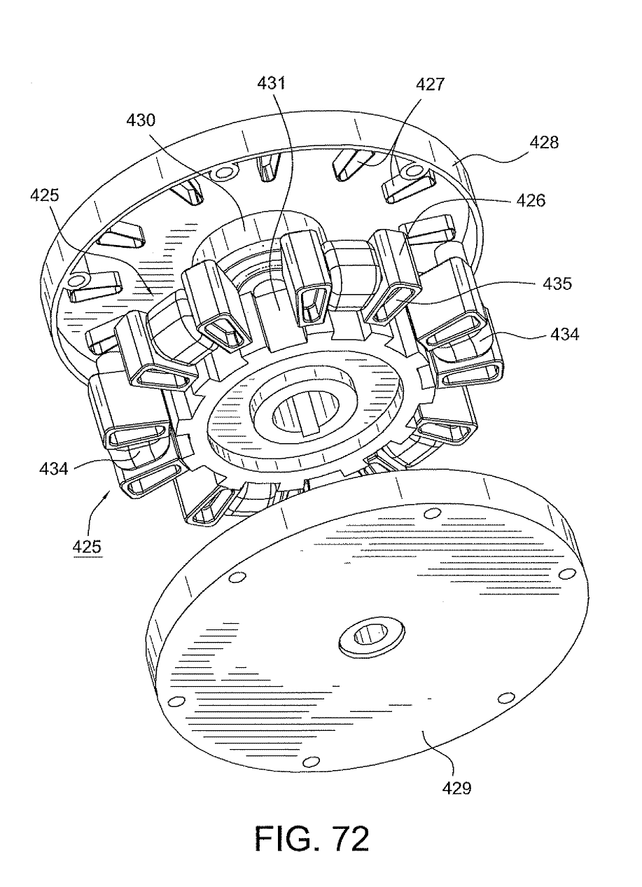

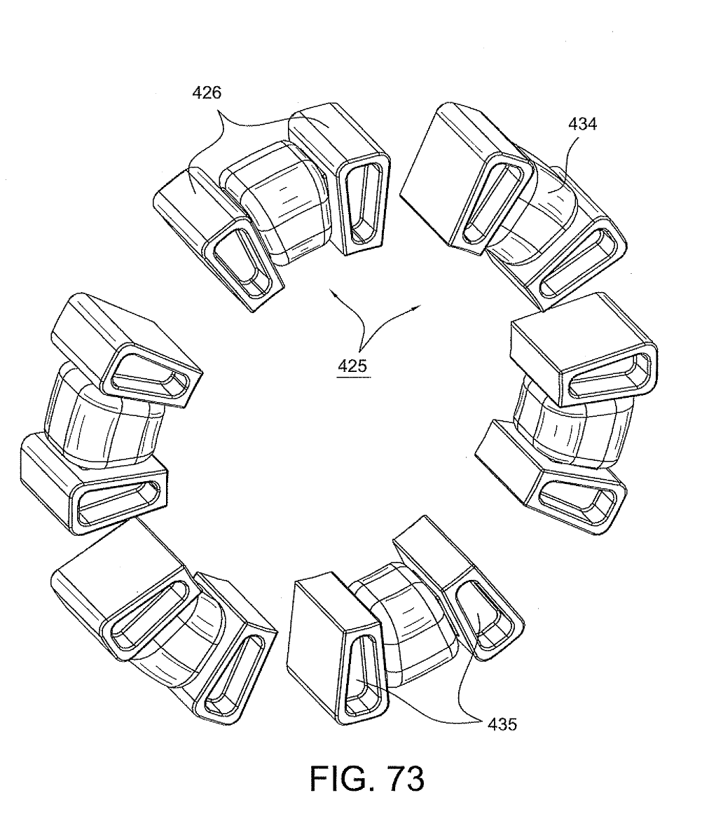

The principle of molded-in alignment structures may also be applied to axially mounted pole structures such as pole structures 425 of the electrical machine illustrated in FIGS. 72 and 73. Each of the pole structures includes a pair of recessed mounting sections 426, each mounting section 426 including a pair of recesses 435 shaped to receive corresponding projections or pins 427 molded into each of the housing plates 428,429. Housing plates 428,429 also support a central bearing structure 430 for a rotor hub 431. Oppositely polarized permanent magnets 432,433 are mounted on a surface of the rotor hub 431 to face respective ones of the mounting sections 426 of pole structures 425 to cause flux reversals in the pole structures as the rotor moves relative to the pole structures. The mounting sections 426 of each pole structure 425 are connected by arms surrounded by coils 434.

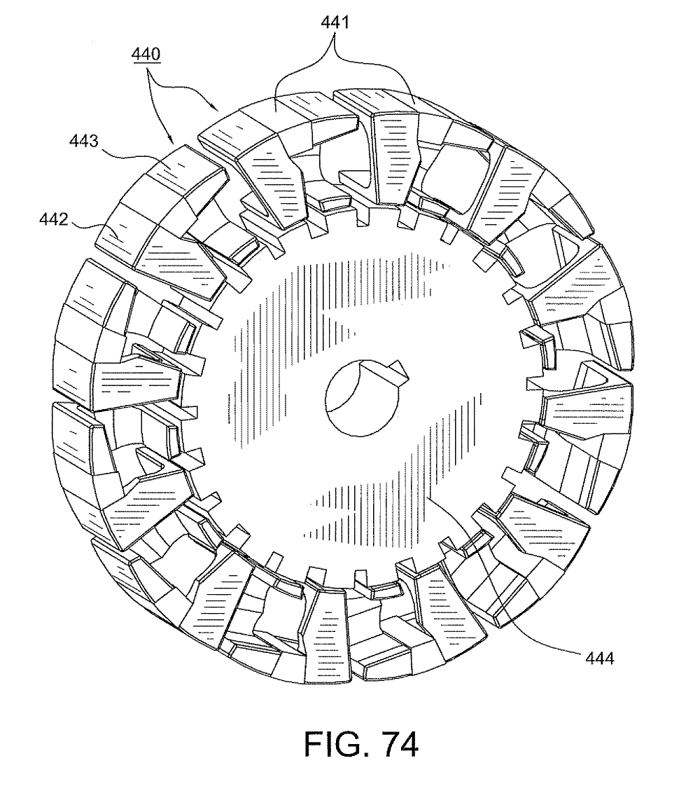

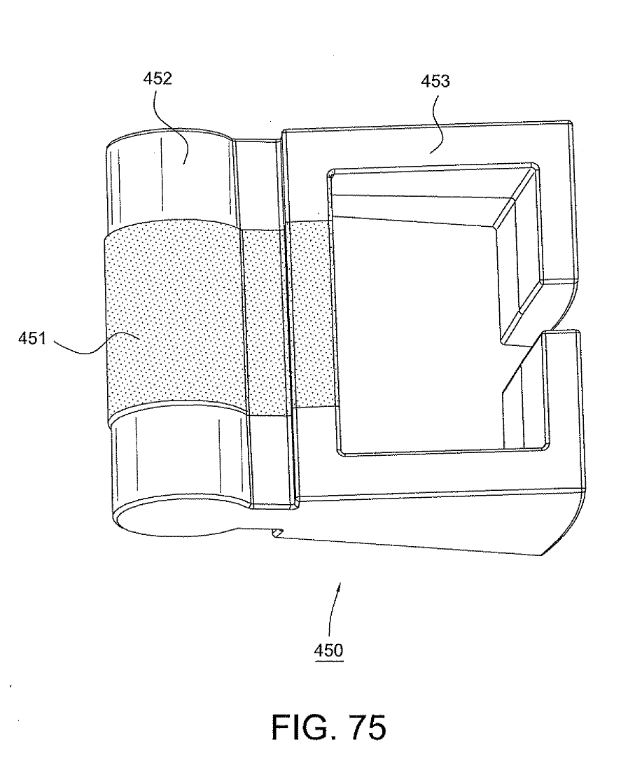

FIGS. 74 and 75 respectively show pole structures 440,450 similar to those illustrated in FIGS. 48 and 54, but in which the permanent magnets 441,451 are positioned in the pole structures rather than on a separate rotor. In the arrangement shown in FIG. 74, two coils (not shown) are required, with each coil wrapped around every second pole structure rather than around adjacent poles structures, so that the oppositely-directed magnetic fluxes in adjacent coil structures do not cancel out the induced currents. The two coils can be tied together to form a single phase winding, or separately connected to form a two phase electrical machine. In the arrangement of FIG. 74, permanent magnets 441 are wedge shaped to hold them in place between the U-shaped soft magnetic pole arms 442 and 443 that face rotor 444. On the other hand, permanent magnet 451 shown in FIG. 75 forms part of a tenon 452 and part of the C-shaped section 453 of the pole structure 450. Those skilled in the art will appreciate that the exact configuration of the permanent magnet may be varied according to the pole structure in which it is included.

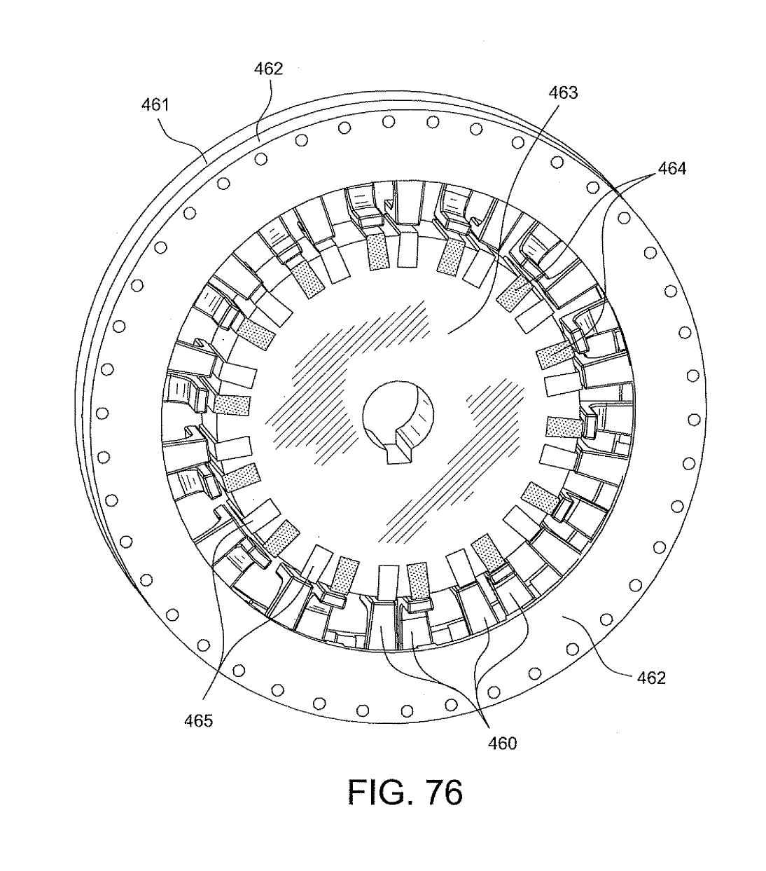

FIG. 76 shows an electrical machine having a pole/coil assembly that may be similar to that shown in FIG. 65, including pole structures 460 extending from and sandwiched between housing rings 461,462. In addition, FIG. 76 shows a disc-shaped rotor 463 that may be used with the illustrated pole/coil assembly or, for example, that of FIG. 65, the rotor 463 including a plurality of opposite polarity magnets 464,465. Uniquely, the permanent magnets 464,465 of this embodiment have a wedge shape, with a narrower side of the wedge shape facing radially outwards, that holds the permanent magnets in place within correspondingly-shaped recesses in the main body of the 463 without the need for glue.

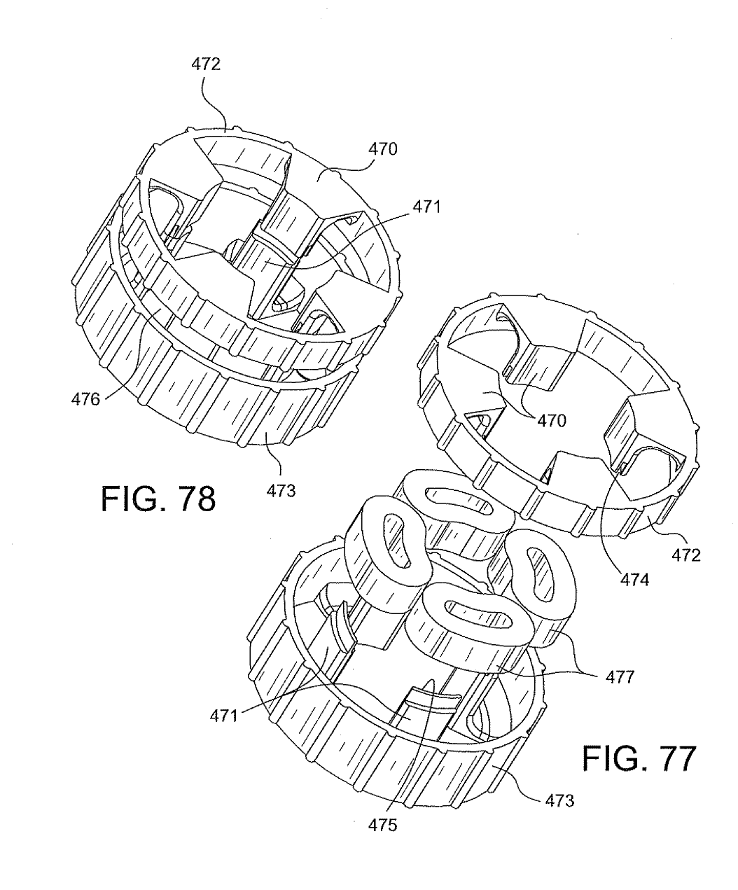

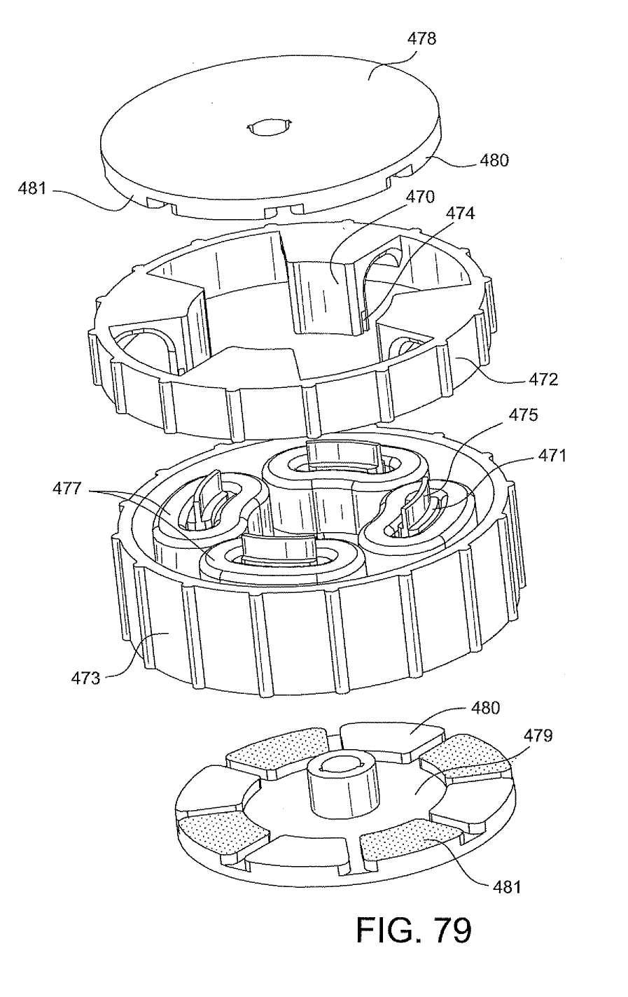

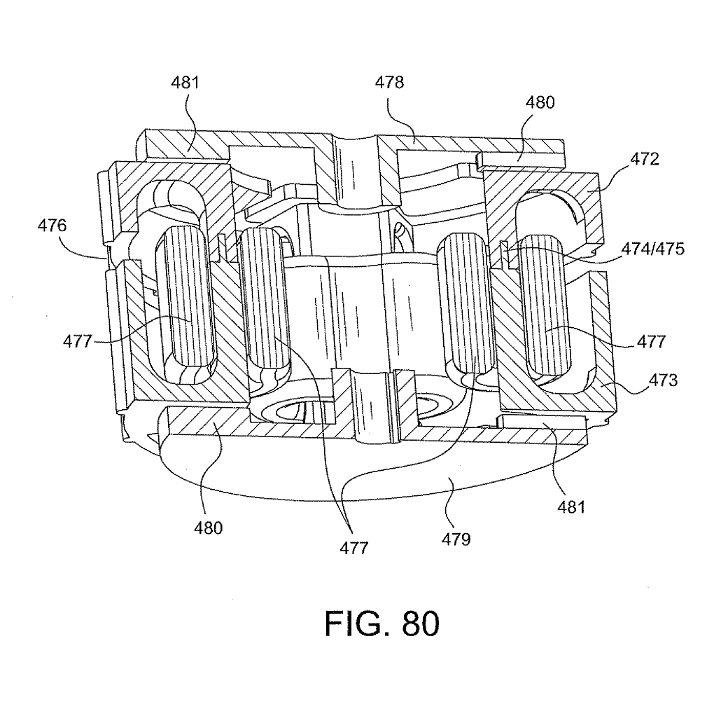

FIGS. 77-80 show yet another variation of the electrical machines of FIGS. 48-76, in which L-shaped pole structures 470,471 respectively extending in opposite directions from housing rings 472,473 are joined together by tongue and groove interfaces 474,475 to provide improved flux coupling between the pole structures in a two-phase, individual coil electrical machine. In this arrangement, the housing rings 471,473 are separated by a gap 476 to confine the flux to the pole structures 470,471, and the pole structures 470,471 are surrounded by individual coils 477. Flux return paths between the pole structures is provided by a soft magnetic permanent magnet rotors 478 and 479, each of which include a plurality of permanent magnets 480,481 arranged such that magnets of opposite polarity face different phase coil/pole structures so that the return path for magnet flux from one pole structure is through a coil/pole structure of the other phase.

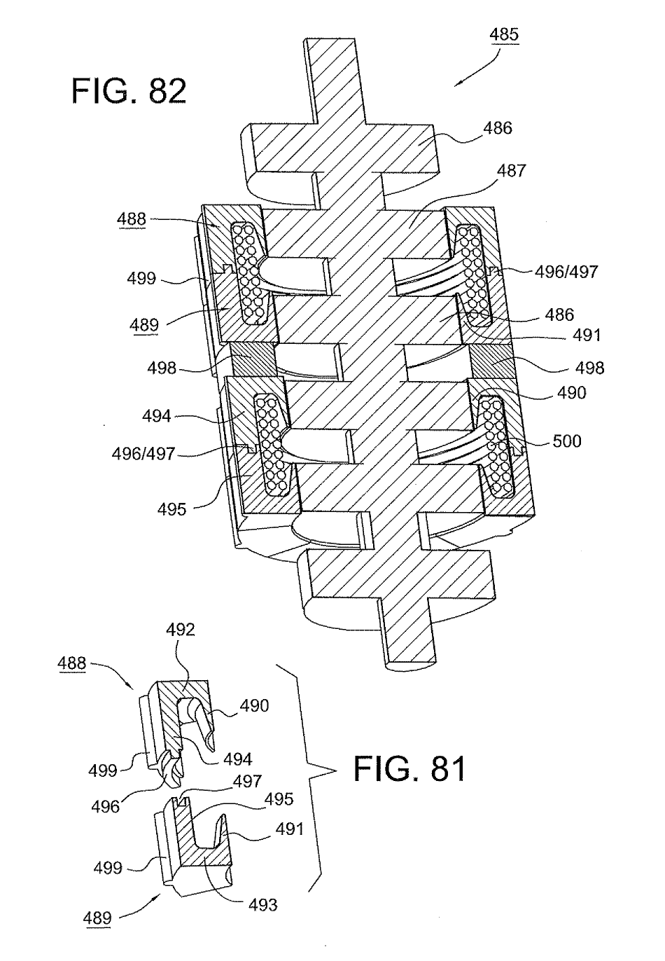

FIGS. 81-82 show a linear electrical machine that utilizes the tongue and groove pole structure joining feature of FIGS. 77-80. This electrical machine is suitable for use either as a motor or as a generator, and especially as a generator in low frequency applications such as wave power generation, or as shock absorber.

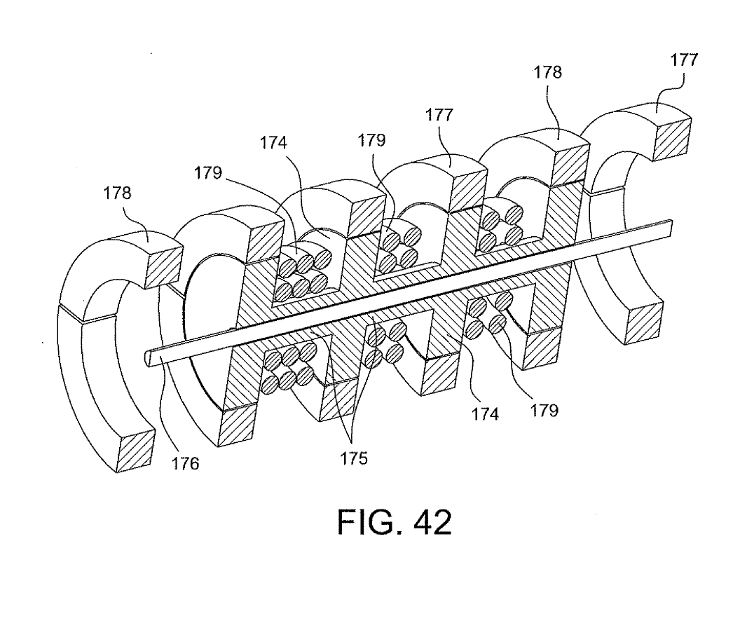

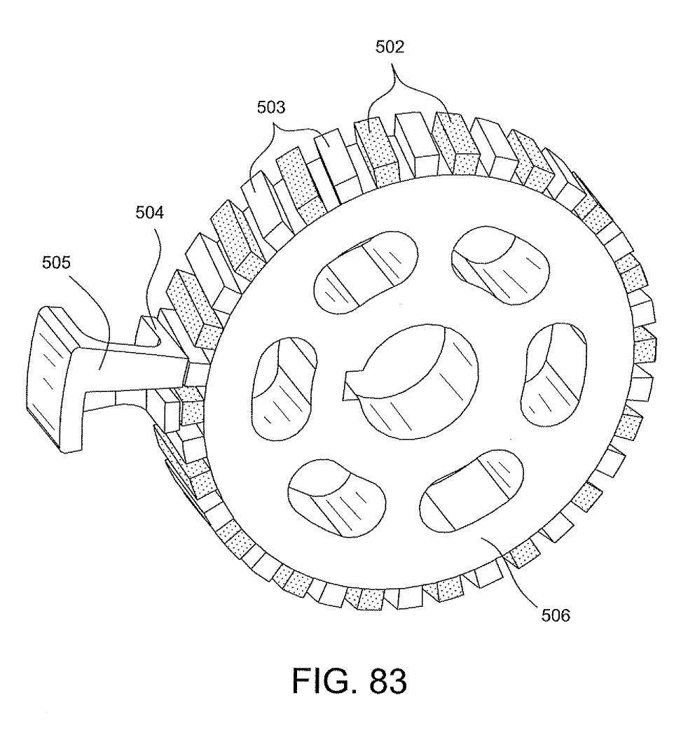

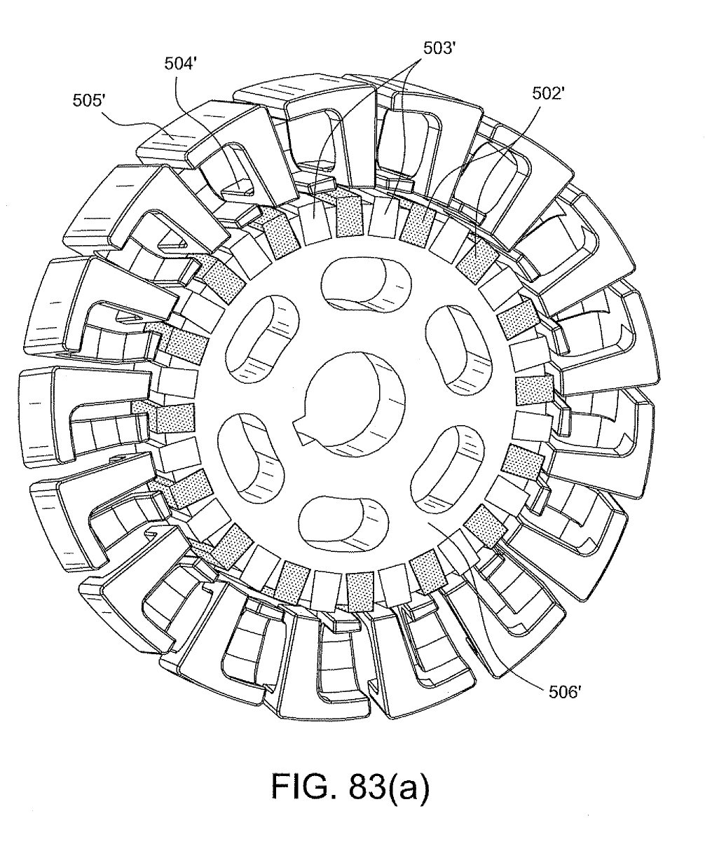

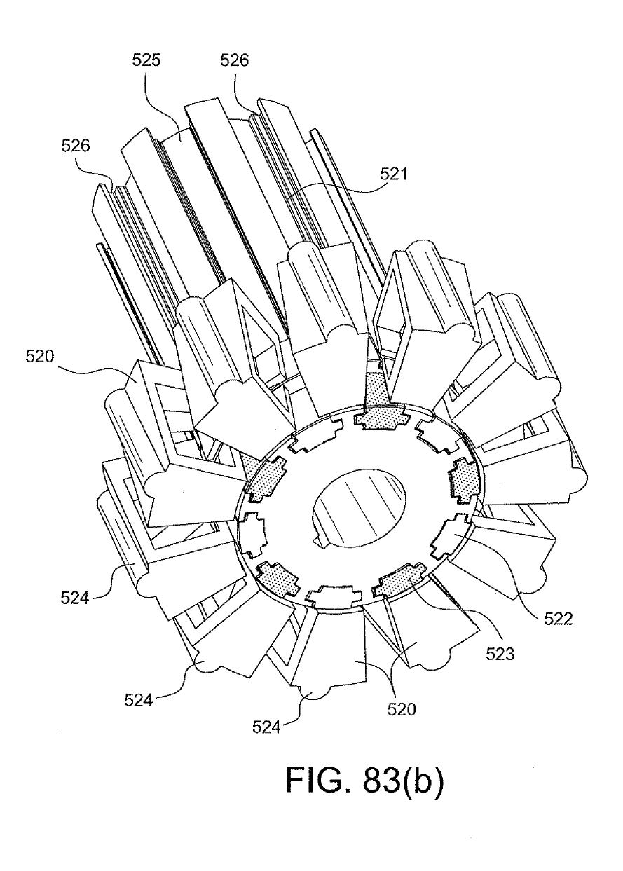

The linear electrical machine of FIGS. 81-82 includes an armature 485 plurality of opposite polarity permanent magnet discs 486,487 corresponding, for example, to those illustrated in FIG. 42, and a stator structure made up of individual U-shaped pole structures 488,489 including axially extending pole faces 490,491 separated by a gap and arranged to face adjacent permanent magnet discs 486,487, radially extending arm sections 492,493, and axially extending housing sections 494,495, one of which includes a tongue 496 and the other of which includes a groove 497 so that pairs of complementary housing sections may be joined by the tongue and groove interfaces 496/497. The end profiles of the pole structures 488,489 are wedge shaped such that the pole structures may be assembled to form a cylindrical housing, although it is also possible to form the pole structures as discs that extend around the circumference of the housing, rather than individual wedge-shaped pieces, with a circumferential interface, such as a stepped structure, rather than individual tongue and groove joints. In order to form individual flux loops between the poles structures and adjacent permanent magnet discs 486,487 of the armature 485, a non-magnetic spacer 498 is provided between adjacent joined-together pairs of magnetic pole structures to form a two phase machine, although those skilled in the art will appreciate that additional spacers and housing sections may be added for additional phases. In addition, optional axially-extending alignment pins 499 may be included in the exterior of the pole structure housing sections 494,495. Finally, in the electrical machine of FIGS. 82 and 83, respective coils 500 are positioned in the spaces formed by the joined-together pole structures 488,489.

FIG. 83 illustrates the principle of skewing permanent magnets to achieve an anti-copping effect. Although the illustrated permanent magnet rotor is similar to the ones illustrated in FIGS. 55-57, the principle of orienting the permanent magnets 502,503 at a nonzero angle relative to principal axes of the pole faces 504 of pole structured 505 may be applied to any of the illustrated embodiments and variations thereof, including ones in which the permanent magnets are integrated into the rotor, as illustrated in FIG. 76, rather than simply affixed to a periphery of the rotor.

It will be appreciated that the skewing effect illustrated in FIG. 83 may be achieved by either orienting the permanent magnets at a nonzero angle relative to an axis of the rotor 506, by orienting the pole faces at a nonzero angle relative to the axis, or by orienting the pole faces and magnets at different nonzero angles relative to the axis of the rotor. An example of an electrical machine in which the pole faces 504′ of pole structures 505′, rather than permanent magnets 502′,503′, are skewed relative to the axis of the rotor 506′, is illustrated in FIG. 83(a).

FIG. 83 (b) illustrates a variation of the skewed stator arrangement of FIG. 83(a), in which the pole structures 520 have a C-shape and are skewed relative to the axis of rotor 521 and permanent magnets 522,523. The skew angle of the pole structures 520 may be determined by any suitable structure, such as optional ribs 524 arranged to fit into axially extending grooves in a stator housing (not shown). Permanent magnets 522,523 of the rotor 521 are arranged to fit into grooves 525 in the rotor, the grooves 525 further including lateral slots 526 for receiving corresponding projections on the magnets so as to hold the magnets in place in the rotor.

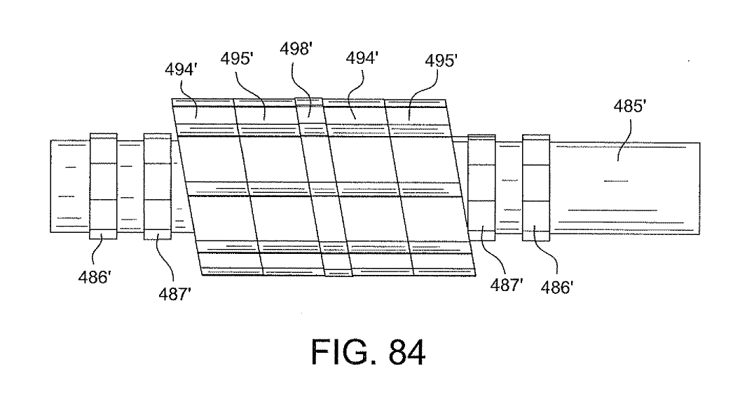

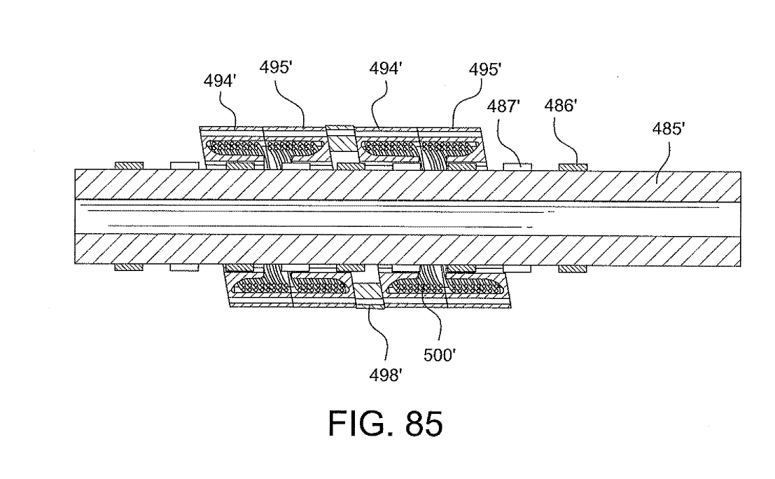

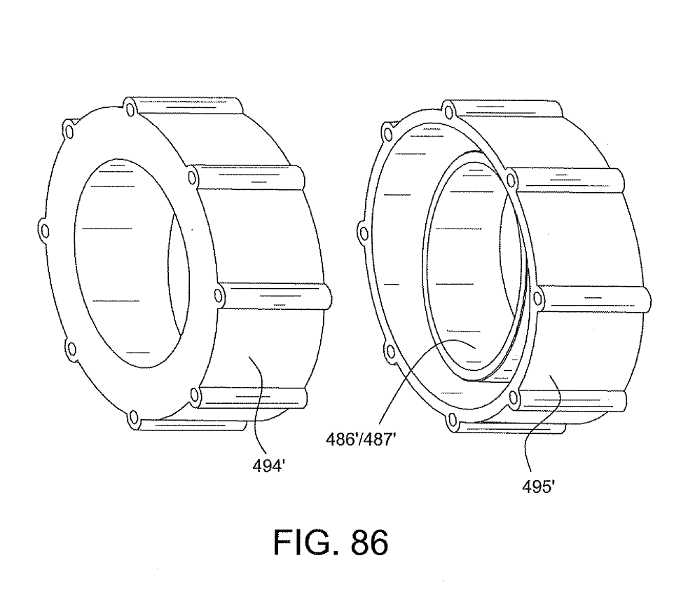

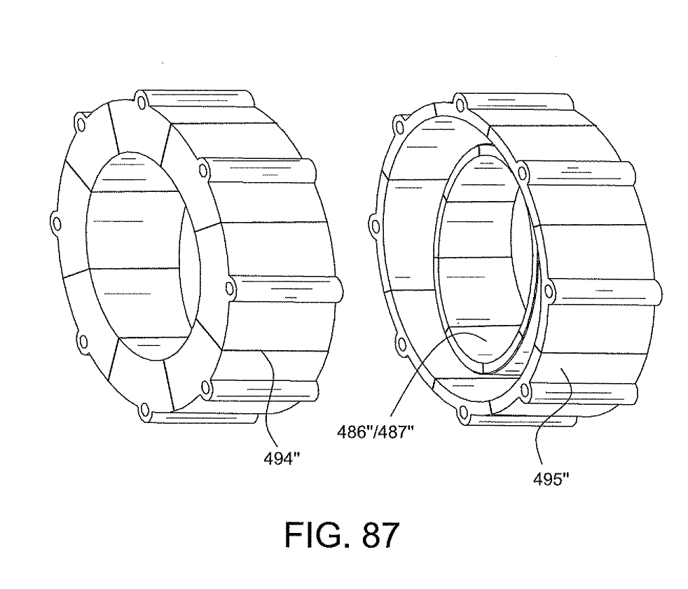

The anti-cogging effects obtained by skewing the permanent magnets relative to the pole structures of an electrical machine may also be provided in a linear motor, as illustrated in FIGS. 84-87. The anti-cogging motor of FIGS. 84,87 may be similar to that of FIGS. 81 and 82, including an armature 485′ with permanent magnet rings or discs 486′,487′ and coil 500′, except that the joined pairs of housing/pole structure sections 494′/495′ and spacer 489′ are skewed with respect to a plane transverse to an axis of the armature, so as to provide the anti-cogging effect. The housing/pole structure sections 494′,495′ are illustrated in FIGS. 84 and 85 as single-piece generally annular housing sections, but the housing/pole structure sections may alternatively be made up of multiple individual wedge-shaped housing/pole structure sections 494″,495″, as shown in FIG. 86.

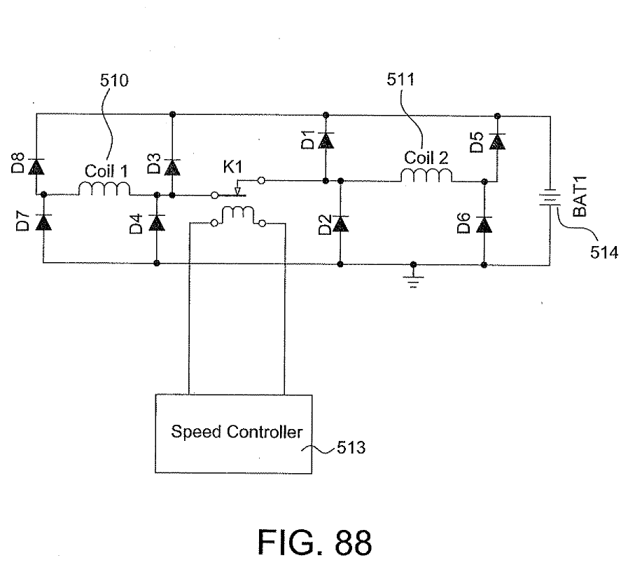

FIG. 88 is a schematic circuit diagram of a speed control circuit suitable for use in controlling the voltage output of a mono coil generator corresponding to the mono coil electrical machines of the third preferred embodiment of the invention, by switching between series and parallel connections of two separate mono coils in a dual coil configuration of the type illustrated, for example, in FIGS. 58 and 60. At low generator speeds, relay K1 is closed to series connect the coils 510,511 and thereby provide a high voltage output and high coil resistance. At higher generator speeds, relay K1 is opened to by the controller 513 to reduce the voltage and divide the resistance and temperature in the windings between the respective coils. The circuit of FIG. 88 may be connected to charge a battery 514, or provide a regenerative braking effect in a hybrid vehicle. Those skilled in the art will appreciate that the relay K1 may be replaced with a solid state switch or PWM control, and that other components of the circuit may also be replaced by functionally equivalent components are required by the particular application to which the circuit is applied.

Having thus described preferred embodiments of the invention in sufficient detail to enable those skilled in the art to make and use the invention, it will nevertheless be appreciated that numerous variations and modifications of the illustrated embodiment may be made without departing from the spirit of the invention. Accordingly, it is intended that the invention not be limited by the above description or accompanying drawings, but that it be defined solely in accordance with the appended claims.

I claim:

1. A high efficiency magnetic core electrical machine, comprising:
a permanent magnet sub-assembly including a plurality of permanent magnets of opposite polarity arrayed axially and circumferentially around the permanent magnet sub-assembly;
a three-dimensional pole structure sub-assembly including at least one soft magnetic flux return ring, a plurality of soft magnetic arms extending axially from the flux return ring, and at least two pole arms extending radially from each of said axially extending arms, each pole arm being axially spaced to face axially spaced sets of said permanent magnets as at least one of said permanent magnet sub-assembly and said pole structure sub-assembly are rotated relative to the other of said permanent magnet sub-assembly and said pole structure sub-assembly,
wherein electrical windings are positioned on said pole structure sub-assembly to interact inductively with changing magnetic flux in said pole structure sub-assembly, and
wherein said relative rotation of said permanent magnet and pole structure sub-assemblies causes permanent magnets of opposite polarity to face axially and circumferentially adjacent ones of said pole arms such that magnetic flux flows through and converges in said pole arms, said axially extending arms, and said flux return ring to thereby interact inductively with said windings.

2. An electrical machine as claimed in claim 1, wherein said flux return ring, said axially-extending arms, and said pole arms are arranged in a plurality of individual pole structure modules, each said module including an arc shaped section of said flux return ring, at least one axially-extending arm, and at least two said radially-extending pole arms.

3. An electrical machine as claimed in claim 2, wherein said axially-extending arm extends above and below said arc shaped section, and said module includes three said pole arms, one of which extends arc shaped ring and two of which extend from ends of said axially-extending arms to form an E-shaped structure.

4. An electrical machine as claimed in claim 3, wherein said pole arms extend radially inwardly.

5. An electrical machine as claimed in claim 3, wherein a number of said arc-shaped sections is three, one of said arc-shaped sections extending from a middle of said axially extending arm and two of said arc-shaped sections extending from ends of said axially-extending arm to form three said flux return rings.

6. An electrical machine as claimed in claim 2, wherein arc-shaped sections of adjacent said modules are joined together by a mortise and tenon connection.

7. An electrical machine as claimed in claim 6, further comprising a mortise or tenon on each end of said axially extending arms to enable connection of multiple said flux return rings.

8. An electrical machine as claimed in claim 6, further comprising interfitting curved surfaces on each end of said axially extending arms, said axially extending arms being joined by pins that extend through bores communicating bores in the axially extending arms of adjacent said modules to enable connection of multiple said flux return rings.

9. An electrical machine as claimed in claim 2, wherein said pole arms include at least one radially inwardly extending pole arm and at least one radially outwardly extending pole arm, and wherein said electrical machine permanent magnets are arranged on an inner cylinder to face said inwardly extending pole arms and on an outer cylinder to face said outwardly extending pole arms.

10. An electrical machine as claimed in claim 8, wherein each said module include three said radially extending pole arms, three said outwardly extending pole arms, and three said arc shaped sections extending on each side of said axially-extending arm to form three said flux return rings.

11. An electrical machine as claimed in claim 1, wherein said windings are wound around coil bobbins fitted onto said pole arms.

12. An electrical machine as claimed in claim 1, wherein said pole arms are flared to increase a surface area that faces said permanent magnets.

13. A high efficiency magnetic core electrical machine, comprising:
a permanent magnet sub-assembly including a plurality of permanent magnets of opposite polarity arrayed around the permanent sub-assembly;
a pole structure sub-assembly including poles that face different said permanent magnets as said pole structure sub-assembly moves relative to said permanent magnet sub-assembly to thereby cause reversals of flux carried by said pole structure sub-assembly,
wherein said pole structure sub-assembly includes a plurality of auxiliary permanent magnets that are freely movable relative to said pole structure sub-assembly to follow said flux reversals and thereby boost magnetic flux flowing through said pole structure sub-assembly in each direction as said permanent magnets of opposite polarity move past respective said poles.

14. An electrical machine as claimed in claim 13, wherein said pole structure sub-assembly includes a flux return ring and said auxiliary permanent magnets are annular dipole magnets mounted for rotation within said flux return ring.

15. An electrical machine as claimed in claim 14, wherein a number of said permanent magnets of said permanent magnet sub-assembly is greater than a number of said poles to provide an anti-cogging effect.

16. An electrical machine as claimed in claim 13, wherein said auxiliary permanent magnets are situated at ends of radially outwardly extending pole arms.

17. An electrical machine as claimed in claim 13, wherein said pole structure sub-assembly includes an outer flux return ring, and said auxiliary permanent magnets are arranged in radially aligned pairs extending between said permanent magnet sub-assembly and said outer flux return ring.

18. An electrical machine as claimed in claim 17, wherein coil windings are situated between individual auxiliary permanent magnets in each of said radially aligned pairs.

19. An electrical machine as claimed in claim 18, wherein said permanent magnet sub-assembly is a cylinder on an outside of said pole structure sub-assembly.

20. An electrical machine as claimed in claim 13, wherein said electrical machine is a linear electrical machine and said auxiliary permanent magnets are annular dipole magnets mounted for rotation.

21. An electrical machine as claimed in claim 20, wherein said permanent magnet sub-assembly includes a linear support member on which a row of said permanent magnets are fixed, said auxiliary permanent magnets are arranged in parallel with said linear member in at least two rows, and a flux return member is provided on an opposite side of said auxiliary permanent magnets from said linear support member.

22. An electrical machine as claimed in claim 21, wherein said flux return member is also provided with a row of permanent magnets.

23. An electrical machine as claimed in claim 21, wherein coil windings are positioned between respective pairs of auxiliary permanent magnets, one in at least two of said rows.

24. A mono coil electrical machine, comprising:
a magnetic pole structure comprising two sets of radially extending pole arms circumferentially arranged around opposite ends of a cylindrical soft magnetic member with a space between said two sets of radially extending pole arms;
a single coil supporting structure extending around said cylindrical soft magnetic member in said space between said two sets of radially extending pole arms, and at least one coil wound around said coil supporting structure; and
two cylindrical housing halves, each supporting a set of permanent magnets of opposite polarities interleaved on an inner surface, said magnets extending around said magnetic pole structure such that individual poles pass each of said magnets when said magnetic pole structure or said two cylindrical housing halves rotate,
wherein a number of said pole arms extending from a respective end of said magnetic pole structure is one half a number of said permanent magnets on a respective said housing half such that said pole arms on one end of said magnetic pole structure all simultaneously face permanent magnets of a same polarity and at the same time said pole arms on a second end of said magnetic pole structure all simultaneously face permanent magnets of a polarity opposite to said same polarity to cause magnetic flux to flow through said coil in a first direction, and
wherein as said magnetic pole structure and said housing halves relatively rotate, permanent magnets on each housing half alternately pass corresponding said poles to cause magnetic flux flowing through said coil to repeatedly reverse polarity and generate an alternating current in said coil.

25. A mono coil electrical machine as claimed in claim 24, wherein said radially extending pole arms are arranged to cause cooling air circulation as said magnetic pole structure rotates.

26. A mono coil electrical machine as claimed in claim 24, wherein a first set of said permanent magnets is arranged on an inner cylindrical surface of each said housing half to face ends of said pole arms, and a second set of said permanent magnets is arranged on an end surface of each said housing half to face sides of said pole arms.

27. A mono coil electrical machine as claimed in claim 24, further comprising a second magnetic pole structure, a second coil, and a second set of housing halves stacked to form a two phase electrical machine.

28. A mono coil electrical machine as claimed in claim 24, wherein a plurality of said magnetic pole structures and mono coils are axially stacked to form a multiple phase electrical machine.

29. A spherical mono coil electrical machine, comprising:
a spherical magnetic pole structure comprising two sets of arc-shaped pole sections, each arc-shaped pole section forming a curved-triangular section of a sphere-shape having vertices that terminate in a hub at a respective axial end of said pole structure and a base midway between said axial ends of the sphere-shape, said slices further inner sides that extend along an axis of the sphere-shape, with slices of the first set forming a first hemisphere, slices of the second set forming a second hemisphere, and slides of the first and second hemispheres being connected by a cylindrical soft magnetic member around which is an annular space;
a single coil supporting structure extending around said cylindrical soft magnetic member in said space between said two sets of arc-shaped pole sections, with at least one coil wound around said coil supporting structure; and
two hemispherical housing halves, each supporting a set of permanent magnets of opposite polarities interleaved on an inner surface, said magnets extending around said magnetic pole structure such that individual poles pass each of said magnets when said magnetic pole structure or said two cylindrical housing halves rotate,
wherein a number of said arc-shaped pole sections on a respective hemisphere of said pole structure is one half a number of said permanent magnets on a respective first said hemispherical housing half such that said arc-shaped pole sections on said respective hemisphere all simultaneously face permanent magnets of a same polarity and at the same time said arc-shaped pole sections on a second said hemisphere of said magnetic pole structure all simultaneously face permanent magnets of a polarity opposite to said same polarity to cause magnetic flux to flow through said connecting member in a first direction, and
wherein as said spherical magnetic pole structure and said hemispherical housing halves relatively rotate, permanent magnets on each hemispherical housing half alternately pass corresponding said arc-shaped pole sections to cause magnetic flux flowing through said connecting member, and therefore through said coil, to repeatedly reverse polarity and generate an alternating current in said coil.

30. A spherical mono coil electrical machine as claimed in claim 24, wherein said single coil supporting structure includes a passage for receiving a liquid coolant.

31. A spherical mono coil electrical machine as claimed in claim 24, wherein said hemispherical housing halves are made up of arc-shaped sections corresponding in number and shape to said permanent magnets supported by said hemispherical housing halves, spaces between said sections providing ventilation.

32. A spherical mono coil electrical machine as claimed in claim 32, wherein ends of said arc-shaped sections of a first of said hemispherical housing halves terminate in an annular flange that mates with a corresponding annular flange on a second of said hemispherical housing halves to join said hemispherical housing halves.

33. A spherical mono coil electrical machine as claimed in claim 32, wherein said annular flanges extend continuously around a perimeter of said hemispherical housing halves to serve as a flux return path between said arc-shaped hemispherical housing half sections.

34. A mono coil electrical machine, comprising:
a central disc having a plurality of flux reversal structures mounted on a periphery of said disc;
an annular permanent magnet sub-assembly comprising a plurality of soft magnetic structures to which are affixed axially aligned pairs of permanent magnets, such that adjacent ones of said permanent magnets alternate in polarity both axially and around a circumference of said permanent magnet sub-assembly; and
at least one coil positioned to intercept magnetic fields generated by said permanent magnets,
wherein a number of said flux reversal structures is one half a number of said axially aligned pairs of permanent magnets, and
wherein as said central disc and annular permanent magnet sub-assembly relatively rotate, top and bottom ends of said flux reversal structures face different axially aligned pairs of said permanent magnets, causing magnet flux flowing between said top and bottom ends to reverse, thereby causing changes in magnetic fields that intercept said coil to induce a current.

35. A mono coil electrical machine as claimed in claim 34, wherein said annular permanent magnet sub-assembly includes a plurality of c-shaped soft magnetic structures having radially extending arms, ends of said arms supporting said permanent magnets, and said coil extending around said permanent magnet sub-assembly in spaces between the arms of the c-shaped soft magnetic structures.

36. A mono coil electrical machine as claimed in claim 34, wherein said annular permanent magnet sub-assembly comprises a continuous flux return member having a c-shaped cross section forming an annular space that extends around said sub-assembly, said coil being received in said annular space.

37. A mono coil electrical machine as claimed in claim 34, wherein said flux reversal structures each includes a pair of bracket arms for securing said flux reversal structures to said central disc.

38. A mono coil electrical machine as claimed in claim 37, wherein said flux reversal structures each further includes upper and lower pole arms extending radially outwardly from said central disc to face said permanent magnets.

39. A mono coil electrical machine as claimed in claim 37, wherein said flux reversal structure each includes an axially extending face, one end of which faces first said permanent magnets of said axially aligned pairs of permanent magnets and a second end of which faces second said permanent magnets of said axially aligned pairs.

40. A mono coil electrical machine as claimed in claim 37, which is stacked with at least one additional said mono coil electrical machine to form a multiple phase electrical machine.

41. A mono coil electrical machine as claimed in claim 34, wherein said permanent magnet sub-assembly includes a plurality of permanent magnet/coil modules, each including an individual coil.

42. A mono coil electrical machine as claimed in claim 41, wherein said permanent magnet/coil modules each includes a pair of soft magnetic holders and a permanent dipole magnet extending between the holders, said dipole magnet extending through a coil holder around which said individual coil is wound.

43. A mono coil electrical machine as claimed in claim 42, wherein said holders each includes a recess shaped to receive and securely hold an end of said dipole magnet.

44. A mono coil electrical machine as claimed in claim 41, wherein permanent magnet/coil modules each includes a pair of pole structures having poles that extend towards said flux reversal structures and a pair of pockets for respectively receiving permanent magnets of opposite polarity, said modules further including a common flux return plate for retaining said permanent magnets within said pockets.

45. A mono coil electrical machine as claimed in claim 34, wherein said permanent magnet sub-assembly includes a plurality of horseshoe magnets.

46. A mono coil electrical machine as claimed in claim 45, wherein said at least one coil is a single coil extending around said permanent magnet sub-assembly in spaces between arms of said horseshoe magnets.

47. A mono coil electrical machine as claimed in claim 45, wherein said at least one coil includes an individual coil surrounding one arm of each of said horseshoe magnets.

48. A linear electrical machine, comprising:
an armature including at least one flux reversal structures;
rows of permanent magnets of opposite polarity, said flux reversal structure extending between said rows of permanent magnets; and
at least one coil positioned to sense changes in a magnetic field resulting from said flux reversals,
wherein one side of said flux reversal structure faces a permanent of first polarity and an opposite side of said flux reversal structure faces a permanent magnet of opposite polarity, and
wherein as said flux reversal structure moves relative to said rows of permanent magnets, said ends of said flux reversal structure face permanent magnets of alternating polarity to cause repeated reversal of magnetic flux in said flux reversal structure, thereby inducing an alternating current in said coil.

49. A linear mono coil electrical machine as claimed in claim 48, wherein said flux reversal structure two arms extending parallel to a direction of movement of said armature relative to said rows of permanent magnets, a connecting arm extending between said two parallel arms, and pairs of pole arms extending transversely from ends of said parallel arms, each pole arm in the pair of pole arms extending from one side of said flux reversal structure facing a respective permanent magnet of like polarity.

50. A linear mono coil electrical machine as claimed in claim 49, further comprising additional pole arms extending transversely to said pairs of pole arms, and additional rows of permanent magnets faced by said additional pole arms to form a three-dimensional linear actuator.

51. A linear mono coil electrical machine as claimed in claim 50, wherein a number of pole arms extending from each respective end of each of said parallel arms of said flux reversal structure is three, and a number of said rows of permanent magnets is six.

52. A linear mono coil electrical machine as claimed in claim 48, wherein a number of said flux reversal structures is at least two to provide multiple phases.

53. A linear mono coil electrical machine as claimed in claim 48, wherein said row of permanent magnet structures include a row of c-shaped magnets, and said coil extends around arms of a plurality of said c-shaped magnets.

54. A linear mono coil electrical machine as claimed in claim 48, wherein said flux reversal structure comprises a plurality of soft magnetic discs connected by cylindrical structures to form spaces between said discs, and said rows of permanent magnets include rows of semi-circular permanent magnets extending around said soft magnetic discs to cause flux reversals in said discs as said armature and rows of permanent magnets move relative to each other.

55. A linear mono coil electrical machine as claimed in claim 54, wherein said at least one coil includes a plurality of coils wrapped around said cylindrical structures in said spaces between said discs.

56. A linear mono coil electrical machine as claimed in claim 54, wherein said at least one coil includes a plurality of coils wrapped around a cylinder to which the permanent magnets are affixed.

57. A mono coil electrical machine, comprising:
a permanent magnet subassembly including a plurality of permanent magnets of opposite polarity; and
at least one flux reversal structure that includes a cylindrical section, flanges extending in opposite directions from each end of the cylindrical section, and a coil wrapped around said cylindrical section,
wherein respective said flanges face permanent magnets of opposite polarity, and
wherein as said permanent magnet sub-assembly moves relative to said flux reversal structure, polarities of said permanent magnets that face said flanges alternates to cause flux reversals in said cylindrical section and induce an alternating current in said at least one coil.

58. A linear mono coil electrical machine as claimed in claim 57, wherein each of said flanges includes a plurality of openings, and wherein said electrical machine includes a plurality of said modules aligned by pins extending through said openings.

59. A linear mono coil electrical machine as claimed in claim 58, wherein said rows of permanent magnets are semi-circular permanent magnets joined together to form a structure that rotates within central openings of said plurality of flux reversal structures.

60. An electrical machine, comprising:
a first set of permanent magnets mounted on a cylindrical housing structure;
a second set of permanent magnets mounted on a soft magnetic magnet holder, said cylindrical housing structure and said magnet holder being relatively movable; and
at least one coil positioned to detect changes in a magnetic field that results from relative movement of said first and second sets of permanent magnets,
wherein said soft magnetic magnet holder surrounds a shaft and includes radially extending spokes for supporting the magnets.

61. An electrical machine as claimed in claim 60, wherein said cylindrical housing structure and magnet holder are made of steel, and the at least one coil is on the outside of the housing to pick up a switching magnetic field in the housing.

62. A low cogging mono coil electrical machine, wherein permanent magnets are mounted on opposite sides of a plurality of plates, said plurality of plates being parallel to each other and mounted on shaft so as to be out-of-phase in order to produce a sine wave in a pair of pickup coils extending around said shaft and permanent magnets between respective pairs of said plates.

63. An electrical machine, comprising:
a rotor comprising a pair of annular axially spaced discs on which are mounted permanent magnets of opposite polarity;
a plurality of linear flux reversal members extending in parallel with an axis of said rotor such that ends of said flux reversal members face respective permanent magnets of opposite polarity on said axially spaced discs; and
at least one pick-up coil,
wherein said ends of said flux reversal members face magnets of alternating polarity as said rotor and cylindrical housing rotate relative to each other, thereby causing flux reversals that induce currents in said pick-up coil.

64. An electrical machine as claimed in claim 63, wherein said linear flux reversal members are mounted in slots in a cylindrical housing, and said pick-up coil extends around said cylindrical housing.

65. An electrical machine as claimed in claim 64, wherein said rotor discs includes a plurality of spokes to which said permanent magnets are mounted.

66. An electrical machine as claimed in claim 63, wherein said pick-up coils includes a plurality of radially extending pick-up coils.

67. An electrical machine as claimed in claim 66, wherein said pick-up coils are aligned relative to said permanent magnets on said rotor by notches in said linear flux reversal members.

68. An electrical machine, comprising:
a stator including an outer housing member and a plurality of pole structures, each pole structure joined to the outer housing member by an interface that forms a self-aligning connection, and each pole structure including abase and at least one arm connected to the base and extending parallel to an axis of the electrical machine, said at least one arm including a pole face arranged to face permanent magnets of opposite polarity;
a disc-shaped rotor having said permanent magnets of opposite polarity mounted around a periphery of the rotor; and
at least one coil extending through an opening between the base and the at least one arm of each of the pole structures.

69. An electrical machine as claimed in claim 68, wherein the at least one coil is a mono coil.

70. An electrical machine as claimed in claim 68, wherein the self-aligning connection is a mortise and tenon joint.

71. An electrical machine as claimed in claim 68, wherein the self-aligning connection is a dovetail joint.

72. An electrical machine as claimed in claim 68, wherein each pole structure includes two arms extending parallel to the axis of the electrical machine in opposite directions, said pole face of respective arms arranged to simultaneously face opposite polarity ones of said permanent magnets.

73. An electrical machine as claimed in claim 68, wherein said outer housing is cylindrical and said pole structures are annular pole structures, and pairs of said annular pole structures include a plurality of said axially extending arms, said annular pole structures in a pair being joined to capture the at least one coil and form a single phase coil assembly, and said self-aligning connection enabling multiple said single phase coil assemblies to be aligned with said outer housing.

74. An electrical machine as claimed in claim 73, wherein said self-aligning connection includes axially extending ribs on said annular pole structures and axially extending grooves on an interior surface of said outer housing.

75. An electrical machine as claimed in claim 73, wherein said annular pole structures are joined to each other by a step interface.

76. An electrical machine as claimed in claim 68, wherein said self-aligning connection includes pins and openings.

77. An electrical machine as claimed in claim 68, wherein the outer housing member is annular and said pole structures are U-shaped members that are bolted to the outer housing member.

78. An electrical machine as claimed in claim 68, wherein said pole structures further include integrated permanent magnets.

79. An electrical machine as claimed in claim 68, wherein said arms are skewed with respect to said permanent magnets to reduce cogging.

80. An electrical machine as claimed in claim 68, wherein said at least one coil includes an outer insulating member that surrounds a plurality of conductors and a pressurized coolant fluid.

81. An electrical machine as claimed in claim 68, wherein said at least one coil includes an outer insulating member surrounding a tube-shaped conductor, said outer insulating member and said tube-shaped conductor both filled with pressurized coolant fluid.

82. A control circuit for an electrical machine having at least two coils, comprising a switch and means for controlling the switch to switch between a series connection of the two coils at low speeds and a parallel connection of the two coils at high speeds.

83. An electrical machine with skewed-stator anti-cogging features, comprising:
a rotor having an axis of rotation and a plurality of permanent magnets arranged around a periphery of the rotor; and
a stator having a plurality of pole structures, said pole structures facing said magnets and having principal axes,
wherein said principal axes of said pole structures are skewed with respect to said axis of rotation of the rotor.

84. An electrical machine as claimed in claim 83, wherein said permanent magnets have principal axes that are also skewed with respect to said axis of rotation of the rotor.
